(19) United States
(12) Patent Application Publication
(10) Pub. No.: US 2024/0279422 A1
(43) Pub. Date: Aug. 22, 2024

(54) MULTILAYER COMPOSITE WITH THERMAL BARRIER PROPERTIES

(71) Applicant: SAINT-GOBAIN PERFORMANCE PLASTICS CORPORATION, Solon, OH (US)

(72) Inventors: Fei WANG, Winchester, MA (US); Chuanping LI, Shrewsbury, MA (US); Rachel BROWN, Sutton, MA (US); Antoine GUIU, Lyon (FR); Benoit DIDIER, Liège (BE); Wenjun SUN, Shanghai (CN); Katherine E. POKHREL, Framingham, MA (US); Kai GAO, Natick, MA (US); Roger P. ZALESKI, North Grafton, MA (US)

(21) Appl. No.: 18/444,068

(22) Filed: Feb. 16, 2024

Related U.S. Application Data
(60) Provisional application No. 63/485,685, filed on Feb. 17, 2023.

(51) Int. Cl. C08J 9/36; B32B 5/02; B32B 5/18; B32B 5/24; B32B 27/06; B32B 27/12; B32B 27/20; C08J 9/00; C08K 3/22; C08K 3/26; C08K 3/36; C08K 3/38; C09D 5/18; C09D 7/40; C09D 7/61

(52) U.S. Cl. CPC C08J 9/365; B32B 5/02; B32B 5/18; B32B 5/245; B32B 27/065; B32B 27/12; B32B 27/20; C08J 9/0066; C08K 3/22; C08K 3/26; C08K 3/36; C08K 3/38; C09D 5/185; C09D 7/61; C09D 7/70; B32B 2262/101; B32B 2264/101; B32B 2264/1023; B32B 2264/104; B32B 2266/0214; B32B 2266/0278; B32B 2307/304; B32B 2307/3065; C08J 2205/06; C08J 2375/04; C08J 2383/04; C08K 2003/2227; C08K 2003/265; C08K 2003/387; C08K 2201/014

(57) ABSTRACT

The present disclosure relates to a multilayer composite or multilayer laminate that may include a core foam layer, and a first ceramifiable barrier component contacting the core foam layer. The ceramifiable barrier component may include a ceramifiable layer. The multilayer composite may have a HBF flammability rating as measured according to ASTM D4986.

### CROSS-REFERENCE TO RELATED APPLICATION(S)

This application claims priority under 35 U.S.C. § 119(c) to U.S. Provisional Application No. 63/485,685, entitled “MULTILAYER COMPOSITE WITH THERMAL BARRIER PROPERTIES,” by Fei WANG et al., filed Feb. 17, 2023, which is assigned to the current assignee hereof and incorporated herein by reference in its entirety.

### FIELD OF THE DISCLOSURE

The present disclosure relates to a multilayer composite and, in particular, a multilayer composite for use as a thermal barrier in various applications, for example, in a battery pack, and methods of forming the same.

### BACKGROUND

Multilayer composite films may be designed for high-temperature protection in various applications, for example, for use as thermal barriers in electric vehicle battery packs, thermal barrier coverings in high-temperature cable protection, thermal barrier containers for thermal spray containment, etc. However, in these, and in other applications, potential heat growth continues to increase due to improvements in technology. Accordingly, there is a continuing need for improved barrier designs that protect against such high heat potential.

### SUMMARY

According to a first aspect, a multilayer composite may include a core foam layer, and a first ceramifiable barrier component contacting the core foam layer. The ceramifiable barrier component may include a ceramifiable layer. The multilayer composite may have a HBF flammability rating as measured according to ASTM D4986.

According to another aspect, a multilayer laminate may include a core foam layer, and a first ceramifiable barrier component contacting the core foam layer. The ceramifiable barrier component may include a ceramifiable layer. The multilayer laminate may have a HBF flammability rating as measured according to ASTM D4986.

### BRIEF DESCRIPTION OF THE DRAWINGS

Embodiments are illustrated by way of example and are not limited to the accompanying figures.

FIG. 1 includes an illustration of an example multilayer composite according to certain embodiments described herein;

FIG. 2 includes a diagram showing a silicone-based foam forming method according to embodiments described herein;

FIG. 3 includes an illustration of an example multilayer composite according to certain embodiments described herein;

FIG. 4 includes an illustration of an example multilayer composite according to certain embodiments described herein;

FIG. 5 includes an illustration of an example multilayer composite according to certain embodiments described herein;

FIG. 6 includes an illustration of an example multilayer composite according to certain embodiments described herein; and

FIG. 7 includes an illustration of an example multilayer composite according to certain embodiments described herein.

Skilled artisans appreciate that elements in the figures are illustrated for simplicity and clarity and have not necessarily been drawn to scale.

### DETAILED DESCRIPTION

The following discussion will focus on specific implementations and embodiments of the teachings. The detailed description is provided to assist in describing certain embodiments and should not be interpreted as a limitation on the scope or applicability of the disclosure or teachings. It will be appreciated that other embodiments can be used based on the disclosure and teachings as provided herein.

The terms “comprises,” “comprising,” “includes,” “including,” “has,” “having” or any other variation thereof, are intended to cover a non-exclusive inclusion. For example, a method, article, or apparatus that comprises a list of features is not necessarily limited only to those features but may include other features not expressly listed or inherent to such method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Also, the use of “a” or “an” is employed to describe elements and components described herein. This is done merely for convenience and to give a general sense of the scope of the invention. This description should be read to include one, at least one, or the singular as also including the plural, or vice versa, unless it is clear that it is meant otherwise. For example, when a single item is described herein, more than one item may be used in place of a single item. Similarly, where more than one item is described herein, a single item may be substituted for that more than one item.

Embodiments described herein are generally directed to a multilayer composite that may include a core foam layer, and a first ceramifiable barrier component contacting the core foam layer. According to particular embodiments, the first ceramifiable barrier component may include a ceramifiable layer.

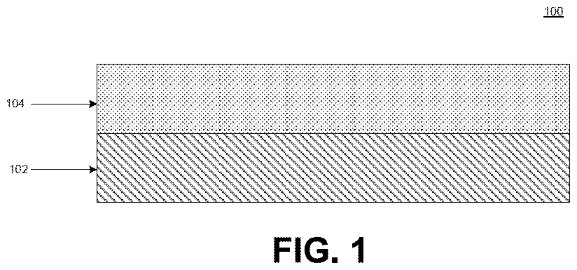

For purposes of illustration, FIG. 1 shows a multilayer composite 100 according to embodiments described herein. As shown in FIG. 1, a multilayer composite 100 may include a first ceramifiable barrier component 102 and a core foam layer 104.

According to certain embodiments, the first ceramifiable barrier component 102 may include ceramifiable layer. According to still other embodiments, the ceramifiable layer may include a polymer-based matrix component, and a filler composition distributed within the polymer-based component.

Referring to embodiments, the ceramifiable layer may include a polymer-based matrix component, and a filler composition distributed within the polymer-based matrix.

According to particular embodiments, the polymer-based matrix component of the ceramifiable layer may include a particular material. For example, the polymer-based matrix component may include a component selected from the group consisting of silicone, polyurethane, epoxy, acrylic resin, or any combination thereof. According to still other embodiments, the polymer-based matrix component may include silicone. According to yet other embodiments, the polymer-based matrix component may consist of silicone. According to still other embodiments, the polymer-based matrix component may include polyurethane. According to yet other embodiments, the polymer-based matrix component may consist of polyurethane. According to still other embodiments, the polymer-based matrix component may include epoxy. According to yet other embodiments, the polymer-based matrix component may consist of epoxy. According to still other embodiments, the polymer-based matrix component may include acrylic resin. According to yet other embodiments, the polymer-based matrix component may consist of acrylic resin.

According to still other embodiments, the ceramifiable layer may include a particular content of the polymer-based matrix component. For example, the ceramifiable layer may include a polymer-based matrix component content of at least about 30 wt. % for a total weight of the ceramifiable layer, such as, at least about 33 wt. % or at least about 35 wt. % or at least about 38 wt. % or at least about 40 wt. % or at least about 43 wt. % or at least about 45 wt. % or even at least about 48 wt. %. According to still other embodiments, the ceramifiable layer may include a polymer-based matrix component content of not greater than about 60 wt. % for a total weight of the ceramifiable layer, such as, not greater than about 58 wt. % or not greater than about 55 wt. % or not greater than about 53 wt. % or even not greater than about 50 wt. %. It will be appreciated that ceramifiable layer may include a polymer-based matrix component content of any value within a range between any of the minimum and maximum values noted above. It will be further appreciated that the ceramifiable layer may include a polymer-based matrix component content of any value between any of the minimum and maximum values noted above.

According to still other embodiments, the ceramifiable layer may include a particular content of the filler composition. For example, the ceramifiable layer may include a filler composition content of at least about 40 wt. % for a total weight of the ceramifiable layer, such as, at least about 43 wt. % or at least about 45 wt. % or at least about 48 wt. % or at least about 50 wt. % or at least about 53 wt. % or at least about 55 wt. % or even at least about 58 wt. %. According to still other embodiments, the ceramifiable layer may include a filler composition content of not greater than about 70 wt. % for a total weight of the ceramifiable layer, such as, not greater than about 68 wt. % or not greater than about 65 wt. % or not greater than about 63 wt. % or even not greater than about 60 wt. %. It will be appreciated that ceramifiable layer may include a filler composition content of any value within a range between any of the minimum and maximum values noted above. It will be further appreciated that the ceramifiable layer may include a filler composition content of any value between any of the minimum and maximum values noted above.

According to certain embodiments, the filler composition may include a ceramization filler component, a structure promoter component, a flux component, and a flame retardant component.

According to particular embodiments, the ceramization filler component of the filler composition may include particular components. For example, the ceramization filler component may include a component selected from the group consisting of sepiolite, wollastonite, or any combination thereof. According to still other embodiments, the ceramization filler component may include sepiolite. According to yet other embodiments, the ceramization filler component may consist of sepiolite. According to still other embodiments, the ceramization filler component may include wollastonite. According to yet other embodiments, the ceramization filler component may consist of wollastonite. According to still other embodiments, the ceramization filler component may include a combination of sepiolite and wollastonite. According to yet other embodiments, the ceramization filler component may consist of a combination of sepiolite and wollastonite.

According to still other embodiments, the ceramization filler component of the filler composition may be a plurality of particles. According to still other embodiments, the ceramization filler component may have a particular aspect ratio. For purposes of embodiments described herein the aspect ratio of the ceramization filler component may be defined as the average length of a statistically significant number of the plurality of particles of the ceramization filler component divided by the average diameter of a statistically significant number of plurality of particles of the ceramization filler component (L/D). For example, the ceramization filler component may have an aspect ratio of not greater than about 10.0, such as, not greater than about 9.5 or not greater than about 9.0 or not greater than about 8.5 or not greater than about 8.0 or not greater than about 7.5 or not greater than about 7.0 or not greater than about 6.5 or not greater than about 6.0 or even not greater than about 5.5. According to still other embodiments, the ceramization filler component may have an aspect ratio of at least about 2.0, such as, at least about 2.5 or at least about 3.0 or at least about 3.5 or at least about 4.0 or even at least about 4.5. It will be appreciated that the ceramization filler component may have an aspect ratio of any value within a range between any of the minimum and maximum values noted above. It will be further appreciated that the ceramization filler component may have an aspect ratio of any value between any of the minimum and maximum values noted above.

According to still other embodiments, the filler composition may include a particular content of the ceramization filler component. For example, the filler composition may include a ceramization filler component content of at least about 75 wt. % for a total weight of the filler composition, such as, at least about 76 wt. % or at least about 77 wt. % or at least about 78 wt. % or at least about 79 wt. % or at least about 80 wt. % or at least about 81 wt. % or at least about 82 wt. % or at least about 83 wt. % or at least about 84 wt. % or even at least about 85 wt. %. According to still other embodiments, the filler composition may include a ceramization filler component content of not greater than about 95 wt. % for a total weight of the filler composition, such as, not greater than about 94 wt. % or not greater than about 93 wt. % or not greater than about 92 wt. % or not greater than about 91 wt. % or not greater than about 90 wt. % or not greater than about 89 wt. % or not greater than about 88 wt. % or not greater than about 88 wt. % or even not greater than about 87 wt. %. It will be appreciated that filler composition may include a ceramization filler component content of any value within a range between any of the minimum and maximum values noted above. It will be further appreciated that the filler composition may include a ceramization filler component content of any value between any of the minimum and maximum values noted above.

According to still other embodiments, the ceramifiable layer may include a particular content of the ceramization filler component. For example, the ceramifiable layer may include a ceramization filler component content of at least about 50 wt. % for a total weight of the ceramifiable layer, such as, at least about 51 wt. % or at least about 52 wt. % or at least about 53 wt. % or at least about 54 wt. % or at least about 55 wt. % or at least about 56 wt. % or at least about 57 wt. % or at least about 58 wt. % or at least about 59 wt. % or even at least about 60 wt. %. According to still other embodiments, the ceramifiable layer may include a ceramization filler component content of not greater than about 70 wt. % for a total weight of the ceramifiable layer, such as, not greater than about 69 wt. % or not greater than about 68 wt. % or not greater than about 67 wt. % or not greater than about 66 wt. % or not greater than about 65 wt. % or not greater than about 64 wt. % or not greater than about 63 wt. % or not greater than about 62 wt. % or not greater than about 61 wt. % or even not greater than about 60 wt. %. It will be appreciated that ceramifiable layer may include a ceramization filler component content of any value within a range between any of the minimum and maximum values noted above. It will be further appreciated that the ceramifiable layer may include a ceramization filler component content of any value between any of the minimum and maximum values noted above.

According to particular embodiments, the structure promoter component of the filler composition may include particular components. For example, the structure promoter component may include a component selected from the group consisting of crystalline silica, diopside, spodumene, lepidolite, lithium carbonate, lithium hydroxide, or any combination thereof. According to still other embodiments, the structure promoter component may include crystalline silica. According to yet other embodiments, the structure promoter component may consist of crystalline silica. According to still other embodiments, the structure promoter component may include diopside. According to yet other embodiments, the structure promoter component may consist of diopside. According to still other embodiments, the structure promoter component may include spodumene. According to yet other embodiments, the structure promoter component may consist of spodumene. According to still other embodiments, the structure promoter component may include lepidolite. According to yet other embodiments, the structure promoter component may consist of lepidolite. According to still other embodiments, the structure promoter component may include lithium carbonate. According to yet other embodiments, the structure promoter component may consist of lithium carbonate. According to still other embodiments, the structure promoter component may include lithium hydroxide. According to yet other embodiments, the structure promoter component may consist of lithium hydroxide.

According to still other embodiments, the filler composition may include a particular content of the structure promoter component. For example, the filler composition may include a structure promoter component content of at least about 0.1 wt. % for a total weight of the filler composition, such as, at least about 0.5 wt. % or at least about 1.0 wt. % or at least about 1.5 wt. % or at least about 2.0 wt. % or at least about 2.5 wt. % or at least about 3.0 wt. % or even at least about 3.5 wt. %. According to still other embodiments, the filler composition may include a structure promoter component content of not greater than about 7.0 wt. % for a total weight of the filler composition, such as, not greater than about 6.5 wt. % or not greater than about 6.0 wt. % or not greater than about 5.5 wt. % or not greater than about 5.0 wt. % or not greater than about 4.5 wt. % or even not greater than about 4.0 wt. %. It will be appreciated that filler composition may include a structure promoter component content of any value within a range between any of the minimum and maximum values noted above. It will be further appreciated that the filler composition may include a structure promoter component content of any value between any of the minimum and maximum values noted above.

According to still other embodiments, the ceramifiable layer may include a particular content of the structure promoter component. For example, the ceramifiable layer may include a structure promoter component content of at least about 0.05 wt. % for a total weight of the ceramifiable layer, such as, at least about 0.1 wt. % or at least about 0.5 wt. % or at least about 1.0 wt. % or at least about 1.5 wt. % or at least about 2.0 wt. % or even at least about 2.5 wt. %. According to still other embodiments, the ceramifiable layer may include a structure promoter component content of not greater than about 5.0 wt. % for a total weight of the ceramifiable layer, such as, not greater than about 4.5 wt. % or not greater than about 4.0 wt. % or not greater than about 3.5 wt. % or even not greater than about 3.0 wt. %. It will be appreciated that ceramifiable layer may include a structure promoter component content of any value within a range between any of the minimum and maximum values noted above. It will be further appreciated that the ceramifiable layer may include a structure promoter component content of any value between any of the minimum and maximum values noted above.

According to particular embodiments, the flux component of the filler composition may include particular components. For example, the flux component may include a component selected from the group consisting of low T glass frit, zinc oxide, zinc borate, antimony (III) oxide, bismuth (III) oxide, or any combination thereof. According to still other embodiments, the flux component may include low T glass frit. According to yet other embodiments, the flux component may consist of low T glass frit. According to still other embodiments, the flux component may include zinc oxide. According to yet other embodiments, the flux component may consist of zinc oxide. According to still other embodiments, the flux component may include zinc borate. According to yet other embodiments, the flux component may consist of zinc borate. According to still other embodiments, the flux component may include antimony (III) oxide. According to yet other embodiments, the flux component may consist of antimony (III) oxide. According to still other embodiments, the flux component may include bismuth (III) oxide. According to yet other embodiments, the flux component may consist of bismuth (III) oxide.

According to still other embodiments, the filler composition may include a particular content of the flux component. For example, the filler composition may include a flux component content of at least about 0.1 wt. % for a total weight of the filler composition, such as, at least about 0.5 wt. % or at least about 1.0 wt. % or at least about 1.5 wt. % or at least about 2.0 wt. % or at least about 2.5 wt. % or at least about 3.0 wt. % or even at least about 3.5 wt. %. According to still other embodiments, the filler composition may include a flux component content of not greater than about 7.0 wt. % for a total weight of the filler composition, such as, not greater than about 6.5 wt. % or not greater than about 6.0 wt. % or not greater than about 5.5 wt. % or not greater than about 5.0 wt. % or not greater than about 4.5 wt. % or even not greater than about 4.0 wt. %. It will be appreciated that filler composition may include a flux component content of any value within a range between any of the minimum and maximum values noted above. It will be further appreciated that the filler composition may include a flux component content of any value between any of the minimum and maximum values noted above.

According to still other embodiments, the ceramifiable layer may include a particular content of the flux component. For example, the ceramifiable layer may include a flux component content of at least about 0.01 wt. % for a total weight of the ceramifiable layer, such as, at least about 0.05 wt. % or at least about 0.1 wt. % or at least about 0.5 wt. % or at least about 1.0 wt. % or at least about 1.5 wt. % or at least about 2.0 wt. % or even at least about 2.5 wt. %. According to still other embodiments, the ceramifiable layer may include a flux component content of not greater than about 5.0 wt. % for a total weight of the ceramifiable layer, such as, not greater than about 4.5 wt. % or not greater than about 4.0 wt. % or not greater than about 3.5 wt. % or even not greater than about 3.0 wt. %. It will be appreciated that ceramifiable layer may include a flux component content of any value within a range between any of the minimum and maximum values noted above. It will be further appreciated that the ceramifiable layer may include a flux component content of any value between any of the minimum and maximum values noted above.

According to particular embodiments, the flame retardant component of the filler composition may include particular components. For example, the flame retardant component may include a component selected from the group consisting of aluminum hydroxide, magnesium hydroxide, or any combination thereof. According to still other embodiments, the flame retardant component may include aluminum hydroxide. According to yet other embodiments, the flame retardant component may consist of aluminum hydroxide. According to still other embodiments, the flame retardant component may include magnesium hydroxide. According to yet other embodiments, the flame retardant component may consist of magnesium hydroxide.

According to still other embodiments, the filler composition may include a particular content of the flame retardant component. For example, the filler composition may include a flame retardant component content of at least about 5.0 wt. % for a total weight of the filler composition, such as, at least about 6.0 wt. % or at least about 7.0 wt. % or at least about 8.0 wt. % or at least about 9.0 wt. % or at least about 10.0 wt. % or at least about 11.0 wt. % or even at least about 12.0 wt. %. According to still other embodiments, the filler composition may include a flame retardant component content of not greater than about 20.0 wt. % for a total weight of the filler composition, such as, not greater than about 19.0 wt. % or not greater than about 18.0 wt. % or not greater than about 17.0 wt. % or not greater than about 16.0 wt. % or not greater than about 15.0 wt. % or even not greater than about 14.0 wt. %. It will be appreciated that filler composition may include a flame retardant component content of any value within a range between any of the minimum and maximum values noted above. It will be further appreciated that the filler composition may include a flame retardant component content of any value between any of the minimum and maximum values noted above.

According to still other embodiments, the ceramifiable layer may include a particular content of the flame retardant component. For example, the ceramifiable layer may include a flame retardant component content of at least about 2.5 wt. % for a total weight of the ceramifiable layer, such as, at least about 3.0 wt. % or at least about 3.5 wt. % or at least about 4.0 wt. % or at least about 4.5 wt. % or at least about 5.0 wt. % or at least about 5.5 wt. % or even at least about 6.0 wt. %. According to still other embodiments, the ceramifiable layer may include a flame retardant component content of not greater than about 10.0 wt. % for a total weight of the ceramifiable layer, such as, not greater than about 9.5 wt. % or not greater than about 9.0 wt. % or not greater than about 8.5 wt. % or not greater than about 8.0 wt. % or not greater than about 7.5 wt. % or even not greater than about 7.0 wt. %. It will be appreciated that ceramifiable layer may include a flame retardant component content of any value within a range between any of the minimum and maximum values noted above. It will be further appreciated that the ceramifiable layer may include a flame retardant component content of any value between any of the minimum and maximum values noted above.

According to still other embodiments, the filler composition may further include a functional additive. According to yet other embodiments, the functional additive may include a particular component. For example, the functional additive may include a component selected from the group consisting of iron (III) oxide, titanium oxide, or any combination thereof. According to still other embodiments, the functional additive component may include iron (III) oxide. According to yet other embodiments, the functional additive component may consist of iron (III) oxide. According to still other embodiments, the functional additive component may include titanium oxide. According to yet other embodiments, the functional additive component may consist of titanium oxide.

According to still other embodiments, the filler composition may include a particular content of the functional additive. For example, the filler composition may include a functional additive content of at least about 0.1 wt. % for a total weight of the filler composition, such as, at least about 0.5 wt. % or at least about 1.0 wt. % or at least about 1.5 wt. % or at least about 2.0 wt. % or at least about 2.5 wt. % or at least about 3.0 wt. % or even at least about 3.5 wt. %. According to still other embodiments, the filler composition may include a functional additive content of not greater than about 7.0 wt. % for a total weight of the filler composition, such as, not greater than about 6.5 wt. % or not greater than about 6.0 wt. % or not greater than about 5.5 wt. % or not greater than about 5.0 wt. % or not greater than about 4.5 wt. % or even not greater than about 4.0 wt. %. It will be appreciated that filler composition may include a functional additive content of any value within a range between any of the minimum and maximum values noted above. It will be further appreciated that the filler composition may include a functional additive content of any value between any of the minimum and maximum values noted above.

According to still other embodiments, the ceramifiable layer may include a particular content of the functional additive. For example, the ceramifiable layer may include a functional additive content of at least about 0.05 wt. % for a total weight of the ceramifiable layer, such as, at least about 0.1 wt. % or at least about 0.5 wt. % or at least about 1.0 wt. % or at least about 1.5 wt. % or at least about 2.0 wt. % or even at least about 2.5 wt. %. According to still other embodiments, the ceramifiable layer may include a functional additive content of not greater than about 5.0 wt. % for a total weight of the ceramifiable layer, such as, not greater than about 4.5 wt. % or not greater than about 4.0 wt. % or not greater than about 3.5 wt. % or even not greater than about 3.0 wt. %. It will be appreciated that ceramifiable layer may include a functional additive content of any value within a range between any of the minimum and maximum values noted above. It will be further appreciated that the ceramifiable layer may include a functional additive content of any value between any of the minimum and maximum values noted above.

According to certain embodiments, the ceramifiable layer may have a particular flammability rating as measured according to ASTM D3801. In particular, the ceramifiable layer may have a V-0 flammability rating as measured according to ASTM D3801.

According to still other embodiments, the ceramifiable layer may have a particular 5-minute hot plate exposure (HPE) cold-side temperature as measured using a hot plate test conducted at 800° C. for 5 minutes. For purposes of embodiments described herein, the hot plate test is carried out by preparing a 15 cm by 25 cm specimen of the ceramifiable layer laminated onto a layer of alkaline free glass fabric having a thickness of 0.3 mm, such that the total specimen thickness is 1.5 mm. The specimen is placed on top of a hot plate adjusted to the desired temperature with the ceramifiable layer side of the specimen facing the hot pate. An infrared (IR) thermometer is used to measure the temperature at the central point of the cold side surface (i.e., the side of the specimen opposite the hot pate) of the sample at the designated time. According to certain embodiments, the ceramifiable layer may have a 5 minute HPE cold side temperature of not greater than about 800° ° C., such as, not greater than about 775° C. or not greater than about 750° C. or not greater than about 725° C. or not greater than about 700° C. or not greater than about 675° C. or not greater than about 650° C. or not greater than about 625° C. or even not greater than about 600° ° C. According to still other embodiments, the ceramifiable layer may have a 5-minute HPE cold side temperature of at least about 25° C. It will be appreciated that the 5-minute HPE cold side temperature of the ceramifiable layer may be within a range between any of the values noted above. It will be further appreciated that the 5-minute HPE cold side temperature of the ceramifiable layer may be any value between any of the values noted above.

According to still other embodiments, the ceramifiable layer may have a particular 15-minute hot plate exposure (HPE) cold-side temperature as measured using a hot plate test conducted at 800° C. for 15 minutes. For purposes of embodiments described herein, the hot plate test is carried out by preparing a 15 cm by 25 cm specimen of the ceramifiable layer laminated onto a layer of alkaline free glass fabric having a thickness of 0.3 mm, such that the total specimen thickness is 1.5 mm. The specimen is placed on top of a hot plate adjusted to the desired temperature with the ceramifiable layer side of the specimen facing the hot pate. An infrared (IR) thermometer is used to measure the temperature at the central point of the cold side surface (i.e., the side of the specimen opposite the hot pate) of the sample at the designated time. According to certain embodiments, the ceramifiable layer may have a 15 minute HPE cold side temperature of not greater than about 800° C., such as, not greater than about 775° C. or not greater than about 750° C. or not greater than about 725° C. or not greater than about 700° C. or not greater than about 675° C. or not greater than about 650° C. or not greater than about 625° C. or even not greater than about 600° C. According to still other embodiments, the ceramifiable layer may have a 15-minute HPE cold side temperature of at least about 25° C. It will be appreciated that the 15-minute HPE cold side temperature of the ceramifiable layer may be within a range between any of the values noted above. It will be further appreciated that the 15-minute HPE cold side temperature of the ceramifiable layer may be any value between any of the values noted above.

According to still other embodiments, the ceramifiable layer may have a particular 30-minute hot plate exposure (HPE) cold-side temperature as measured using a hot plate test conducted at 800° C. for 30 minutes. For purposes of embodiments described herein, the hot plate test is carried out by preparing a 15 cm by 25 cm specimen of the ceramifiable layer laminated onto a layer of alkaline free glass fabric having a thickness of 0.3 mm, such that the total specimen thickness is 1.5 mm. The specimen is placed on top of a hot plate adjusted to the desired temperature with the ceramifiable layer side of the specimen facing the hot pate. An infrared (IR) thermometer is used to measure the temperature at the central point of the cold side surface (i.e., the side of the specimen opposite the hot pate) of the sample at the designated time. According to certain embodiments, the ceramifiable layer may have a 30 minute HPE cold side temperature of not greater than about 800° C., such as, not greater than about 775° C. or not greater than about 750° C. or not greater than about 725° C. or not greater than about 700° C. or not greater than about 675° C. or not greater than about 650° C. or not greater than about 625° C. or even not greater than about 600° C. According to still other embodiments, the ceramifiable layer may have a 30-minute HPE cold side temperature of at least about 25° C. It will be appreciated that the 30-minute HPE cold side temperature of the ceramifiable layer may be within a range between any of the values noted above. It will be further appreciated that the 30-minute HPE cold side temperature of the ceramifiable layer may be any value between any of the values noted above.

According to still other embodiments, the ceramifiable layer may have a particular 5-minute torch exposure (TE) cold-side temperature as measured using a torch test conducted at 1300° ° C. for 5 minutes. For purposes of embodiments described herein, the torch test is carried out by preparing a 15 cm by 15 cm specimen of the ceramifiable layer laminated onto a layer of alkaline free glass fabric having a thickness of 0.3 mm, such that the total specimen thickness is 1.5 mm. The specimen is fixed on a holder. A torch is placed 7 cm away from a face of the specimen fixed on the holder with the ceramifiable layer side of the specimen facing the torch. The torch is adjusted to produce an outer flame just touching the central point of the ceramifiable layer side of the specimen that reaches and is stabilized at a desired temperature as measured using a thermometer at point where the flam touches the specimen. An infrared (IR) thermometer or a thermocouple is used to measure the temperature at the central point of the cold side surface (i.e., the side of the specimen opposite the torch) of the sample at the designated time. According to certain embodiments, the ceramifiable layer may have a 5 minute TE cold side temperature of not greater than about 800° C., such as, not greater than about 775° C. or not greater than about 750° C. or not greater than about 725° C. or not greater than about 700° C. or not greater than about 675° C. or not greater than about 650° C. or not greater than about 625° C. or even not greater than about 600° C. According to still other embodiments, the ceramifiable layer may have a 5-minute TE cold side temperature of at least about 25° C. It will be appreciated that the 5-minute TE cold side temperature of the ceramifiable layer may be within a range between any of the values noted above. It will be further appreciated that the 5-minute TE cold side temperature of the ceramifiable layer may be any value between any of the values noted above.

According to still other embodiments, the ceramifiable layer may have a particular 15-minute torch exposure (TE) cold-side temperature as measured using a torch test conducted at 1300° C. for 15 minutes. For purposes of embodiments described herein, the torch test is carried out by preparing a 15 cm by 15 cm specimen of the ceramifiable layer laminated onto a layer of alkaline free glass fabric having a thickness of 0.3 mm, such that the total specimen thickness is 1.5 mm. The specimen is fixed on a holder. A torch is placed 7 cm away from a face of the specimen fixed on the holder with the ceramifiable layer side of the specimen facing the torch. The torch is adjusted to produce an outer flame just touching the central point of the ceramifiable layer side of the specimen that reaches and is stabilized at a desired temperature as measured using a thermometer at point where the flam touches the specimen. An infrared (IR) thermometer or a thermocouple is used to measure the temperature at the central point of the cold side surface (i.e., the side of the specimen opposite the torch) of the sample at the designated time. According to certain embodiments, the ceramifiable layer may have a 15 minute TE cold side temperature of not greater than about 800° C., such as, not greater than about 775° C. or not greater than about 750° ° C. or not greater than about 725° C. or not greater than about 700° C. or not greater than about 675° C. or not greater than about 650° C. or not greater than about 625° C. or even not greater than about 600° C. According to still other embodiments, the ceramifiable layer may have a 15-minute TE cold side temperature of at least about 25° C. It will be appreciated that the 15-minute TE cold side temperature of the ceramifiable layer may be within a range between any of the values noted above. It will be further appreciated that the 15-minute TE cold side temperature of the ceramifiable layer may be any value between any of the values noted above.

According to still other embodiments, the ceramifiable layer may have a particular 30-minute torch exposure (TE) cold-side temperature as measured using a torch test conducted at 1300° ° C. for 30 minutes. For purposes of embodiments described herein, the torch test is carried out by preparing a 15 cm by 15 cm specimen of the ceramifiable layer laminated onto a layer of alkaline free glass fabric having a thickness of 0.3 mm, such that the total specimen thickness is 1.5 mm. The specimen is fixed on a holder. A torch is placed 7 cm away from a face of the specimen fixed on the holder with the ceramifiable layer side of the specimen facing the torch. The torch is adjusted to produce an outer flame just touching the central point of the ceramifiable layer side of the specimen that reaches and is stabilized at a desired temperature as measured using a thermometer at point where the flam touches the specimen. An infrared (IR) thermometer or a thermocouple is used to measure the temperature at the central point of the cold side surface (i.e., the side of the specimen opposite the torch) of the sample at the designated time. According to certain embodiments, the ceramifiable layer may have a 30 minute TE cold side temperature of not greater than about 800° C., such as, not greater than about 775° C. or not greater than about 750° C. or not greater than about 725° C. or not greater than about 700° C. or not greater than about 675° C. or not greater than about 650° C. or not greater than about 625° C. or even not greater than about 600° C. According to still other embodiments, the ceramifiable layer may have a 30-minute TE cold side temperature of at least about 25° C. It will be appreciated that the 30-minute TE cold side temperature of the ceramifiable layer may be within a range between any of the values noted above. It will be further appreciated that the 30-minute TE cold side temperature of the ceramifiable layer may be any value between any of the values noted above.

According to yet other embodiments, the ceramifiable layer may have a particular density. For purpose of embodiments described herein, the density of the ceramifiable layer may be determined according to ASTM D1056. According to certain embodiments, the ceramifiable layer may have a density of not greater than about 1.7 kg/m³, such as, not great than about 1.6 kg/m³ or not greater than about 1.5 kg/m³ or not greater than about 1.4 kg/m³ or not greater than about 1.3 kg/m³ or not greater than about 1.2 kg/m³ or not greater than about 1.1 kg/m³ or not greater than about 1.0 kg/m³ or not greater than about 0.9 kg/m³ or not greater than about 0.8 kg/m³ or not greater than about 0.7 kg/m³ or not greater than about 0.6 kg/m³ or not greater than about 0.5 kg/m³ or even not greater than about 0.4 kg/m³. According to yet other embodiments, the ceramifiable layer may have a density of at least about 0.001 kg/m³. It will be appreciated that the density of the ceramifiable layer may be within a range between any of the minimum and maximum values noted above. It will be further appreciated that the density of the ceramifiable layer may be any value between any of the minimum and maximum values noted above.

According to yet other embodiments, the ceramifiable layer may have a particular weight. According to certain embodiments, the ceramifiable layer may have a weight of at least about 0.001 kg/m², such as, at least about 0.005 kg/m² or at least about 0.01 kg/m² or at least about 0.05 kg/m² or at least about 0.1 kg/m² or at least about 0.5 kg/m² or at least about 1.0 kg/m² or even at least about 1.5 kg/m². According to yet other embodiments, the ceramifiable layer may have a weight of not greater than about 2.61 kg/m². It will be appreciated that the weight of the ceramifiable layer may be within a range between any of the minimum and maximum values noted above. It will be further appreciated that the weight of the ceramifiable layer may be any value between any of the minimum and maximum values noted above.

According to yet other embodiments, the ceramifiable layer may have a particular hardness. For purpose of embodiments described herein, the hardness of the ceramifiable layer may be determined according to ASTM D2240. According to certain embodiments, the ceramifiable layer may have a hardness of at least about 61 Shore A, such as, at least about 62 Shore A or at least about 63 Shore A or at least about 64 Shore A or even at least about 65 Shore A. According to yet other embodiments, the ceramifiable layer may have a hardness of not greater than about 71 Shore A, such as, not greater than about 70 Shore A or not greater than about 69 Shore A or not greater than about 68 Shore A or not greater than about 67 Shore A or even not greater than about 66 Shore A. It will be appreciated that the hardness of the ceramifiable layer may be within a range between any of the minimum and maximum values noted above. It will be further appreciated that the hardness of the ceramifiable layer may be any value between any of the minimum and maximum values noted above.

According to yet other embodiments, the ceramifiable layer may have a particular tensile strength. For purpose of embodiments described herein, the tensile strength of the ceramifiable layer may be determined according to ASTM D412. According to certain embodiments, the ceramifiable layer may have a tensile strength of at least about 2.3 MPa, such as, at least about 2.5 MPa or at least about 5 MPa or at least about 10 MPa or at least about 20 MPa or at least about 30 MPa or at least about 40 MPa or at least about 50 MPa or at least about 100 MPa or even at least about 150 MPa. According to yet other embodiments, the ceramifiable layer may have a tensile strength of not greater than about 500 MPa. It will be appreciated that the tensile strength of the ceramifiable layer may be within a range between any of the minimum and maximum values noted above. It will be further appreciated that the tensile strength of the ceramifiable layer may be any value between any of the minimum and maximum values noted above.

According to certain embodiments, cermifiable layers described herein may be formed according to any acceptable forming process for a composite material layer.

According to certain other embodiments, the filler composition of the cermifiable layer may be a different filler composition. According to certain embodiments, the filler composition may include a ceramization filler component, a reinforcement component, a flux component, and a flame retardant component.

According to particular embodiments, the ceramization filler component of the filler composition may include particular components. For example, the ceramization filler component may include a component selected from the group consisting of aluminum silicate, zirconium silicate, zirconia, alumina, or any combination thereof. According to still other embodiments, the ceramization filler component may include aluminum silicate. According to yet other embodiments, the ceramization filler component may consist of aluminum silicate. According to still other embodiments, the ceramization filler component may include zirconium silicate. According to yet other embodiments, the ceramization filler component may consist of zirconium silicate. According to still other embodiments, the ceramization filler component may include zirconia. According to yet other embodiments, the ceramization filler component may consist of zirconia. According to still other embodiments, the ceramization filler component may include alumina. According to yet other embodiments, the ceramization filler component may consist of alumina.

According to still other embodiments, the filler composition may include a particular content of the ceramization filler component. For example, the filler composition may include a ceramization filler component content of at least about 50 wt. % for a total weight of the filler composition, such as, at least about 53 wt. % or at least about 55 wt. % or at least about 58 wt. % or at least about 60 wt. % or at least about 63 wt. % or at least about 65 wt. % or at least about 68 wt. % or at least about 70 wt. % or at least about 73 wt. % or even at least about 75 wt. %. According to still other embodiments, the filler composition may include a ceramization filler component content of not greater than about 90 wt. % for a total weight of the filler composition, such as, not greater than about 89 wt. % or not greater than about 88 wt. % or not greater than about 87 wt. % or not greater than about 86 wt. % or not greater than about 85 wt. % or not greater than about 84 wt. % or not greater than about 83 wt. % or not greater than about 82 wt. % or not greater than about 81 wt. % or even not greater than about 80 wt. %. It will be appreciated that filler composition may include a ceramization filler component content of any value within a range between any of the minimum and maximum values noted above. It will be further appreciated that the filler composition may include a ceramization filler component content of any value between any of the minimum and maximum values noted above.

According to still other embodiments, the ceramifiable layer may include a particular content of the ceramization filler component. For example, the ceramifiable layer may include a ceramization filler component content of at least about 25 wt. % for a total weight of the ceramifiable layer, such as, at least about 26 wt. % or at least about 27 wt. % or at least about 28 wt. % or at least about 29 wt. % or at least about 30 wt. % or at least about 31 wt. % or at least about 32 wt. % or at least about 33 wt. % or at least about 34 wt. % or even at least about 35 wt. %. According to still other embodiments, the ceramifiable layer may include a ceramization filler component content of not greater than about 65 wt. % for a total weight of the ceramifiable layer, such as, not greater than about 64 wt. % or not greater than about 68 wt. % or not greater than about 63 wt. % or not greater than about 62 wt. % or not greater than about 61 wt. % or not greater than about 60 wt. % or not greater than about 59 wt. % or not greater than about 58 wt. % or not greater than about 57 wt. % or even not greater than about 56 wt. %. It will be appreciated that ceramifiable layer may include a ceramization filler component content of any value within a range between any of the minimum and maximum values noted above. It will be further appreciated that the ceramifiable layer may include a ceramization filler component content of any value between any of the minimum and maximum values noted above.

According to particular embodiments, the reinforcement component of the filler composition may include particular components. According to certain embodiments, the reinforcement component may include wollastonite. According to yet other embodiments, the reinforcement component may consist of wollastonite.

According to still other embodiments, the filler composition may include a particular content of the reinforcement component. For example, the filler composition may include a reinforcement component content of at least about 0.1 wt. % for a total weight of the filler composition, such as, at least about 0.5 wt. % or at least about 1.0 wt. % or at least about 1.5 wt. % or at least about 2.0 wt. % or at least about 2.5 wt. % or at least about 3.0 wt. % or even at least about 3.5 wt. %. According to still other embodiments, the filler composition may include a reinforcement component content of not greater than about 10.0 wt. % for a total weight of the filler composition, such as, not greater than about 9.5 wt. % or not greater than about 9.0 wt. % or not greater than about 8.5 wt. % or not greater than about 8.0 wt. % or not greater than about 7.5 wt. % or even not greater than about 7.0 wt. %. It will be appreciated that filler composition may include a reinforcement component content of any value within a range between any of the minimum and maximum values noted above. It will be further appreciated that the filler composition may include a reinforcement component content of any value between any of the minimum and maximum values noted above.

According to still other embodiments, the ceramifiable layer may include a particular content of the reinforcement component. For example, the ceramifiable layer may include a reinforcement component content of at least about 0.05 wt. % for a total weight of the ceramifiable layer, such as, at least about 0.1 wt. % or at least about 0.5 wt. % or at least about 1.0 wt. % or at least about 1.5 wt. % or at least about 2.0 wt. % or even at least about 2.5 wt. %. According to still other embodiments, the ceramifiable layer may include a reinforcement component content of not greater than about 9.0 wt. % for a total weight of the ceramifiable layer, such as, not greater than about 8.5 wt. % or not greater than about 8.0 wt. % or not greater than about 7.5 wt. % or even not greater than about 6.0 wt. %. It will be appreciated that ceramifiable layer may include a reinforcement component content of any value within a range between any of the minimum and maximum values noted above. It will be further appreciated that the ceramifiable layer may include a reinforcement component content of any value between any of the minimum and maximum values noted above.

According to particular embodiments, the flux component of the filler composition may include particular components. For example, the flux component may include a component selected from the group consisting of low T glass frit, zinc oxide, zinc borate, antimony (III) oxide, bismuth (III) oxide, or any combination thereof. According to still other embodiments, the flux component may include low T glass frit. According to yet other embodiments, the flux component may consist of low T glass frit. According to still other embodiments, the flux component may include zinc oxide. According to yet other embodiments, the flux component may consist of zinc oxide. According to still other embodiments, the flux component may include zinc borate. According to yet other embodiments, the flux component may consist of zinc borate. According to still other embodiments, the flux component may include antimony (III) oxide. According to yet other embodiments, the flux component may consist of antimony (III) oxide. According to still other embodiments, the flux component may include bismuth (III) oxide. According to yet other embodiments, the flux component may consist of bismuth (III) oxide.

According to still other embodiments, the filler composition may include a particular content of the flux component. For example, the filler composition may include a flux component content of at least about 3.0 wt. % for a total weight of the filler composition, such as, at least about 3.5 wt. % or at least about 4.0 wt. % or at least about 4.5 wt. % or at least about 5.0 wt. % or at least about 5.5 wt. % or at least about 6.0 wt. % or even at least about 6.5 wt. %. According to still other embodiments, the filler composition may include a flux component content of not greater than about 10.0 wt. % for a total weight of the filler composition, such as, not greater than about 9.5 wt. % or not greater than about 8.0 wt. % or not greater than about 7.5 wt. % or even not greater than about 7.0 wt. %. It will be appreciated that filler composition may include a flux component content of any value within a range between any of the minimum and maximum values noted above. It will be further appreciated that the filler composition may include a flux component content of any value between any of the minimum and maximum values noted above.

According to still other embodiments, the ceramifiable layer may include a particular content of the flux component. For example, the ceramifiable layer may include a flux component content of at least about 1.5 wt. % for a total weight of the ceramifiable layer, such as, at least about 1.6 wt. % or at least about 1.7 wt. % or at least about 1.8 wt. % or at least about 1.9 wt. % or at least about 2.0 wt. % or even at least about 2.5 wt. %. According to still other embodiments, the ceramifiable layer may include a flux component content of not greater than about 9.0 wt. % for a total weight of the ceramifiable layer, such as, not greater than about 8.5 wt. % or not greater than about 8.0 wt. % or not greater than about 7.5 wt. % or even not greater than about 7.0 wt. %. It will be appreciated that ceramifiable layer may include a flux component content of any value within a range between any of the minimum and maximum values noted above. It will be further appreciated that the ceramifiable layer may include a flux component content of any value between any of the minimum and maximum values noted above.

According to particular embodiments, the flame retardant component of the filler composition may include particular components. For example, the flame retardant component may include a component selected from the group consisting of aluminum hydroxide, magnesium hydroxide, or any combination thereof. According to still other embodiments, the flame retardant component may include aluminum hydroxide. According to yet other embodiments, the flame retardant component may consist of aluminum hydroxide. According to still other embodiments, the flame retardant component may include magnesium hydroxide. According to yet other embodiments, the flame retardant component may consist of magnesium hydroxide.

According to still other embodiments, the filler composition may include a particular content of the flame retardant component. For example, the filler composition may include a flame retardant component content of at least about 5.0 wt. % for a total weight of the filler composition, such as, at least about 6.0 wt. % or at least about 7.0 wt. % or at least about 8.0 wt. % or at least about 9.0 wt. % or at least about 10.0 wt. % or at least about 11.0 wt. % or even at least about 12.0 wt. %. According to still other embodiments, the filler composition may include a flame retardant component content of not greater than about 20.0 wt. % for a total weight of the filler composition, such as, not greater than about 19.0 wt. % or not greater than about 18.0 wt. % or not greater than about 17.0 wt. % or not greater than about 16.0 wt. % or not greater than about 15.0 wt. % or even not greater than about 14.0 wt. %. It will be appreciated that filler composition may include a flame retardant component content of any value within a range between any of the minimum and maximum values noted above. It will be further appreciated that the filler composition may include a flame retardant component content of any value between any of the minimum and maximum values noted above.

According to still other embodiments, the ceramifiable layer may include a particular content of the flame retardant component. For example, the ceramifiable layer may include a flame retardant component content of at least about 2.5 wt. % for a total weight of the ceramifiable layer, such as, at least about 3.0 wt. % or at least about 3.5 wt. % or at least about 4.0 wt. % or at least about 4.5 wt. % or at least about 5.0 wt. % or at least about 5.5 wt. % or even at least about 6.0 wt. %. According to still other embodiments, the ceramifiable layer may include a flame retardant component content of not greater than about 18.0 wt. % for a total weight of the ceramifiable layer, such as, not greater than about 17.5 wt. % or not greater than about 17.0 wt. % or not greater than about 16.5 wt. % or not greater than about 16.0 wt. % or not greater than about 15.5 wt. % or even not greater than about 15.0 wt. %. It will be appreciated that ceramifiable layer may include a flame retardant component content of any value within a range between any of the minimum and maximum values noted above. It will be further appreciated that the ceramifiable layer may include a flame retardant component content of any value between any of the minimum and maximum values noted above.

According to still other embodiments, the filler composition may further include a functional additive. According to yet other embodiments, the functional additive may include a particular component. For example, the functional additive may include a component selected from the group consisting of iron (III) oxide, titanium oxide, or any combination thereof. According to still other embodiments, the functional additive component may include iron (III) oxide. According to yet other embodiments, the functional additive component may consist of iron (III) oxide. According to still other embodiments, the functional additive component may include titanium oxide. According to yet other embodiments, the functional additive component may consist of titanium oxide.

According to still other embodiments, the filler composition may include a particular content of the functional additive. For example, the filler composition may include a functional additive content of at least about 0.1 wt. % for a total weight of the filler composition, such as, at least about 0.5 wt. % or at least about 1.0 wt. % or at least about 1.5 wt. % or at least about 2.0 wt. % or at least about 2.5 wt. % or at least about 3.0 wt. % or even at least about 3.5 wt. %. According to still other embodiments, the filler composition may include a functional additive content of not greater than about 7.0 wt. % for a total weight of the filler composition, such as, not greater than about 6.5 wt. % or not greater than about 6.0 wt. % or not greater than about 5.5 wt. % or not greater than about 5.0 wt. % or not greater than about 4.5 wt. % or even not greater than about 4.0 wt. %. It will be appreciated that filler composition may include a functional additive content of any value within a range between any of the minimum and maximum values noted above. It will be further appreciated that the filler composition may include a functional additive content of any value between any of the minimum and maximum values noted above.

According to still other embodiments, the ceramifiable layer may include a particular content of the functional additive. For example, the ceramifiable layer may include a functional additive content of at least about 0.05 wt. % for a total weight of the ceramifiable layer, such as, at least about 0.1 wt. % or at least about 0.5 wt. % or at least about 1.0 wt. % or at least about 1.5 wt. % or at least about 2.0 wt. % or even at least about 2.5 wt. %. According to still other embodiments, the ceramifiable layer may include a functional additive content of not greater than about 6.5 wt. % for a total weight of the ceramifiable layer, such as, not greater than about 6.0 wt. % or not greater than about 5.5 wt. % or not greater than about 5.0 wt. % or even not greater than about 4.5 wt. %. It will be appreciated that ceramifiable layer may include a functional additive content of any value within a range between any of the minimum and maximum values noted above. It will be further appreciated that the ceramifiable layer may include a functional additive content of any value between any of the minimum and maximum values noted above.

According to certain embodiments, the ceramifiable layer may have a particular flammability rating as measured according to ASTM D3801. In particular, the ceramifiable layer may have a V-0 flammability rating as measured according to ASTM D3801.

According to still other embodiments, the ceramifiable layer may have a particular 5-minute hot plate exposure (HPE) cold-side temperature as measured using a hot plate test conducted at 800° ° C. for 5 minutes. For purposes of embodiments described herein, the hot plate test is carried out by preparing a 15 cm by 25 cm specimen of the ceramifiable layer laminated onto a layer of alkaline free glass fabric having a thickness of 0.3 mm, such that the total specimen thickness is 1.5 mm. The specimen is placed on top of a hot plate adjusted to the desired temperature with the ceramifiable layer side of the specimen facing the hot pate. An infrared (IR) thermometer is used to measure the temperature at the central point of the cold side surface (i.e., the side of the specimen opposite the hot pate) of the sample at the designated time. According to certain embodiments, the ceramifiable layer may have a 5 minute HPE cold side temperature of not greater than about 800° C., such as, not greater than about 775° C. or not greater than about 750° C. or not greater than about 725° C. or not greater than about 700° C. or not greater than about 675° C. or not greater than about 650° C. or not greater than about 625° C. or even not greater than about 600° C. According to still other embodiments, the ceramifiable layer may have a 5-minute HPE cold side temperature of at least about 25° C. It will be appreciated that the 5-minute HPE cold side temperature of the ceramifiable layer may be within a range between any of the values noted above. It will be further appreciated that the 5-minute HPE cold side temperature of the ceramifiable layer may be any value between any of the values noted above.

According to still other embodiments, the ceramifiable layer may have a particular 15-minute hot plate exposure (HPE) cold-side temperature as measured using a hot plate test conducted at 800° C. for 15 minutes. For purposes of embodiments described herein, the hot plate test is carried out by preparing a 15 cm by 25 cm specimen of the ceramifiable layer laminated onto a layer of alkaline free glass fabric having a thickness of 0.3 mm, such that the total specimen thickness is 1.5 mm. The specimen is placed on top of a hot plate adjusted to the desired temperature with the ceramifiable layer side of the specimen facing the hot pate. An infrared (IR) thermometer is used to measure the temperature at the central point of the cold side surface (i.e., the side of the specimen opposite the hot pate) of the sample at the designated time. According to certain embodiments, the ceramifiable layer may have a 15 minute HPE cold side temperature of not greater than about 800° C., such as, not greater than about 775° C. or not greater than about 750° C. or not greater than about 725° C. or not greater than about 700° C. or not greater than about 675° C. or not greater than about 650° C. or not greater than about 625° C. or even not greater than about 600° C. According to still other embodiments, the ceramifiable layer may have a 15-minute HPE cold side temperature of at least about 25° C. It will be appreciated that the 15-minute HPE cold side temperature of the ceramifiable layer may be within a range between any of the values noted above. It will be further appreciated that the 15-minute HPE cold side temperature of the ceramifiable layer may be any value between any of the values noted above.

According to still other embodiments, the ceramifiable layer may have a particular 30-minute hot plate exposure (HPE) cold-side temperature as measured using a hot plate test conducted at 800° ° C. for 30 minutes. For purposes of embodiments described herein, the hot plate test is carried out by preparing a 15 cm by 25 cm specimen of the ceramifiable layer laminated onto a layer of alkaline free glass fabric having a thickness of 0.3 mm, such that the total specimen thickness is 1.5 mm. The specimen is placed on top of a hot plate adjusted to the desired temperature with the ceramifiable layer side of the specimen facing the hot pate. An infrared (IR) thermometer is used to measure the temperature at the central point of the cold side surface (i.e., the side of the specimen opposite the hot pate) of the sample at the designated time. Then an infrared (IR) thermometer is used to measure the cold side surface temperature of the sample at the designated time. According to certain embodiments, the ceramifiable layer may have a 30 minute HPE cold side temperature of not greater than about 800° C., such as, not greater than about 775° C. or not greater than about 750° C. or not greater than about 725° C. or not greater than about 700° C. or not greater than about 675° C. or not greater than about 650° C. or not greater than about 625° C. or even not greater than about 600° C. According to still other embodiments, the ceramifiable layer may have a 30-minute HPE cold side temperature of at least about 25° C. It will be appreciated that the 30-minute HPE cold side temperature of the ceramifiable layer may be within a range between any of the values noted above. It will be further appreciated that the 30-minute HPE cold side temperature of the ceramifiable layer may be any value between any of the values noted above.

According to still other embodiments, the ceramifiable layer may have a particular 5-minute torch exposure (TE) cold-side temperature as measured using a torch test conducted at 1500° C. for 5 minutes. For purposes of embodiments described herein, the torch test is carried out by preparing a 15 cm by 15 cm specimen of the ceramifiable layer laminated onto a layer of alkaline free glass fabric having a thickness of 0.3 mm, such that the total specimen thickness is 1.5 mm. The specimen is fixed on a holder. A torch is placed 7 cm away from a face of the specimen fixed on the holder with the ceramifiable layer side of the specimen facing the torch. The torch is adjusted to produce an outer flame just touching the central point of the ceramifiable layer side of the specimen that reaches and is stabilized at a desired temperature as measured using a thermometer at point where the flam touches the specimen. An infrared (IR) thermometer or a thermocouple is used to measure the temperature at the central point of the cold side surface (i.e., the side of the specimen opposite the torch) of the sample at the designated time. According to certain embodiments, the ceramifiable layer may have a 5 minute TE cold side temperature of not greater than about 800° C., such as, not greater than about 775° C. or not greater than about 750° C. or not greater than about 725° C. or not greater than about 700° C. or not greater than about 675° C. or not greater than about 650° C. or not greater than about 625° C. or even not greater than about 600° C. According to still other embodiments, the ceramifiable layer may have a 5-minute TE cold side temperature of at least about 25° C. It will be appreciated that the 5-minute TE cold side temperature of the ceramifiable layer may be within a range between any of the values noted above. It will be further appreciated that the 5-minute TE cold side temperature of the ceramifiable layer may be any value between any of the values noted above.

According to still other embodiments, the ceramifiable layer may have a particular 15-minute torch exposure (TE) cold-side temperature as measured using a torch test conducted at 1500° C. for 15 minutes. For purposes of embodiments described herein, the torch test is carried out by preparing a 15 cm by 15 cm specimen of the ceramifiable layer laminated onto a layer of alkaline free glass fabric having a thickness of 0.3 mm, such that the total specimen thickness is 1.5 mm. The specimen is fixed on a holder. A torch is placed 7 cm away from a face of the specimen fixed on the holder with the ceramifiable layer side of the specimen facing the torch. The torch is adjusted to produce an outer flame just touching the central point of the ceramifiable layer side of the specimen that reaches and is stabilized at a desired temperature as measured using a thermometer at point where the flam touches the specimen. An infrared (IR) thermometer or a thermocouple is used to measure the temperature at the central point of the cold side surface (i.e., the side of the specimen opposite the torch) of the sample at the designated time. Then an infrared (IR) thermometer or a thermocouple is used to measure the cold side surface temperature of the sample at the designated time. According to certain embodiments, the ceramifiable layer may have a 15 minute TE cold side temperature of not greater than about 800° C., such as, not greater than about 775° C. or not greater than about 750° C. or not greater than about 725° C. or not greater than about 700° C. or not greater than about 675° C. or not greater than about 650° C. or not greater than about 625° C. or even not greater than about 600° C. According to still other embodiments, the ceramifiable layer may have a 15-minute TE cold side temperature of at least about 25° C. It will be appreciated that the 15-minute TE cold side temperature of the ceramifiable layer may be within a range between any of the values noted above. It will be further appreciated that the 15-minute TE cold side temperature of the ceramifiable layer may be any value between any of the values noted above.

According to still other embodiments, the ceramifiable layer may have a particular 30-minute torch exposure (TE) cold-side temperature as measured using a torch test conducted at 1500° C. for 30 minutes. For purposes of embodiments described herein, the torch test is carried out by preparing a 15 cm by 15 cm specimen of the ceramifiable layer laminated onto a layer of alkaline free glass fabric having a thickness of 0.3 mm, such that the total specimen thickness is 1.5 mm. The specimen is fixed on a holder. A torch is placed 7 cm away from a face of the specimen fixed on the holder with the ceramifiable layer side of the specimen facing the torch. The torch is adjusted to produce an outer flame just touching the central point of the ceramifiable layer side of the specimen that reaches and is stabilized at a desired temperature as measured using a thermometer at point where the flam touches the specimen. An infrared (IR) thermometer or a thermocouple is used to measure the temperature at the central point of the cold side surface (i.e., the side of the specimen opposite the torch) of the sample at the designated time. Then an infrared (IR) thermometer or a thermocouple is used to measure the cold side surface temperature of the sample at the designated time. According to certain embodiments, the ceramifiable layer may have a 30 minute TE cold side temperature of not greater than about 800° C., such as, not greater than about 775° C. or not greater than about 750° C. or not greater than about 725° C. or not greater than about 700° C. or not greater than about 675° C. or not greater than about 650° C. or not greater than about 625° C. or even not greater than about 600° C. According to still other embodiments, the ceramifiable layer may have a 30-minute TE cold side temperature of at least about 25° C. It will be appreciated that the 30-minute TE cold side temperature of the ceramifiable layer may be within a range between any of the values noted above. It will be further appreciated that the 30-minute TE cold side temperature of the ceramifiable layer may be any value between any of the values noted above.

According to yet other embodiments, the ceramifiable layer may have a particular density. For purpose of embodiments described herein, the density of the ceramifiable layer may be determined according to ASTM D1056. According to certain embodiments, the ceramifiable layer may have a density of not greater than about 1.7 kg/m³, such as, not great than about 1.6 kg/m³ or not greater than about 1.5 kg/m³ or not greater than about 1.4 kg/m³ or not greater than about 1.3 kg/m³ or not greater than about 1.2 kg/m³ or not greater than about 1.1 kg/m³ or not greater than about 1.0 kg/m³ or not greater than about 0.9 kg/m³ or not greater than about 0.8 kg/m³ or not greater than about 0.7 kg/m³ or not greater than about 0.6 kg/m³ or not greater than about 0.5 kg/m³ or even not greater than about 0.4 kg/m³. According to yet other embodiments, the ceramifiable layer may have a density of at least about 0.001 kg/m³. It will be appreciated that the density of the ceramifiable layer may be within a range between any of the minimum and maximum values noted above. It will be further appreciated that the density of the ceramifiable layer may be any value between any of the minimum and maximum values noted above.

According to yet other embodiments, the ceramifiable layer may have a particular weight. According to certain embodiments, the ceramifiable layer may have a weight of at least about 0.001 kg/m², such as, at least about 0.005 kg/m² or at least about 0.01 kg/m² or at least about 0.05 kg/m² or at least about 0.1 kg/m² or at least about 0.5 kg/m² or at least about 1.0 kg/m² or even at least about 1.5 kg/m². According to yet other embodiments, the ceramifiable layer may have a weight of not greater than about 2.61 kg/m². It will be appreciated that the weight of the ceramifiable layer may be within a range between any of the minimum and maximum values noted above. It will be further appreciated that the weight of the ceramifiable layer may be any value between any of the minimum and maximum values noted above.

According to yet other embodiments, the ceramifiable layer may have a particular hardness. For purpose of embodiments described herein, the hardness of the ceramifiable layer may be determined according to D2240. According to certain embodiments, the ceramifiable layer may have a hardness of at least about 61 Shore A, such as, at least about 62 Shore A or at least about 63 Shore A or at least about 64 Shore A or even at least about 65 Shore A. According to yet other embodiments, the ceramifiable layer may have a hardness of not greater than about 71 Shore A, such as, not greater than about 70 Shore A or not greater than about 69 Shore A or not greater than about 68 Shore A or not greater than about 67 Shore A or even not greater than about 66 Shore A. It will be appreciated that the hardness of the ceramifiable layer may be within a range between any of the minimum and maximum values noted above. It will be further appreciated that the hardness of the ceramifiable layer may be any value between any of the minimum and maximum values noted above.

According to yet other embodiments, the ceramifiable layer may have a particular tensile strength. For purpose of embodiments described herein, the tensile strength of the ceramifiable layer may be determined according to D412. According to certain embodiments, the ceramifiable layer may have a tensile strength of at least about 2.3 MPa, such as, at least about 2.5 MPa or at least about 5 MPa or at least about 10 MPa or at least about 20 MPa or at least about 30 MPa or at least about 40 MPa or at least about 50 MPa or at least about 100 MPa or even at least about 150 MPa. According to yet other embodiments, the ceramifiable layer may have a tensile strength of not greater than about 500 MPa. It will be appreciated that the tensile strength of the ceramifiable layer may be within a range between any of the minimum and maximum values noted above. It will be further appreciated that the tensile strength of the ceramifiable layer may be any value between any of the minimum and maximum values noted above.

According to yet other embodiments, the ceramifiable layer may have a particular thickness. For example, the cermifiable layer may have a thickness of at least about 0.2 mm, such as, at least about 0.5 mm or at least about 1.0 mm or at least about 1.5 mm or at least about 2.0 mm or at least about 2.5 mm or at least about 3.0 mm or at least about 3.5 mm or at least about 4.0 mm or at least about 4.5 mm or even at least about 5.0 mm. According to still other embodiments, the cermifiable layer may have a thickness of not greater than about 10 mm, such as, not greater than about 9.5 mm or not greater than about 9.0 mm or not greater than about 8.5 mm or not greater than about 8.0 mm or not greater than about 7.5 mm or not greater than about 7.0 mm or not greater than about 6.5 mm or even not greater than about 6.0 mm. It will be appreciated that the thickness of the cermifiable layer may be within a range between any of the minimum and maximum values noted above. It will be further appreciated that the thickness of the cermifiable layer may be any value between any of the minimum and maximum values noted above.

According to certain embodiments, the cermifiable layer may have a particular flammability rating as measured according to ASTM D3801. In particular, the cermifiable layer may have a V-0 flammability rating as measured according to ASTM D3801.

According to still other embodiments, the cermifiable layer may have a particular 5-minute hot plate exposure (HPE) cold-side temperature as measured using a hot plate test conducted at 800° C. for 5 minutes. For purposes of embodiments described herein, the hot plate test is carried out by preparing a 15 cm by 25 cm specimen of the composite material laminated onto a layer of alkaline free glass fabric having a thickness of 0.3 mm, such that the total specimen thickness is 1.5 mm. The specimen is placed on top of a hot plate adjusted to the desired temperature with the composite material side of the specimen facing the hot pate. An infrared (IR) thermometer is used to measure the temperature at the central point of the cold side surface (i.e., the side of the specimen opposite the hot pate) of the sample at the designated time. According to certain embodiments, the cermifiable layer may have a 5 minute HPE cold side temperature of not greater than about 800° C., such as, not greater than about 775° C. or not greater than about 750° C. or not greater than about 725° C. or not greater than about 700° C. or not greater than about 675° C. or not greater than about 650° C. or not greater than about 625° C. or even not greater than about 600° C. According to still other embodiments, the cermifiable layer may have a 5-minute HPE cold side temperature of at least about 25° C. It will be appreciated that the 5-minute HPE cold side temperature of the cermifiable layer may be within a range between any of the values noted above. It will be further appreciated that the 5-minute HPE cold side temperature of the cermifiable layer may be any value between any of the values noted above.

According to still other embodiments, the cermifiable layer may have a particular 15-minute hot plate exposure (HPE) cold-side temperature as measured using a hot plate test conducted at 800° C. for 15 minutes. For purposes of embodiments described herein, the hot plate test is carried out by preparing a 15 cm by 25 cm specimen of the composite material laminated onto a layer of alkaline free glass fabric having a thickness of 0.3 mm, such that the total specimen thickness is 1.5 mm. The specimen is placed on top of a hot plate adjusted to the desired temperature with the composite material side of the specimen facing the hot pate. An infrared (IR) thermometer is used to measure the temperature at the central point of the cold side surface (i.e., the side of the specimen opposite the hot pate) of the sample at the designated time. According to certain embodiments, the cermifiable layer may have a 15 minute HPE cold side temperature of not greater than about 800° C., such as, not greater than about 775° C. or not greater than about 750° C. or not greater than about 725° C. or not greater than about 700° C. or not greater than about 675° C. or not greater than about 650° C. or not greater than about 625° C. or even not greater than about 600° C. According to still other embodiments, the cermifiable layer may have a 15-minute HPE cold side temperature of at least about 25° C. It will be appreciated that the 15-minute HPE cold side temperature of the cermifiable layer may be within a range between any of the values noted above. It will be further appreciated that the 15-minute HPE cold side temperature of the cermifiable layer may be any value between any of the values noted above.

According to still other embodiments, the cermifiable layer may have a particular 30-minute hot plate exposure (HPE) cold-side temperature as measured using a hot plate test conducted at 800° C. for 30 minutes. For purposes of embodiments described herein, the hot plate test is carried out by preparing a 15 cm by 25 cm specimen of the composite material laminated onto a layer of alkaline free glass fabric having a thickness of 0.3 mm, such that the total specimen thickness is 1.5 mm. The specimen is placed on top of a hot plate adjusted to the desired temperature with the composite material side of the specimen facing the hot pate. An infrared (IR) thermometer is used to measure the temperature at the central point of the cold side surface (i.e., the side of the specimen opposite the hot pate) of the sample at the designated time. According to certain embodiments, the cermifiable layer may have a 30 minute HPE cold side temperature of not greater than about 800° C., such as, not greater than about 775° C. or not greater than about 750° C. or not greater than about 725° C. or not greater than about 700° C. or not greater than about 675° C. or not greater than about 650° C. or not greater than about 625° C. or even not greater than about 600° C. According to still other embodiments, the cermifiable layer may have a 30-minute HPE cold side temperature of at least about 25° C. It will be appreciated that the 30-minute HPE cold side temperature of the cermifiable layer may be within a range between any of the values noted above. It will be further appreciated that the 30-minute HPE cold side temperature of the cermifiable layer may be any value between any of the values noted above.

According to still other embodiments, the cermifiable layer may have a particular 5-minute torch exposure (TE) cold-side temperature as measured using a torch test conducted at 1300° ° C. for 5 minutes. For purposes of embodiments described herein, the torch test is carried out by preparing a 15 cm by 15 cm specimen of the composite material laminated onto a layer of alkaline free glass fabric having a thickness of 0.3 mm, such that the total specimen thickness is 1.5 mm. The specimen is fixed on a holder. A torch is placed 7 cm away from a face of the specimen fixed on the holder with the composite material side of the specimen facing the torch. The torch is adjusted to produce an outer flame just touching the central point of the composite material side of the specimen that reaches and is stabilized at a desired temperature as measured using a thermometer at point where the flam touches the specimen. An infrared (IR) thermometer or a thermocouple is used to measure the temperature at the central point of the cold side surface (i.e., the side of the specimen opposite the torch) of the sample at the designated time. According to certain embodiments, the cermifiable layer may have a 5 minute TE cold side temperature of not greater than about 800° C., such as, not greater than about 775° C. or not greater than about 750° C. or not greater than about 725° ° C. or not greater than about 700° C. or not greater than about 675° C. or not greater than about 650° ° C. or not greater than about 625° C. or even not greater than about 600° C. According to still other embodiments, the cermifiable layer may have a 5-minute TE cold side temperature of at least about 25° C. It will be appreciated that the 5-minute TE cold side temperature of the cermifiable layer may be within a range between any of the values noted above. It will be further appreciated that the 5-minute TE cold side temperature of the cermifiable layer may be any value between any of the values noted above.

According to still other embodiments, the cermifiable layer may have a particular 15-minute torch exposure (TE) cold-side temperature as measured using a torch test conducted at 1300° C. for 15 minutes. For purposes of embodiments described herein, the torch test is carried out by preparing a 15 cm by 15 cm specimen of the composite material laminated onto a layer of alkaline free glass fabric having a thickness of 0.3 mm, such that the total specimen thickness is 1.5 mm. The specimen is fixed on a holder. A torch is placed 7 cm away from a face of the specimen fixed on the holder with the composite material side of the specimen facing the torch. The torch is adjusted to produce an outer flame just touching the central point of the composite material side of the specimen that reaches and is stabilized at a desired temperature as measured using a thermometer at point where the flam touches the specimen. An infrared (IR) thermometer or a thermocouple is used to measure the temperature at the central point of the cold side surface (i.e., the side of the specimen opposite the torch) of the sample at the designated time. According to certain embodiments, the cermifiable layer may have a 15 minute TE cold side temperature of not greater than about 800° ° C., such as, not greater than about 775° C. or not greater than about 750° C. or not greater than about 725° C. or not greater than about 700° C. or not greater than about 675° C. or not greater than about 650° C. or not greater than about 625° C. or even not greater than about 600° C. According to still other embodiments, the cermifiable layer may have a 15-minute TE cold side temperature of at least about 25° C. It will be appreciated that the 15-minute TE cold side temperature of the cermifiable layer may be within a range between any of the values noted above. It will be further appreciated that the 15-minute TE cold side temperature of the cermifiable layer may be any value between any of the values noted above.

According to still other embodiments, the cermifiable layer may have a particular 30-minute torch exposure (TE) cold-side temperature as measured using a torch test conducted at 1300° C. for 30 minutes. For purposes of embodiments described herein, the torch test is carried out by preparing a 15 cm by 15 cm specimen of the composite material laminated onto a layer of alkaline free glass fabric having a thickness of 0.3 mm, such that the total specimen thickness is 1.5 mm. The specimen is fixed on a holder. A torch is placed 7 cm away from a face of the specimen fixed on the holder with the composite material side of the specimen facing the torch. The torch is adjusted to produce an outer flame just touching the central point of the composite material side of the specimen that reaches and is stabilized at a desired temperature as measured using a thermometer at point where the flam touches the specimen. An infrared (IR) thermometer or a thermocouple is used to measure the temperature at the central point of the cold side surface (i.e., the side of the specimen opposite the torch) of the sample at the designated time. According to certain embodiments, the cermifiable layer may have a 30 minute TE cold side temperature of not greater than about 800° C., such as, not greater than about 775° C. or not greater than about 750° C. or not greater than about 725° C. or not greater than about 700° C. or not greater than about 675° C. or not greater than about 650° C. or not greater than about 625° C. or even not greater than about 600° C. According to still other embodiments, the cermifiable layer may have a 30-minute TE cold side temperature of at least about 25° ° C. It will be appreciated that the 30-minute TE cold side temperature of the cermifiable layer may be within a range between any of the values noted above. It will be further appreciated that the 30-minute TE cold side temperature of the cermifiable layer may be any value between any of the values noted above.

According to yet other embodiments, the cermifiable layer may have a particular density. For purpose of embodiments described herein, the density of the cermifiable layer may be determined according to ASTM D1056. According to certain embodiments, the cermifiable layer may have a density of not greater than about 1.7 kg/m³, such as, not great than about 1.6 kg/m³ or not greater than about 1.5 kg/m³ or not greater than about 1.4 kg/m³ or not greater than about 1.3 kg/m³ or not greater than about 1.2 kg/m³ or not greater than about 1.1 kg/m³ or not greater than about 1.0 kg/m³ or not greater than about 0.9 kg/m³ or not greater than about 0.8 kg/m³ or not greater than about 0.7 kg/m³ or not greater than about 0.6 kg/m³ or not greater than about 0.5 kg/m³ or even not greater than about 0.4 kg/m³. According to yet other embodiments, the cermifiable layer may have a density of at least about 0.001 kg/m³. It will be appreciated that the density of the cermifiable layer may be within a range between any of the minimum and maximum values noted above. It will be further appreciated that the density of the cermifiable layer may be any value between any of the minimum and maximum values noted above.

According to yet other embodiments, the cermifiable layer may have a particular weight. According to certain embodiments, the cermifiable layer may have a weight of at least about 0.001 kg/m², such as, at least about 0.005 kg/m² or at least about 0.01 kg/m² or at least about 0.05 kg/m² or at least about 0.1 kg/m² or at least about 0.5 kg/m² or at least about 1.0 kg/m² or even at least about 1.5 kg/m². According to yet other embodiments, the cermifiable layer may have a weight of not greater than about 2.61 kg/m². It will be appreciated that the weight of the cermifiable layer may be within a range between any of the minimum and maximum values noted above. It will be further appreciated that the weight of the cermifiable layer may be any value between any of the minimum and maximum values noted above.

According to yet other embodiments, the cermifiable layer may have a particular hardness. For purpose of embodiments described herein, the hardness of the cermifiable layer may be determined according to ASTM D2240. According to certain embodiments, the cermifiable layer may have a hardness of at least about 61 Shore A, such as, at least about 62 Shore A or at least about 63 Shore A or at least about 64 Shore A or even at least about 65 Shore A. According to yet other embodiments, the cermifiable layer may have a hardness of not greater than about 71 Shore A, such as, not greater than about 70 Shore A or not greater than about 69 Shore A or not greater than about 68 Shore A or not greater than about 67 Shore A or even not greater than about 66 Shore A. It will be appreciated that the hardness of the cermifiable layer may be within a range between any of the minimum and maximum values noted above. It will be further appreciated that the hardness of the cermifiable layer may be any value between any of the minimum and maximum values noted above.

According to yet other embodiments, the cermifiable layer may have a particular tensile strength. For purpose of embodiments described herein, the tensile strength of the cermifiable layer may be determined according to ASTM D412. According to certain embodiments, the cermifiable layer may have a tensile strength of at least about 2.3 MPa, such as, at least about 2.5 MPa or at least about 5 MPa or at least about 10 MPa or at least about 20 MPa or at least about 30 MPa or at least about 40 MPa or at least about 50 MPa or at least about 100 MPa or even at least about 150 MPa. According to yet other embodiments, the cermifiable layer may have a tensile strength of not greater than about 500 MPa. It will be appreciated that the tensile strength of the cermifiable layer may be within a range between any of the minimum and maximum values noted above. It will be further appreciated that the tensile strength of the cermifiable layer may be any value between any of the minimum and maximum values noted above.

According to certain embodiments, cermifiable layers described herein may be formed according to any acceptable forming process for a composite material layer.

According to certain embodiments, the core foam layer 104 may include a silicone-based foam that may include a silicone-based matrix component, a flame retardant filler component, and an insulation filler component.

According to particular embodiments, the silicone-based matrix component of the core foam layer 104 may include platinum catalyzed addition cured silicone foam. According to still other embodiments, the silicone-based matrix component may include peroxide cured silicone foam. According to yet other embodiments, the silicone-based matrix component may include tin catalyzed silicone foam. According to still other embodiments, the silicone-based matrix component may include any combination of a platinum catalyzed addition cured silicone foam, a peroxide cured silicone foam, and a tin catalyzed silicone foam.

According to particular embodiments, the silicone-based matrix component may consist of platinum catalyzed addition cured silicone foam. According to still other embodiments, the silicone-based matrix component may consist of peroxide cured silicone foam. According to yet other embodiments, the silicone-based matrix component may consist of tin catalyzed silicone foam. According to still other embodiments, the silicone-based matrix component may consist of any combination of a platinum catalyzed addition cured silicone foam, a peroxide cured silicone foam, and a tin catalyzed silicone foam.

According to particular embodiments, the silicone-based matrix component may be a platinum catalyzed addition cured silicone foam layer. According to still other embodiments, the silicone-based matrix component may be a peroxide cured silicone foam layer. According to yet other embodiments, the silicone-based matrix component may be a tin catalyzed silicone foam layer. According to still other embodiments, the silicone-based matrix component may be a layer of any combination of a platinum catalyzed addition cured silicone foam, a peroxide cured silicone foam, and a tin catalyzed silicone foam.

According to yet other embodiments, the flame retardant filler component may be selected from a particular group of materials. For example, the flame retardant filler component may be selected from the group consisting of metal hydrates, borate compounds, platinum compounds, transition metal oxides, metal carbonates, calcium silicates, aluminum silicates, magnesium silicates, glass frits, alkaline salts, vermiculites, and any combination thereof.

According to still other embodiments, the flame retardant filler component may include a particular material. For example, the flame retardant filler component may include metal hydrates. According to still other embodiments, the flame retardant filler component may include borate compounds. According to still other embodiments, the flame retardant filler component may include platinum compounds. According to still other embodiments, the flame retardant filler component may include transition metal oxides. According to other embodiments, the flame retardant filler component may include metal carbonates. According to still other embodiments, the flame retardant filler component may include calcium silicates. According to yet other embodiments, the flame retardant filler component may include aluminum silicates. According to yet other embodiments, the flame retardant filler component may include magnesium silicates. According to still other embodiments, the flame retardant filler component may include glass frits. According to still other embodiments, the flame retardant filler component may include alkaline salts. According to yet other embodiments, the flame retardant filler component may include vermiculites. According to still other embodiments, the flame retardant filler component may include any combination of metal hydrates, borate compounds, platinum compounds, transition metal oxides, metal carbonates, calcium silicates, aluminum silicates, magnesium silicates, glass frits, alkaline salts, or vermiculites.

According to still other embodiments, the flame retardant filler component may consist of a particular material. For example, the flame retardant filler component may consist of metal hydrates. According to still other embodiments, the flame retardant filler component may consist of borate compounds. According to still other embodiments, the flame retardant filler component may consist of platinum compounds. According to still other embodiments, the flame retardant filler component may consist of transition metal oxides. According to other embodiments, the flame retardant filler component may consist of metal carbonates. According to still other embodiments, the flame retardant filler component may consist of calcium silicates.

According to yet other embodiments, the flame retardant filler component may consist of aluminum silicates. According to yet other embodiments, the flame retardant filler component may consist of magnesium silicates. According to still other embodiments, the flame retardant filler component may consist of glass frits. According to still other embodiments, the flame retardant filler component may consist of alkaline salts. According to yet other embodiments, the flame retardant filler component may consist of vermiculites. According to still other embodiments, the flame retardant filler component may consist of any combination of metal hydrates, borate compounds, platinum compounds, transition metal oxides, metal carbonates, calcium silicates, aluminum silicates, magnesium silicates, glass frits, alkaline salts, or vermiculites.

According to still other embodiments, the flame retardant filler component may be a particular material. For example, the flame retardant filler component may be a metal hydrate filler. According to still other embodiments, the flame retardant filler component may be a borate salt filler. According to still other embodiments, the flame retardant filler component may be a platinum compound filler. According to still other embodiments, the flame retardant filler component may be a transition metal oxide filler. According to other embodiments, the flame retardant filler component may be a metal carbonate filler. According to still other embodiments, the flame retardant filler component may be a calcium silicate filler. According to yet other embodiments, the flame retardant filler component may be an aluminum silicate filler. According to yet other embodiments, the flame retardant filler component may be a magnesium silicate filler. According to still other embodiments, the flame retardant filler component may be a glass frit filler. According to still other embodiments, the flame retardant filler component may be an alkaline salt filler. According to yet other embodiments, the flame retardant filler component may be a vermiculite filler. According to still other embodiments, the flame retardant filler component may be a filler of any combination of metal hydrates, borate compounds, platinum compounds, transition metal oxides, metal carbonates, calcium silicates, aluminum silicates, magnesium silicates, glass frits, alkaline salts, or vermiculites.

According to still other embodiments, the flame retardant filler component may be selected from an particular group of metal hydrate materials. For example, the flame retardant filler component may be selected from a group consisting of aluminum trihydrate, magnesium dihydroxides, bochmite, calcium hydroxide, Huntite, gypsum, hydromagnesite, and any combination thereof.

According to still other embodiments, the flame retardant filler component may include a particular metal hydrate material. For example, the flame retardant filler component may include aluminum trihydrate. According to still other embodiments, the flame retardant filler component may include magnesium dihydroxides. According to yet other embodiments, the flame retardant filler component may include bochmite. According to other embodiments, the flame retardant filler component may include calcium hydroxide. According to still other embodiments, the flame retardant filler component may include Huntite. According to yet other embodiments, the flame retardant filler component may include gypsum. According to other embodiments, the flame retardant filler component may include hydromagnesite. According to still other embodiments, the flame retardant filler component may include any combination of aluminum trihydrate, magnesium dihydroxides, bochmite, calcium hydroxide, Huntite, gypsum, or hydromagnesite.

According to still other embodiments, the flame retardant filler component may consist of a particular metal hydrate material. For example, the flame retardant filler component may consist of aluminum trihydrate. According to still other embodiments, the flame retardant filler component may consist of magnesium dihydroxides. According to yet other embodiments, the flame retardant filler component may consist of bochmite. According to other embodiments, the flame retardant filler component may consist of calcium hydroxide. According to still other embodiments, the flame retardant filler component may consist of Huntite. According to yet other embodiments, the flame retardant filler component may consist of gypsum. According to other embodiments, the flame retardant filler component may consist of hydromagnesite. According to still other embodiments, the flame retardant filler component may consist of any combination of aluminum trihydrate, magnesium dihydroxides, bochmite, calcium hydroxide, Huntite, gypsum, or hydromagnesite.

According to still other embodiments, the flame retardant filler component may be a particular metal hydrate material filler. For example, the flame retardant filler component may be an aluminum trihydrate filler. According to still other embodiments, the flame retardant filler component may be a magnesium dihydroxide filler. According to yet other embodiments, the flame retardant filler component may be a bochmite filler. According to other embodiments, the flame retardant filler component may be a calcium hydroxide filler. According to still other embodiments, the flame retardant filler component may be a Huntite filler. According to yet other embodiments, the flame retardant filler component may be a gypsum filler. According to other embodiments, the flame retardant filler component may be a hydromagnesite filler. According to still other embodiments, the flame retardant filler component may be a filler of any combination of aluminum trihydrate, magnesium dihydroxides, bochmite, calcium hydroxide, Huntite, gypsum, or hydromagnesite.

According to still other embodiments, the flame retardant filler component may be selected from a particular group of borate salt materials. For example, the flame retardant filler component may be selected from a group consisting of zinc borate, calcium borate, sodium borate, potassium borate, lithium borate, and any combination thereof.

According to still other embodiments, the flame retardant filler component may include a particular borate salt material. For example, the flame retardant filler component may include zinc borate. According to yet other embodiments, the flame retardant filler component may include calcium borate. According to other embodiments, the flame retardant filler component may include sodium borate. According to still other embodiments, the flame retardant filler component may include potassium borate. According to yet other embodiments, the flame retardant filler component may include lithium borate. According to still other embodiments, the flame retardant filler component may include any combination of zinc borate, calcium borate, sodium borate, potassium borate, or lithium borate.

According to still other embodiments, the flame retardant filler component may consist of a particular borate salt material. For example, the flame retardant filler component may consist of zinc borate. According to yet other embodiments, the flame retardant filler component may consist of calcium borate. According to other embodiments, the flame retardant filler component may consist of sodium borate. According to still other embodiments, the flame retardant filler component may consist of potassium borate. According to yet other embodiments, the flame retardant filler component may consist of lithium borate. According to still other embodiments, the flame retardant filler component may consist of any combination of zinc borate, calcium borate, sodium borate, potassium borate, or lithium borate.

According to still other embodiments, the flame retardant filler component may be a particular borate salt material filler. For example, the flame retardant filler component may be a zinc borate filler. According to yet other embodiments, the flame retardant filler component may be a calcium borate filler. According to other embodiments, the flame retardant filler component may be a sodium borate filler. According to still other embodiments, the flame retardant filler component may be a potassium borate filler. According to yet other embodiments, the flame retardant filler component may be a lithium borate filler. According to still other embodiments, the flame retardant filler component may be a filler of any combination of zinc borate, calcium borate, sodium borate, potassium borate, or lithium borate.

According to still other embodiments, the flame retardant filler component may be selected from a particular group of platinum compound materials. For example, the flame retardant filler component may be selected from a group consisting of platinum-1,3-divinyl-1,1,3,3-tetramethyldisiloxane, hexachloroplatinic acid, and any combination thereof.

According to still other embodiments, the flame retardant filler component may include a particular of platinum compound material. For example, the flame retardant filler component may include platinum-1,3-divinyl-1,1,3,3-tetramethyldisiloxane. According to yet other embodiments, the flame retardant filler component may include hexachloroplatinic acid. According to still other embodiments, the flame retardant filler component may include any combination of platinum-1,3-divinyl-1,1,3,3-tetramethyldisiloxane, and hexachloroplatinic acid.

According to still other embodiments, the flame retardant filler component may consist of a particular of platinum compound material. For example, the flame retardant filler component may consist of platinum-1,3-divinyl-1,1,3,3-tetramethyldisiloxane. According to yet other embodiments, the flame retardant filler component may consist of hexachloroplatinic acid. According to still other embodiments, the flame retardant filler component may consist of any combination of platinum-1,3-divinyl-1,1,3,3-tetramethyldisiloxane, and hexachloroplatinic acid.

According to still other embodiments, the flame retardant filler component may be a particular platinum compound material filler. For example, the flame retardant filler component may be a platinum-1,3-divinyl-1,1,3,3-tetramethyldisiloxane filler. According to yet other embodiments, the flame retardant filler component may be a hexachloroplatinic acid filler. According to still other embodiments, the flame retardant filler component may be a filler or any combination of platinum-1,3-divinyl-1,1,3,3-tetramethyldisiloxane, and hexachloroplatinic acid.

According to still other embodiments, the flame retardant filler component may be selected from a particular group of transition metal oxide materials. For example, the flame retardant filler component may be selected from a group consisting of iron oxide, cerium oxide, titanium oxide, zinc oxide, and any combination thereof.

According to still other embodiments, the flame retardant filler component may include a particular transition metal oxide material. For example, the flame retardant filler component may include iron oxide. According to yet other embodiments, the flame retardant filler component may include cerium oxide. According to other embodiments, the flame retardant filler component may include zinc oxide. According to still other embodiments, the flame retardant filler component may include any combination of iron oxide, cerium oxide, titanium oxide, or zinc oxide.

According to still other embodiments, the flame retardant filler component may consist of a particular transition metal oxide material. For example, the flame retardant filler component may consist of iron oxide. According to yet other embodiments, the flame retardant filler component may consist of cerium oxide. According to other embodiments, the flame retardant filler component may consist of zinc oxide. According to still other embodiments, the flame retardant filler component may consist of any combination of iron oxide, cerium oxide, titanium oxide, or zinc oxide.

According to still other embodiments, the flame retardant filler component may be a particular transition metal oxide material filler. For example, the flame retardant filler component may be an iron oxide filler. According to yet other embodiments, the flame retardant filler component may be a cerium oxide filler. According to other embodiments, the flame retardant filler component may be a zinc oxide filler. According to still other embodiments, the flame retardant filler component may be a filler of any combination of iron oxide, cerium oxide, titanium oxide, or zinc oxide.

According to still other embodiments, the flame retardant filler component may be selected from a particular group of metal carbonate materials. For example, the flame retardant filler component may be selected from a group consisting of Huntite, calcium carbonate, and any combination thereof.

According to still other embodiments, the flame retardant filler component may include a particular transition metal carbonate material. For example, the flame retardant filler component may include Huntite. According to yet other embodiments, the flame retardant filler component may include calcium carbonate. According to still other embodiments, the flame retardant filler component may include any combination of Huntite, or calcium carbonate.

According to still other embodiments, the flame retardant filler component may consist of a particular transition metal carbonate material. For example, the flame retardant filler component may consist of Huntite. According to yet other embodiments, the flame retardant filler component may consist of calcium carbonate. According to still other embodiments, the flame retardant filler component may consist of any combination of Huntite, or calcium carbonate.

According to still other embodiments, the flame retardant filler component may be a particular transition metal carbonate material filler. For example, the flame retardant filler component may be a Huntite filler. According to yet other embodiments, the flame retardant filler component may be a calcium carbonate filler. According to still other embodiments, the flame retardant filler component may be a filler of any combination of Huntite, or calcium carbonate.

According to still other embodiments, the flame retardant filler component may be selected from a particular group of metal carbonate mixtures. For example, the flame retardant filler component may be selected from a group consisting of a natural mixture of hydromagnesite and Huntite, synthetic magnesium carbonate hydroxide pentahydrate, and any combination thereof.

According to still other embodiments, the flame retardant filler component may include a particular metal carbonate mixture. For example, the flame retardant filler component may include a natural mixture of hydromagnesite. According to other embodiments, the flame retardant filler component may include a natural mixture of hydromagnesite. According to still other embodiments, the flame retardant filler component may include any combination of a natural mixture of hydromagnesite and Huntite, or synthetic magnesium carbonate hydroxide pentahydrate.

According to still other embodiments, the flame retardant filler component may consist of a particular metal carbonate mixture. For example, the flame retardant filler component may consist of a natural mixture of hydromagnesite. According to other embodiments, the flame retardant filler component may consist of a natural mixture of hydromagnesite. According to still other embodiments, the flame retardant filler component may consist of any combination of a natural mixture of hydromagnesite and Huntite, or synthetic magnesium carbonate hydroxide pentahydrate.

According to still other embodiments, the flame retardant filler component may be a particular metal carbonate mixture filler. For example, the flame retardant filler component may be a filler of a natural mixture of hydromagnesite. According to other embodiments, the flame retardant filler component may be a filler of a natural mixture of hydromagnesite. According to still other embodiments, the flame retardant filler component may be a filler of any combination of a natural mixture of hydromagnesite and Huntite, or synthetic magnesium carbonate hydroxide pentahydrate.

According to still other embodiments, the flame retardant filler component may be selected from a particular group of alumina silicate materials or magnesium silicate materials. For example, the flame retardant filler component may be selected from a group consisting of wallastonite, mica, kaolin, clay, talc, vermiculite, and any combination thereof.

According to still other embodiments, the flame retardant filler component may include a particular alumina silicate material or magnesium silicate material. For example, the flame retardant filler component may include wallastonite. According to yet other embodiments, the flame retardant filler component may include mica. According to still other embodiments, the flame retardant filler component may include clay. According to other embodiments, the flame retardant filler component may include kaolin. According to yet other embodiments, the flame retardant filler component may include a talc. According to other embodiments, the flame retardant filler component may include vermiculite. According to still other embodiments, the flame retardant filler component may include any combination of wallastonite, mica, clay, kaolin, talc, or vermiculite.

According to still other embodiments, the flame retardant filler component may consist of a particular alumina silicate material or magnesium silicate material. For example, the flame retardant filler component may consist of wallastonite. According to yet other embodiments, the flame retardant filler component may consist of mica. According to still other embodiments, the flame retardant filler component 220 may consist of clay. According to other embodiments, the flame retardant filler component may consist of kaolin. According to yet other embodiments, the flame retardant filler component may consist of talc. According to other embodiments, the flame retardant filler component may consist of vermiculite. According to still other embodiments, the flame retardant filler component may consist of any combination of wallastonite, mica, clay, kaolin, talc, or vermiculite.

According to still other embodiments, the flame retardant filler component may be a filler of a particular alumina silicate material or magnesium silicate material. For example, the flame retardant filler component may be a wallastonite filler. According to yet other embodiments, the flame retardant filler component may be a mica filler. According to still other embodiments, the flame retardant filler component may be a clay filler. According to other embodiments, the flame retardant filler component may be a kaolin filler. According to yet other embodiments, the flame retardant filler component may be a talc filler. According to other embodiments, the flame retardant filler component may be a vermiculite filler. According to still other embodiments, the flame retardant filler component may be a filler of any combination of wallastonite, mica, clay, kaolin, talc, or vermiculite.

According to still other embodiments, the flame retardant filler component may be selected from a particular group of alkaline salt materials. For example, the flame retardant filler component may be selected from a group consisting of sodium carbonate, potassium carbonate, and any combination thereof.

According to still other embodiments, the flame retardant filler component may include a particular alkaline salt material. For example, the flame retardant filler component may include sodium carbonate. According to yet other embodiments, the flame retardant filler component may include potassium carbonate. According to still other embodiments, the flame retardant filler component may include any combination of sodium carbonate, or potassium carbonate.

According to still other embodiments, the flame retardant filler component may consist of a particular alkaline salt material. For example, the flame retardant filler component may consist of sodium carbonate. According to yet other embodiments, the flame retardant filler component may consist of potassium carbonate. According to still other embodiments, the flame retardant filler component may consist of any combination of sodium carbonate, or potassium carbonate.

According to still other embodiments, the flame retardant filler component may be a particular alkaline salt material filler. For example, the flame retardant filler component may be a sodium carbonate filler. According to yet other embodiments, the flame retardant filler component may be a potassium carbonate filler. According to still other embodiments, the flame retardant filler component may be a filler of any combination of sodium carbonate, or potassium carbonate.

According to still other embodiments, the insulation filler component may be selected from a particular group of materials. For example, the insulation filler component may be selected from a group consisting of expanded perlite, unexpanded perlite, glass beads, vermiculite, expanded vermiculite, expanded glass, zeolite, aerogel, silica, porous silica, porous alumina, and any combination thereof.

According to still other embodiments, the insulation filler component may include a particular material. For example, the insulation filler component may include expanded perlite. According to yet other embodiments, the insulation filler component may include unexpanded perlite. According to yet other embodiments, the insulation filler component may include glass beads. According to yet other embodiments, the insulation filler component may include vermiculite. According to yet other embodiments, the insulation filler component may include expanded vermiculite. According to yet other embodiments, the insulation filler component may include expanded glass. According to yet other embodiments, the insulation filler component may include zeolite. According to still other embodiments, the insulation filler component may include aerogel. According to yet other embodiments, the insulation filler component may include silica. According to yet other embodiments, the insulation filler component may include porous silica. According to other embodiments, the insulation filler component may include porous alumina. According to still other embodiments, the insulation filler component may include any combination of expanded perlite, unexpanded perlite, glass beads, vermiculite, expanded vermiculite, expanded glass, zeolite, aerogel, silica, porous silica, or porous alumina.

According to still other embodiments, the insulation filler component may consist of a particular material. For example, the insulation filler component may consist of expanded perlite. According to yet other embodiments, the insulation filler component may consist of unexpanded perlite. According to yet other embodiments, the insulation filler component may consist of glass beads. According to yet other embodiments, the insulation filler component may consist of vermiculite. According to yet other embodiments, the insulation filler component may consist of expanded vermiculite. According to yet other embodiments, the insulation filler component may consist of expanded glass. According to yet other embodiments, the insulation filler component may consist of zeolite. According to still other embodiments, the insulation filler component may consist of aerogel. According to yet other embodiments, the insulation filler component may consist of silica. According to yet other embodiments, the insulation filler component may consist of porous silica. According to other embodiments, the insulation filler component may consist of porous alumina. According to still other embodiments, the insulation filler component may consist of any combination of expanded perlite, unexpanded perlite, glass beads, vermiculite, expanded vermiculite, expanded glass, zeolite, aerogel, silica, porous silica, or porous alumina.

According to still other embodiments, the insulation filler component may be a filler of a particular material. For example, the insulation filler component may be an expanded perlite filler. According to yet other embodiments, the insulation filler component may be an unexpanded perlite filler. According to yet other embodiments, the insulation filler component may be a glass beads filler. According to yet other embodiments, the insulation filler component may be a vermiculite filler. According to yet other embodiments, the insulation filler component may be an expanded vermiculite filler. According to yet other embodiments, the insulation filler component may be an expanded glass filler.

According to yet other embodiments, the insulation filler component may be a zeolite filler. According to still other embodiments, the insulation filler component may be an aerogel filler. According to yet other embodiments, the insulation filler component may be a silica filler. According to yet other embodiments, the insulation filler component may be a porous silica filler. According to other embodiments, the insulation filler component may be a porous alumina filler. According to still other embodiments, the insulation filler component may be a filler of any combination of expanded perlite, unexpanded perlite, glass beads, vermiculite, expanded vermiculite, expanded glass, zeolite, aerogel, silica, porous silica, or porous alumina.

According to certain embodiments, the core foam layer 104 may include a particular content of the silicone-based matrix component. For example, the core foam layer 104 may include a silicone-based matrix component content of at least about 20 wt. % for a total weight of the core foam layer 104, such as, at least about 25 wt. % or at least about 30 wt. % or at least about 35 wt. % or at least about 40 wt. % or at least about 45 wt. % or even at least about 50 wt. %. According to yet other embodiments, the core foam layer 104 may include a silicone-based matrix component content of not greater than about 85 wt. % for a total weight of the core foam layer 104, such as, not greater than about 80 wt. % or not greater than about 75 wt. % or not greater than about 70 wt. % or even not greater than about 65 wt. %. It will be appreciated that the silicone-based matrix component content of the core foam layer 104 may be within a range between any of the values noted above. It will be further appreciated that the silicone-based matrix component content of the core foam layer 104 may be any value between any of the minimum and maximum values noted above.

According to still other embodiments, the core foam layer 104 may include a particular content of flame retardant filler component. For example, the core foam layer 104 may include a flame retardant filler component content of at least about 1 wt. % for a total weight of the core foam layer 104, such as, at least about 2 wt. %, or at least about 3 wt. %, or at least about 4 wt. %, or at least about 5 wt. %, or at least about 7 wt. %, or at least about 10 wt. %, or at least about 12 wt. %, or even at least about 15.%. According to yet other embodiments, the core foam layer 104 may include a flame retardant filler component content of not greater than about 35 wt. % for a total weight of the core foam layer 104, such as, not greater than about 34 wt. %, or not greater than about 33 wt. %, or not greater than about 32 wt. %, or not greater than about 31 wt. %, or not greater than about 30 wt. %, or not greater than about 28 wt. %, or not greater than about 25 wt. %, or not greater than about 23 wt. %, or not greater than about 20 wt. %. It will be appreciated that the flame retardant filler component content of the core foam layer 104 may be within a range between any of the values noted above. It will be further appreciated that the flame retardant filler component content of the core foam layer 104 may be any value between any of the minimum and maximum values noted above.

According to still other embodiments, the core foam layer 104 may include a particular content of insulation filler component. For example, the core foam layer 104 may include an insulation filler component content of at least about 1 wt. % for a total weight of the core foam layer 104, such as, at least about 2 wt. %, or at least about 3 wt. %, or at least about 4 wt. %, or at least about 5 wt. %, or at least about 7 wt. %, or at least about 10 wt. %, or at least about 12 wt. %, or even at least about 15.%. According to yet other embodiments, the core foam layer 104 may include an insulation filler component content of not greater than about 25 wt. % for a total weight of the core foam layer 104, such as, not greater than about 24 wt. % or not greater than about 23 wt. %, or not greater than about 22 wt. %, or not greater than about 21 wt. %, or not greater than about 20 wt. %, or not greater than about 19 wt. %, or not greater than about 18 wt. %, or not greater than about 17 wt. %, or not greater than about 16 wt. %. It will be appreciated that the insulation filler component content of the core foam layer 104 may be within a range between any of the values noted above. It will be further appreciated that the insulation filler component content of the core foam layer 104 may be any value between any of the minimum and maximum values noted above.

According to certain embodiments, the core foam layer 104 may have a particular flammability rating as measured according to ASTM D4986. In particular, the foam layer may have a HBF flammability rating as measured according to ASTM D4986.

According to certain embodiments, the core foam layer 104 may have a particular flammability rating as measured according to ASTM D3801. In particular, the foam layer may have a V-0 flammability rating as measured according to ASTM D3801.

According to certain embodiments, the multilayer composite 100 may have a particular flammability rating as measured according to ASTM D4986. In particular, the foam layer may have a HBF flammability rating as measured according to ASTM D4986.

According to certain embodiments, the multilayer composite 100 may have a particular flammability rating as measured according to ASTM D3801. In particular, the foam layer may have a V-0 flammability rating as measured according to ASTM D3801.

According to yet other embodiments, the core foam layer 104 may have a particular self-ignition time when exposed to a hot plate test at a temperature of 650° C. For purposes of embodiments described herein, the hot plate test is carried out by preparing a 1-inch by 1-inch specimen of the material, which is put on top of a hot plate. Then a thermal couple is fixed in a steel weight (1 inch in diameter, 2 inches in height) is put on top of the specimen to measure the cold side surface temperature. The temperature curve is recorded and the point, if any, of self-ignition is recorded. According to particular embodiments, the core foam layer 104 may have a self-ignition time of at least about 1 minute, such as, at least about 1.5 minutes or at least about 2 minutes or at least about 2.5 minutes or at least about 3 minutes or at least about 3.5 minutes or at least about 4.0 minutes or at least about 4.5 minutes or even at least about 5.0 minutes. It will be appreciated that the self-ignition time of the core foam layer 104 may be within a range between any of the values noted above. It will be further appreciated that the self-ignition time of the core foam layer 104 may be any value between any of the values noted above.

According to yet other embodiments, the multilayer composite 100 may have a particular self-ignition time when exposed to a hot plate test at a temperature of 650° C. For purposes of embodiments described herein, the hot plate test is carried out by preparing a 1 inch by 1 inch specimen of the material, which is put on top of a hot plate. Then a thermal couple is fixed in a steel weight (1 inch in diameter, 2 inches in height) is put on top of the specimen to measure the cold side surface temperature. The temperature curve is recorded and the point, if any, of self-ignition is recorded. According to particular embodiments, the multilayer composite 100 may have a self-ignition time of at least about 1 minute, such as, at least about 1.5 minutes, or at least about 2 minutes, or at least about 2.5 minutes, or at least about 3 minutes, or at least about 3.5 minutes, or at least about 4.0 minutes, or at least about 4.5 minutes, or even at least about 5.0 minutes. It will be appreciated that the self-ignition time of the multilayer composite 100 may be within a range between any of the values noted above. It will be further appreciated that the self-ignition time of the multilayer composite 100 may be any value between any of the values noted above.

According to still other embodiments, the core foam layer 104 may have a particular cold-side temperature as measured at 5 minutes when a 3 mm thickness of the foam is exposed to a hot plate test at 650° C. For purposes of embodiments described herein, the hot plate test is carried out by preparing a 1 inch by 1 inch specimen of the material, which is put on top of a hot plate. Then a thermal couple is fixed in a steel weight (1 inch in diameter, 2 inches in height) is put on top of the specimen to measure the cold side surface temperature. According to certain embodiments, the core foam layer 104 may have a cold side temperature of not greater than about 300° C., such as, not greater than about 275° C. or not greater than about 250° C. or not greater than about 225° C. or not greater than about 200° C. or not greater than about 175° C. or even not greater than about 150° C. According to still other embodiments, the core foam layer 104 may have a cold side temperature of at least about 25° C. It will be appreciated that the cold side temperature of the core foam layer 104 may be within a range between any of the values noted above. It will be further appreciated that the cold side temperature of the core foam layer 104 may be any value between any of the values noted above.

According to still other embodiments, the multilayer composite 100 may have a particular cold-side temperature as measured at 5 minutes when a 3 mm thickness of the foam is exposed to a hot plate test at 650° C. For purposes of embodiments described herein, the hot plate test is carried out by preparing a 1 inch by 1 inch specimen of the material, which is put on top of a hot plate. Then a thermal couple is fixed in a steel weight (1 inch in diameter, 2 inches in height) is put on top of the specimen to measure the cold side surface temperature. According to certain embodiments, the multilayer composite 100 may have a cold side temperature of not greater than about 300° C., such as, not greater than about 275° C. or not greater than about 250° C. or not greater than about 225° C. or not greater than about 200° C. or not greater than about 175° C. or even not greater than about 150° C. According to still other embodiments, the multilayer composite 100 may have a cold side temperature of at least about 25° C. It will be appreciated that the cold side temperature of the multilayer composite 100 may be within a range between any of the values noted above. It will be further appreciated that the cold side temperature of the multilayer composite 100 may be any value between any of the values noted above.

According to still other embodiments, the core foam layer 104 may have a particular burn-through time as measured when exposed to a torch test carried out at a temperature of 1000° C. For purposes of embodiments described herein, the torch test is carried out by preparing a 1 inch by 1 inch specimen of the material, which is placed 1.5 inches from a torch. The thermal couple is fixed on the flame side to measure the “hot side” temperature, which is adjusted to 1000° C. A second thermal couple is positioned to the opposite side of the sample to measure the “cold side” temperature. The time is measured until, if it occurs, the torch burns through the sample. According to particular embodiments, the multilayer composite 100 may have a burn-through time of at least about 6 minutes, such as, at least about 6.5 minutes, or at least about 7 minutes, or at least about 7.5 minutes, or at least about 8 minutes, or at least about 8.5 minutes, or at least about 9.0 minutes, or at least about 9.5 minutes, or even at least about 10.0 minutes. It will be appreciated that the burn-through time of the core foam layer 104 may be within a range between any of the values noted above. It will be further appreciated that the burn-through time of the core foam layer 104 may be any value between any of the values noted above.

According to still other embodiments, the multilayer composite 100 may have a particular burn-through time as measured when exposed to a torch test carried out at a temperature of 1000° C. For purposes of embodiments described herein, the torch test is carried out by preparing a 1 inch by 1 inch specimen of the material, which is placed 1.5 inches from a torch. The thermal couple is fixed on the flame side to measure the “hot side” temperature, which is adjusted to 1000° C. A second thermal couple is positioned to the opposite side of the sample to measure the “cold side” temperature. The time is measured until, if it occurs, the torch burns through the sample. According to particular embodiments, the multilayer composite 100 may have a burn-through time of at least about 6 minutes, such as, at least about 6.5 minutes, or at least about 7 minutes, or at least about 7.5 minutes, or at least about 8 minutes, or at least about 8.5 minutes, or at least about 9.0 minutes, or at least about 9.5 minutes, or even at least about 10.0 minutes. It will be appreciated that the burn-through time of the multilayer composite 100 may be within a range between any of the values noted above. It will be further appreciated that the burn-through time of the multilayer composite 100 may be any value between any of the values noted above.

According to yet other embodiments, the core foam layer 104 may have a particular thickness. For example, the core foam layer 104 may have a thickness of at least about 0.5 mm, such as, at least about 1.0 mm or at least about 1.5 mm or at least about 2.0 mm or at least about 2.5 mm or at least about 3.0 mm or at least about 3.5 mm or at least about 4.0 mm or at least about 4.5 mm or even at least about 5.0 mm. According to still other embodiments, the core foam layer 104 may have a thickness of not greater than about 10 mm, such as, not greater than about 9.5 mm or not greater than about 9.0 mm or not greater than about 8.5 mm or not greater than about 8.0 mm or not greater than about 7.5 mm or not greater than about 7.0 mm or not greater than about 6.5 mm or even not greater than about 6.0 mm. It will be appreciated that the thickness of the core foam layer 104 may be within a range between any of the minimum and maximum values noted above. It will be further appreciated that the thickness of the core foam layer 104 may be any value between any of the minimum and maximum values noted above.

According to yet other embodiments, the multilayer composite 100 may have a particular thickness. For example, the multilayer composite 100 may have a thickness of at least about 0.5 mm, such as, at least about 1.0 mm or at least about 1.5 mm or at least about 2.0 mm or at least about 2.5 mm or at least about 3.0 mm or at least about 3.5 mm or at least about 4.0 mm or at least about 4.5 mm or even at least about 5.0 mm. According to still other embodiments, the multilayer composite 100 may have a thickness of not greater than about 10 mm, such as, not greater than about 9.5 mm or not greater than about 9.0 mm or not greater than about 8.5 mm or not greater than about 8.0 mm or not greater than about 7.5 mm or not greater than about 7.0 mm or not greater than about 6.5 mm or even not greater than about 6.0 mm. It will be appreciated that the thickness of the multilayer composite 100 may be within a range between any of the minimum and maximum values noted above. It will be further appreciated that the thickness of the multilayer composite 100 may be any value between any of the minimum and maximum values noted above.

According to yet other embodiments, the core foam layer 104 may have a particular 25% strain compression rating. For purposes of embodiments described herein, the 25% strain compression rating is defined as the compression rating of a sample measure at a 25% strain and is determined by measuring the force-to-compress and compression-force-deflection of the sample at a 25% strain. Force-to-compress (FTC) is defined as the peak force (or stress) to compress the sample to a predetermined strain and compression-force-deflection (CFD) is defined as the plateau or relaxation force (or stress) retained by a sample when held at the desired strain (i.e., 25%). Measurements are made using a Texture Analyzer, which finds and records both FTC values and CFD values after a hold time of 60 seconds, a compression speed of 0.16 mm/s and a trigger force of 10 grams.

According to certain embodiments, the core foam layer 104 may have a 25% strain compression rating of not greater than about 500 kPa, such as, not greater than about 475 kPa or not greater than about 450 kPa or not greater than about 425 kPa or not greater than about 400 kPa or not greater than about 375 kPa or not greater than about 350 kPa or not greater than about 325 kPa or not greater than about 300 kPa or not greater than about 275 kPa or not greater than about 250 kPa or not greater than about 225 kPa or not greater than about 200 kPa or not greater than about 175 kPa or not greater than about 150 kPa or not greater than about 125 kPa or not greater than about 100 kPa. According to still other embodiments, the core foam layer 104 may have a 25% strain compression rating of at least about 5 kPa, such as, at least about 10 kPa or at least about 15 kPa or at least about 20 kPa or at least about 25 kPa. It will be appreciated that the 25% strain compression rating of the core foam layer 104 may be within a range between any of the minimum and maximum values noted above. It will be further appreciated that the 50% strain compression rating of the core foam layer 104 may be any value between any of the minimum and maximum values noted above.

According to yet other embodiments, the multilayer composite 100 may have a particular 25% strain compression rating. For purposes of embodiments described herein, the 25% strain compression rating is defined as the compression rating of a sample measure at a 25% strain and is determined by measuring the force-to-compress and compression-force-deflection of the sample at a 25% strain. Force-to-compress (FTC) is defined as the peak force (or stress) to compress the sample to a predetermined strain and compression-force-deflection (CFD) is defined as the plateau or relaxation force (or stress) retained by a sample when held at the desired strain (i.e., 25%). Measurements are made using a Texture Analyzer, which finds and records both FTC values and CFD values after a hold time of 60 seconds, a compression speed of 0.16 mm/s and a trigger force of 10 grams.

According to certain embodiments, the multilayer composite 100 may have a 25% strain compression rating of not greater than about 500 kPa, such as, not greater than about 475 kPa or not greater than about 450 kPa or not greater than about 425 kPa or not greater than about 400 kPa or not greater than about 375 kPa or not greater than about 350 kPa or not greater than about 325 kPa or not greater than about 300 kPa or not greater than about 275 kPa or not greater than about 250 kPa or not greater than about 225 kPa or not greater than about 200 kPa or not greater than about 175 kPa or not greater than about 150 kPa or not greater than about 125 kPa or not greater than about 100 kPa. According to still other embodiments, the multilayer composite 100 may have a 25% strain compression rating of at least about 5 kPa, such as, at least about 10 kPa or at least about 15 kPa or at least about 20 kPa or at least about 25 kPa. It will be appreciated that the 25% strain compression rating of the multilayer composite 100 may be within a range between any of the minimum and maximum values noted above. It will be further appreciated that the 50% strain compression rating of the multilayer composite 100 may be any value between any of the minimum and maximum values noted above.

According to yet other embodiments, the core foam layer 104 may have a particular density. For purpose of embodiments described herein, the density of the core foam layer 104 may be determined according to ASTM D1056. According to certain embodiments, the core foam layer 104 may have a density of not greater than about 1200 kg/m³, such as, not great than about 1175 kg/m³ or not greater than about 1150 kg/m³ or not greater than about 1125 kg/m³ or not greater than about 1100 kg/m³ or not greater than about 1050 kg/m³ or not greater than about 1000 kg/m³ or not greater than about 950 kg/m³ or not greater than about 900 kg/m³ or not greater than about 850 kg/m³ or not greater than about 800 kg/m³ or not greater than about 750 kg/m³ or not greater than about 700 kg/m³ or even not greater than about 650 kg/m³. According to yet other embodiments, the core foam layer 104 may have a density of at least about 100 kg/m³, such as, at least about 120 kg/m³ or at least about 140 kg/m³ or at least about 160 kg/m³ or at least about 180 kg/m³ or at least about 200 kg/m³ or at least about 220 kg/m³ or even at least about 240 kg/m³. It will be appreciated that the density of the core foam layer 104 may be within a range between any of the minimum and maximum values noted above. It will be further appreciated that the density of the core foam layer 104 may be any value between any of the minimum and maximum values noted above.

According to yet other embodiments, the multilayer composite 100 may have a particular density. For the purpose of embodiments described herein, the density of the core foam layer 104 may be determined according to ASTM D1056. According to certain embodiments, the multilayer composite 100 may have a density of not greater than about 1500 kg/m³, such as, not great than about 1475 kg/m³ or not greater than about 1450 kg/m³ or not greater than about 1425 kg/m³ or not greater than about 1400 kg/m³ or not greater than about 1350 kg/m³ or not greater than about 1300 kg/m³ or not greater than about 1250 kg/m³ or not greater than about 1200 kg/m³ or not greater than about 1150 kg/m³ or not greater than about 1100 kg/m³ or not greater than about 1050 kg/m³ or not greater than about 1000 kg/m³ or even not greater than about 950 kg/m³. According to yet other embodiments, the multilayer composite 100 may have a density of at least about 100 kg/m³, such as, at least about 120 kg/m³ or at least about 140 kg/m³ or at least about 160 kg/m³ or at least about 180 kg/m³ or at least about 200 kg/m³ or at least about 220 kg/m³ or even at least about 240 kg/m³. It will be appreciated that the density of the multilayer composite 100 may be within a range between any of the minimum and maximum values noted above. It will be further appreciated that the density of the multilayer composite 100 may be any value between any of the minimum and maximum values noted above.

According to yet other embodiments, the core foam layer 104 may have a particular thermal conductivity as measured according to ASTM C518. For example, the core foam layer 104 may have a thermal conductivity of at least about 0.01 W/mK, such as, at least about 0.02 W/mK or at least about 0.03 W/mK or at least about 0.04 W/mK or even at least about 0.05 W/mK. According to still other embodiments, the core foam layer 104 may have a thermal conductivity of not greater than about 0.15 W/mK, such as, not greater than about 0.14 W/mK or not greater than about 0.13 W/mK or not greater than about 0.12 W/mK or not greater than about 0.11 W/mK or not greater than about 0.10 W/mK not greater than about 0.09 W/mK or not greater than about 0.08 W/mK or even not greater than about 0.07 W/mK. It will be appreciated that the thermal conductivity of the core foam layer 104 may be within a range between any of the minimum and maximum values noted above. It will be further appreciated that the thermal conductivity of the core foam layer 104 may be any value between any of the minimum and maximum values noted above.

According to yet other embodiments, the multilayer composite 100 may have a particular thermal conductivity as measured according to ASTM C518. For example, the multilayer composite 100 may have a thermal conductivity of at least about 0.01 W/mK, such as, at least about 0.02 W/mK or at least about 0.03 W/mK or at least about 0.04 W/mK or even at least about 0.05 W/mK. According to still other embodiments, the multilayer composite 100 may have a thermal conductivity of not greater than about 0.15 W/mK, such as, not greater than about 0.14 W/mK or not greater than about 0.13 W/mK or not greater than about 0.12 W/mK or not greater than about 0.11 W/mK or not greater than about 0.10 W/mK not greater than about 0.09 W/mK or not greater than about 0.08 W/mK or even not greater than about 0.07 W/mK. It will be appreciated that the thermal conductivity of the multilayer composite 100 may be within a range between any of the minimum and maximum values noted above. It will be further appreciated that the thermal conductivity of the multilayer composite 100 may be any value between any of the minimum and maximum values noted above.

According to other embodiments, the core foam layer 104 may include a polyurethane-based foam that may include a polyurethane-based matrix component, and a flame retardant filler component.

According to particular embodiments, the polyurethane-based matrix component of the core foam layer 104 may include a particular material. For example, the polyurethane-based matrix component of the core foam layer 104 may include a flexible polyurethane reacted from isocyanate and polyol.

According to particular embodiments, the polyurethane-based matrix component of the core foam layer 104 may consist of a particular material. For example, the polyurethane-based matrix component of the core foam layer 104 may consist of a flexible polyurethane reacted from isocyanate and polyol.

According to particular embodiments, the polyurethane-based matrix component of the core foam layer 104 may be a layer of a particular material. For example, the polyurethane-based matrix component of the core foam layer 104 may be a flexible polyurethane layer, which is reacted from isocyanate and polyol.

According to yet other embodiments, the flame retardant filler component may be selected from a particular group of materials. For example, the flame retardant filler component may be a filler selected from the group consisting of reactive charring agents, mineral compounds, endothermic decomposition compounds, and any combination thereof.

According to still other embodiments, the flam retardant filler component may include a particular material. For example, the flame retardant filler component may include reactive charring agents. It will be appreciated that a reactive charring agent may be defined as a compound that can react with a carbon source, such as a polymer material, at high temperatures to form a carbon layer. According to still other embodiments, the flame retardant filler component may include melamine. According to yet other embodiments, the flame retardant filler component may include organic phosphorous compounds. According to still other embodiments, the flame retardant filler component may include inorganic phosphorous compounds. According to yet other embodiments, the flame retardant filler component may include metal salts. According to yet other embodiments, the flame retardant filler component may include mineral compounds. According to still other embodiments, the flame retardant filler component may include endothermic decomposition compounds. According to other embodiments, the flame retardant filler component may include any combination of reactive charring agents, melamine, organic phosphorous compounds, inorganic phosphorous compounds, metal salts, mineral compounds, or endothermic decomposition compounds.

According to still other embodiments, the flam retardant filler component may consist of a particular material. For example, the flame retardant filler component may consist of reactive charring agents. According to still other embodiments, the flame retardant filler component may consist of melamine. According to yet other embodiments, the flame retardant filler component may consist of organic phosphorous compounds. According to still other embodiments, the flame retardant filler component may consist of inorganic phosphorous compounds. According to yet other embodiments, the flame retardant filler component may consist of metal salts. According to yet other embodiments, the flame retardant filler component may consist of mineral compounds. According to still other embodiments, the flame retardant filler component may consist of endothermic decomposition compounds. According to other embodiments, the flame retardant filler component may consist of any combination of reactive charring agents, melamine, organic phosphorous compounds, inorganic phosphorous compounds, metal salts, mineral compounds, or endothermic decomposition compounds.

According to still other embodiments, the flam retardant filler component may be a filler of a particular material. For example, the flame retardant filler component may be a filler of reactive charring agents. According to still other embodiments, the flame retardant filler component may be a filler of melamine. According to yet other embodiments, the flame retardant filler component may be a filler of organic phosphorous compounds. According to still other embodiments, the flame retardant filler component may be a filler of inorganic phosphorous compounds. According to yet other embodiments, the flame retardant filler component may be a filler of metal salts. According to yet other embodiments, the flame retardant filler component may be a filler of mineral compounds. According to still other embodiments, the flame retardant filler component may be a filler of endothermic decomposition compounds. According to other embodiments, the flame retardant filler component may be a filler of any combination of reactive charring agents, melamine, organic phosphorous compounds, inorganic phosphorous compounds, metal salts, mineral compounds, or endothermic decomposition compounds.

According to yet other embodiments, the flame retardant filler component may include a particular organic phosphorous compound or inorganic phosphorous compound. For example, the flame retardant filler component may include a phosphate. According to yet other embodiments, the flame retardant filler component may include a phosphonate. According to yet other embodiments, the flame retardant filler component may include a phosphinate. According to a particular embodiment, the flame retardant filler component may include any combination of a phosphate, a phosphonate, or a phosphinate.

According to yet other embodiments, the flame retardant filler component may consist of a particular organic phosphorous compound or inorganic phosphorous compound. For example, the flame retardant filler component may consist of a phosphate. According to yet other embodiments, the flame retardant filler component may consist of a phosphonate. According to yet other embodiments, the flame retardant filler component may consist of a phosphinate. According to a particular embodiment, the flame retardant filler component may consist of any combination of a phosphate, a phosphonate, or a phosphinate.

According to yet other embodiments, the flame retardant filler component may be a filler of a particular organic phosphorous compound or inorganic phosphorous compound. For example, the flame retardant filler component may be a filler of a phosphate. According to yet other embodiments, the flame retardant filler component may be a filler of a phosphonate. According to yet other embodiments, the flame retardant filler component may be a filler of a phosphinate. According to a particular embodiment, the flame retardant filler component may be a filler of any combination of a phosphate, a phosphonate, or a phosphinate.

According to still other embodiments, the flame retardant filler component may include a particular metal salt. For example, the flame retardant filler component may include aluminum diethyl phosphinate.

According to still other embodiments, the flame retardant filler component may consist of a particular metal salt. For example, the flame retardant filler component may consist of aluminum diethyl phosphinate.

According to still other embodiments, the flame retardant filler component may be a filler of a particular metal salt. For example, the flame retardant filler component may be a filler of aluminum diethyl phosphinate. According to still other embodiments, the flame retardant filler component may include a particular mineral compound. For example, the flame retardant filler component may include expandable graphite.

According to still other embodiments, the flame retardant filler component may consist of a particular mineral compound. For example, the flame retardant filler component may consist of expandable graphite.

According to still other embodiments, the flame retardant filler component may be a filler of particular mineral compound. For example, the flame retardant filler component may be an expandable graphite filler.

According to yet other embodiments, the flame retardant filler component may include a particular endothermic decomposition compound. For example, the flame retardant filler component may include a metal hydrate. According to still other embodiments, the flame retardant filler component may include a metal silicate. According to yet other embodiments, the flame retardant filler component may include a carbonate. According to a particular embodiment, the flame retardant filler component may include aluminum trihydrate. According to still other embodiments, the flame retardant filler component may include zinc borate. According to yet other embodiments, the flame retardant filler component may include any combination of a metal hydrate, a metal silicate, a carbonate, aluminum trihydrate, or zinc borate.

According to yet other embodiments, the flame retardant filler component may consist of a particular endothermic decomposition compound. For example, the flame retardant filler component may consist of a metal hydrate. According to still other embodiments, the flame retardant filler component may consist of a metal silicate. According to yet other embodiments, the flame retardant filler component may consist of a carbonate. According to a particular embodiment, the flame retardant filler component may consist of aluminum trihydrate. According to still other embodiments, the flame retardant filler component may consist of zinc borate. According to yet other embodiments, the flame retardant filler component may consist of any combination of a metal hydrate, a metal silicate, a carbonate, aluminum trihydrate, or zinc borate.

According to yet other embodiments, the flame retardant filler component may be a filler of a particular endothermic decomposition compound. For example, the flame retardant filler component may be a metal hydrate filler. According to still other embodiments, the flame retardant filler component may be a metal silicate filler. According to yet other embodiments, the flame retardant filler component may be a carbonate filler. According to a particular embodiment, the flame retardant filler component may be an aluminum trihydrate filler. According to still other embodiments, the flame retardant filler component may be a filler of zinc borate. According to yet other embodiments, the flame retardant filler component may be a filler of any combination of a metal hydrate, a metal silicate, a carbonate, aluminum trihydrate, or zinc borate.

According to certain embodiments, the core foam layer 104 may include a particular content of the polyurethane-based matrix component. For example, the core foam layer 104 may include a polyurethane-based matrix component content of at least about 40 wt. % for a total weight of the core foam layer 104, such as, at least about 45 wt. % or at least about 50 wt. % or at least about 55 wt. % or at least about 60 wt. % or at least about 65 wt. % or even at least about 70 wt. %. According to yet other embodiments, the core foam layer 104 may include a polyurethane-based matrix component content of not greater than about 95 wt. % for a total weight of the core foam layer 104, such as, not greater than about 90 wt. % or not greater than about 85 wt. % or not greater than about 80 wt. % or even not greater than about 75 wt. %. It will be appreciated that the polyurethane-based matrix component content of the core foam layer 104 may be within a range between any of the values noted above. It will be further appreciated that the polyurethane-based matrix component content of the core foam layer 104 may be any value between any of the minimum and maximum values noted above.

According to still other embodiments, the core foam layer 104 may include a particular content of flame retardant filler component. For example, the core foam layer 104 may include a flame retardant filler component content of at least about 5 wt. % for a total weight of the core foam layer 104, such as, at least about 10 wt. % or at least about 15 wt. % or at least about 20 wt. % or at least about 25 wt. % or at least about 30 wt. % or even at least about 35 wt. %. According to yet other embodiments, the core foam layer 104 may include a flame retardant filler component content of not greater than about 60 wt. % for a total weight of the core foam layer 104, such as, not greater than about 55 wt. % or not greater than about 50 wt. % or not greater than about 45 wt. % or even not greater than about 40 wt. %. It will be appreciated that the flame retardant filler component content of the core foam layer 104 may be within a range between any of the minimum and maximum values noted above. It will be further appreciated that the flame retardant filler component content of the core foam layer 104 may be any value between any of the minimum and maximum values noted above.

According to certain embodiments, the core foam layer 104 may have a particular flammability rating as measured according to ASTM D4986. In particular, the foam layer may have an HFB flammability rating as measured according to ASTM D4986.

According to certain embodiments, the multilayer composite 100 may have a particular flammability rating as measured according to ASTM D4986. In particular, the foam layer may have an HFB flammability rating as measured according to ASTM D4986.

According to still other embodiments, the core foam layer 104 may have a particular cold-side temperature as measured at 5 minutes when a 3 mm thickness of the foam is exposed to a hot plate test at 650° C. For purposes of embodiments described herein, the hot plate test is carried out by preparing a 1-inch by 1-inch specimen of the material, which is put on top of a hot plate. Then a thermal couple is fixed in a steel weight (1 inch in diameter, 2 inches in height) is put on top of the specimen to measure the cold side surface temperature. According to certain embodiments, the core foam layer 104 may have a cold side temperature of not greater than about 300° C., such as, not greater than about 275° C. or not greater than about 250° C. or not greater than about 225° C. or not greater than about 200° C. or not greater than about 175° C. or even not greater than about 150° C. According to still other embodiments, the core foam layer 104 may have a cold side temperature of at least about 25° C. It will be appreciated that the cold side temperature of the core foam layer 104 may be within a range between any of the values noted above. It will be further appreciated that the cold side temperature of the core foam layer 104 may be any value between any of the values noted above.

According to still other embodiments, the multilayer composite 100 may have a particular cold-side temperature as measured at 5 minutes when a 3 mm thickness of the foam is exposed to a hot plate test at 650° ° C. For purposes of embodiments described herein, the hot plate test is carried out by preparing a 1 inch by 1 inch specimen of the material, which is put on top of a hot plate. Then a thermal couple is fixed in a steel weight (1 inch in diameter, 2 inches in height) is put on top of the specimen to measure the cold side surface temperature. According to certain embodiments, the multilayer composite 100 may have a cold side temperature of not greater than about 300° C., such as, not greater than about 275° C. or not greater than about 250° C. or not greater than about 225° C. or not greater than about 200° C. or not greater than about 175° C. or even not greater than about 150° C. According to still other embodiments, the multilayer composite 100 may have a cold side temperature of at least about 25° C. It will be appreciated that the cold side temperature of the multilayer composite 100 may be within a range between any of the values noted above. It will be further appreciated that the cold side temperature of the multilayer composite 100 may be any value between any of the values noted above.

According to yet other embodiments, the core foam layer 104 may have a particular thickness. For example, the core foam layer 104 may have a thickness of at least about 0.5 mm, such as, at least about 1.0 mm or at least about 1.5 mm or at least about 2.0 mm or at least about 2.5 mm or at least about 3.0 mm or at least about 3.5 mm or at least about 4.0 mm or at least about 4.5 mm or even at least about 5.0 mm. According to still other embodiments, the core foam layer 104 may have a thickness of not greater than about 10 mm, such as, not greater than about 9.5 mm or not greater than about 9.0 mm or not greater than about 8.5 mm or not greater than about 8.0 mm or not greater than about 7.5 mm or not greater than about 7.0 mm or not greater than about 6.5 mm or even not greater than about 6.0 mm. It will be appreciated that the thickness of the core foam layer 104 may be within a range between any of the minimum and maximum values noted above. It will be further appreciated that the thickness of the core foam layer 104 may be any value between any of the minimum and maximum values noted above.

According to yet other embodiments, the multilayer composite 100 may have a particular thickness. For example, the multilayer composite 100 may have a thickness of at least about 0.5 mm, such as, at least about 1.0 mm or at least about 1.5 mm or at least about 2.0 mm or at least about 2.5 mm or at least about 3.0 mm or at least about 3.5 mm or at least about 4.0 mm or at least about 4.5 mm or even at least about 5.0 mm. According to still other embodiments, the multilayer composite 100 may have a thickness of not greater than about 10 mm, such as, not greater than about 9.5 mm or not greater than about 9.0 mm or not greater than about 8.5 mm or not greater than about 8.0 mm or not greater than about 7.5 mm or not greater than about 7.0 mm or not greater than about 6.5 mm or even not greater than about 6.0 mm. It will be appreciated that the thickness of the multilayer composite 100 may be within a range between any of the minimum and maximum values noted above. It will be further appreciated that the thickness of the multilayer composite 100 may be any value between any of the minimum and maximum values noted above.

According to yet other embodiments, the core foam layer 104 may have a particular 25% strain compression rating. For purposes of embodiments described herein, the 25% strain compression rating is defined as the compression rating of a sample measure at a 25% strain and is determined by measuring the force-to-compress and compression-force-deflection of the sample at a 25% strain. Force-to-compress (FTC) is defined as the peak force (or stress) to compress the sample to a predetermined strain and compression-force-deflection (CFD) is defined as the plateau or relaxation force (or stress) retained by a sample when held at the desired strain (i.e., 25%). Measurements are made using a Texture Analyzer, which finds and records both FTC values and CFD values after a hold time of 60 seconds, a compression speed of 0.16 mm/s and a trigger force of 10 grams.

According to certain embodiments, the core foam layer 104 may have a 25% strain compression rating of not greater than about 500 kPa, such as, not greater than about 475 kPa or not greater than about 450 kPa or not greater than about 425 kPa or not greater than about 400 kPa or not greater than about 375 kPa or not greater than about 350 kPa or not greater than about 325 kPa or not greater than about 300 kPa or not greater than about 275 kPa or not greater than about 250 kPa or not greater than about 225 kPa or not greater than about 200 kPa or not greater than about 175 kPa or not greater than about 150 kPa or not greater than about 125 kPa or not greater than about 100 kPa. According to still other embodiments, the core foam layer 104 may have a 25% strain compression rating of at least about 5 kPa, such as, at least about 10 kPa or at least about 15 kPa or at least about 20 kPa or at least about 25 kPa. It will be appreciated that the 25% strain compression rating of the core foam layer 104 may be within a range between any of the minimum and maximum values noted above. It will be further appreciated that the 25% strain compression rating of the core foam layer 104 may be any value between any of the minimum and maximum values noted above.

According to yet other embodiments, the multilayer composite 100 may have a particular 25% strain compression rating. For purposes of embodiments described herein, the 25% strain compression rating is defined as the compression rating of a sample measure at a 25% strain and is determined by measuring the force-to-compress and compression-force-deflection of the sample at a 25% strain. Force-to-compress (FTC) is defined as the peak force (or stress) to compress the sample to a predetermined strain and compression-force-deflection (CFD) is defined as the plateau or relaxation force (or stress) retained by a sample when held at the desired strain (i.e., 25%). Measurements are made using a Texture Analyzer, which finds and records both FTC values and CFD values after a hold time of 60 seconds, a compression speed of 0.16 mm/s and a trigger force of 10 grams.

According to certain embodiments, the multilayer composite 100 may have a 25% strain compression rating of not greater than about 500 kPa, such as, not greater than about 475 kPa or not greater than about 450 kPa or not greater than about 425 kPa or not greater than about 400 kPa or not greater than about 375 kPa or not greater than about 350 kPa or not greater than about 325 kPa or not greater than about 300 kPa or not greater than about 275 kPa or not greater than about 250 kPa or not greater than about 225 kPa or not greater than about 200 kPa or not greater than about 175 kPa or not greater than about 150 kPa or not greater than about 125 kPa or not greater than about 100 kPa. According to still other embodiments, the multilayer composite 100 may have a 25% strain compression rating of at least about 5 kPa, such as, at least about 10 kPa or at least about 15 kPa or at least about 20 kPa or at least about 25 kPa. It will be appreciated that the 25% strain compression rating of the multilayer composite 100 may be within a range between any of the minimum and maximum values noted above. It will be further appreciated that the 25% strain compression rating of the multilayer composite 100 may be any value between any of the minimum and maximum values noted above.

According to yet other embodiments, the core foam layer 104 may have a particular density. For purpose of embodiments described herein, the density of the core foam layer 104 may be determined according to ASTM D1056. According to certain embodiments, the core foam layer 104 may have a density of not greater than about 600 kg/m³, such as, not great than about 575 kg/m³ or not greater than about 550 kg/m³ or not greater than about 525 kg/m³ or not greater than about 500 kg/m³ or not greater than about 450 kg/m³ or not greater than about 400 kg/m³ or not greater than about 350 kg/m³ or even not greater than about 300 kg/m³. According to yet other embodiments, the core foam layer 104 may have a density of at least about 50 kg/m³, such as, at least about 60 kg/m³ or at least about 80 kg/m³ or at least about 100 kg/m³ or at least about 120 kg/m³ or at least about 140 kg/m³ or at least about 160 kg/m³ or at least about 180 kg/m³ or at least about 200 kg/m³ or at least about 220 kg/m³ or even at least about 240 kg/m³. It will be appreciated that the density of the core foam layer 104 may be within a range between any of the minimum and maximum values noted above. It will be further appreciated that the density of the core foam layer 104 may be any value between any of the minimum and maximum values noted above.

According to yet other embodiments, the multilayer composite 100 may have a particular density. For purpose of embodiments described herein, the density of the multilayer composite 100 may be determined according to ASTM D1056. According to certain embodiments, the multilayer composite 100 may have a density of not greater than about 600 kg/m³, such as, not great than about 575 kg/m³ or not greater than about 550 kg/m³ or not greater than about 525 kg/m³ or not greater than about 500 kg/m³ or not greater than about 450 kg/m³ or not greater than about 400 kg/m³ or not greater than about 350 kg/m³ or even not greater than about 300 kg/m³. According to yet other embodiments, the multilayer composite 100 may have a density of at least about 50 kg/m³, such as, at least about 60 kg/m³ or at least about 80 kg/m³ or at least about 100 kg/m³ or at least about 120 kg/m³ or at least about 140 kg/m³ or at least about 160 kg/m³ or at least about 180 kg/m³ or at least about 200 kg/m³ or at least about 220 kg/m³ or even at least about 240 kg/m³. It will be appreciated that the density of the multilayer composite 100 may be within a range between any of the minimum and maximum values noted above. It will be further appreciated that the density of the multilayer composite 100 may be any value between any of the minimum and maximum values noted above.

According to yet other embodiments, the core foam layer 104 may have a particular thermal conductivity as measured according to ASTM C518. For example, the core foam layer 104 may have a thermal conductivity of at least about 0.01 W/mK, such as, at least about 0.02 W/mK or at least about 0.03 W/mK or at least about 0.04 W/mK or even at least about 0.05 W/mK. According to still other embodiments, the core foam layer 104 may have a thermal conductivity of not greater than about 0.15 W/mK, such as, not greater than about 0.14 W/mK or not greater than about 0.13 W/mK or not greater than about 0.12 W/mK or not greater than about 0.11 W/mK or not greater than about 0.10 W/mK not greater than about 0.09 W/mK or not greater than about 0.08 W/mK or even not greater than about 0.07 W/mK. It will be appreciated that the thermal conductivity of the core foam layer 104 may be within a range between any of the minimum and maximum values noted above. It will be further appreciated that the thermal conductivity of the core foam layer 104 may be any value between any of the minimum and maximum values noted above.

According to yet other embodiments, the multilayer composite 100 may have a particular thermal conductivity as measured according to ASTM C518. For example, the multilayer composite 100 may have a thermal conductivity of at least about 0.01 W/mK, such as, at least about 0.02 W/mK or at least about 0.03 W/mK or at least about 0.04 W/mK or even at least about 0.05 W/mK. According to still other embodiments, the multilayer composite 100 may have a thermal conductivity of not greater than about 0.15 W/mK, such as, not greater than about 0.14 W/mK or not greater than about 0.13 W/mK or not greater than about 0.12 W/mK or not greater than about 0.11 W/mK or not greater than about 0.10 W/mK not greater than about 0.09 W/mK or not greater than about 0.08 W/mK or even not greater than about 0.07 W/mK. It will be appreciated that the thermal conductivity of the multilayer composite 100 may be within a range between any of the minimum and maximum values noted above. It will be further appreciated that the thermal conductivity of the multilayer composite 100 may be any value between any of the minimum and maximum values noted above.

According to other embodiments, the core foam layer 104 may include a different type of silicone-based foam.

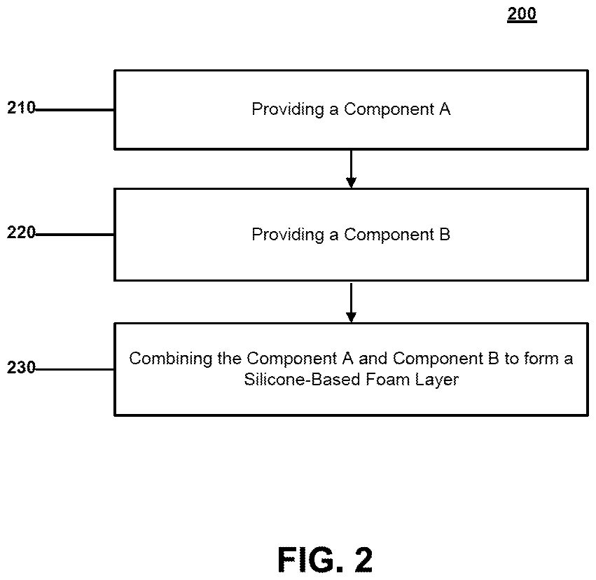

Referring first to a method of forming this silicone-based foam, FIG. 2 includes a diagram showing a forming method 200 for forming a layer of the silicone-based foam according to embodiments described herein. According to particular embodiments, the forming method 200 may include a first step 210 of providing a component A, a second step 220 of providing a component B, and a third step 230 of combining the component A and component B to form a layer of the silicone-based foam.

Referring to first step 210, the component A may include a silicone-based matrix component, a first filler component, a second filler component, and a third filler component.

According to particular embodiments, the silicone-based matrix component of the component A may include additional components. For example, the silicone-based matrix component may include platinum (Pt). According to still other embodiments, the silicone-based be a platinum catalyzed silicone-based matrix component. According to still other embodiments, the silicone-based matrix component of the component A may include peroxide. According to still other embodiments, the silicone-based may be a peroxide catalyzed silicone-based matrix component. According to still other embodiments, the silicone-based matrix component of the component A may include tin. According to yet other embodiments, the silicone-based matrix component of the component A may include tin catalyzed silicone-based matrix component. According to still other embodiments, the silicone-based matrix component of the component A may include tris(pentafluorophenyl) borane. According to still other embodiments, the silicone-based matrix component of the component A may include a transient basic catalyst. According to still other embodiments, the silicone-based matrix component of the component A may include phosphoronitrile chloride. According to still other embodiments, the silicone-based matrix component of the component A may include ruthenium.

According to certain embodiments, the component A may include a particular content of the silicone-based matrix component. For example, the component A may include a silicone-based matrix component content of at least about 30 wt. % for a total weight of the component A, such as, at least about 32 wt. % or at least about 35 wt. % or at least about 37 wt. % or at least about 40 wt. % or at least about 42 wt. % or even at least about 45 wt. %. According to yet other embodiments, the component A may include a silicone-based matrix component content of not greater than about 60 wt. % for a total weight of the component A, such as, not greater than about 58 wt. % or not greater than about 55 wt. % or not greater than about 53 wt. % or even not greater than about 50 wt. %. It will be appreciated that the silicone-based matrix component content of the component A may be within a range between any of the values noted above. It will be further appreciated that the silicone-based matrix component content of the component A may be any value between any of the minimum and maximum values noted above.

According to certain embodiments, the first filler component of the component A may include alumina trihydrate. According to still other embodiments, the first filler component of the component A may consist of alumina trihydrate. According to yet other embodiments, the first filler component of the component A may be an alumina trihydrate filler.

According to other embodiments, the component A may include a particular content of the first filler component. For example, the component A may include a first filler component content of at least about 5.0 wt. % for a total weight of the component A, such as, at least about 5.5 wt. % or at least about 6.0 wt. % or at least about 6.5 wt. % or at least about 7.0 wt. % or at least about 7.5 wt. % or even at least about 8.0 wt. %. According to yet other embodiments, the component A may include a first filler component content of not greater than about 30.0 wt. % for a total weight of the component A, such as, not greater than about 28.0 wt. % or not greater than about 26.0 wt. % or not greater than about 24.0 wt. % or even not greater than about 22.0 wt. %. It will be appreciated that the first filler component content of the component A may be within a range between any of the values noted above. It will be further appreciated that the first filler component content of the component A may be any value between any of the minimum and maximum values noted above.

According to other embodiments, the component A may include a particular content of alumina trihydrate. For example, the component A may include an alumina trihydrate content of at least about 5.0 wt. % for a total weight of the component A, such as, at least about 5.5 wt. % or at least about 6.0 wt. % or at least about 6.5 wt. % or at least about 7.0 wt. % or at least about 7.5 wt. % or even at least about 8.0 wt. %. According to yet other embodiments, the component A may include an alumina trihydrate content of not greater than about 30.0 wt. % for a total weight of the component A, such as, not greater than about 28.0 wt. % or not greater than about 26.0 wt. % or not greater than about 24.0 wt. % or even not greater than about 22.0 wt. %. It will be appreciated that the alumina trihydrate content of the component A may be within a range between any of the values noted above. It will be further appreciated that the alumina trihydrate content of the component A may be any value between any of the minimum and maximum values noted above.

According to still other embodiments, the second filler component of the component A may include perlite. According to still other embodiments, the second filler component of the component A may consist of perlite. According to yet other embodiments, the second filler component of the component A may be a perlite filler.

According to other embodiments, the component A may include a particular content of the second filler component. For example, the component A may include a second filler component content of at least about 1.0 wt. % for a total weight of the component A, such as, at least about 1.5 wt. % or at least about 2.0 wt. % or at least about 2.5 wt. % or at least about 3.0 wt. % or at least about 3.5 wt. % or even at least about 4.0 wt. %. According to yet other embodiments, the component A may include a second filler component content of not greater than about 15.0 wt. % for a total weight of the component A, such as, not greater than about 14.0 wt. % or not greater than about 13.0 wt. % or not greater than about 12.0 wt. % or even not greater than about 11.0 wt. %. It will be appreciated that the second filler component content of the component A may be within a range between any of the values noted above. It will be further appreciated that the second filler component content of the component A may be any value between any of the minimum and maximum values noted above.

According to other embodiments, the component A may include a particular content of perlite. For example, the component A may include a perlite content of at least about 1.0 wt. % for a total weight of the component A, such as, at least about 1.5 wt. % or at least about 2.0 wt. % or at least about 2.5 wt. % or at least about 3.0 wt. % or at least about 3.5 wt. % or even at least about 4.0 wt. %. According to yet other embodiments, the component A may include a perlite content of not greater than about 15.0 wt. % for a total weight of the component A, such as, not greater than about 14.0 wt. % or not greater than about 13.0 wt. % or not greater than about 12.0 wt. % or even not greater than about 11.0 wt. %. It will be appreciated that the perlite content of the component A may be within a range between any of the values noted above. It will be further appreciated that the perlite content of the component A may be any value between any of the minimum and maximum values noted above.

According to still other embodiments, the third filler component of the component A may include calcium carbonate. According to still other embodiments, the third filler component of the component A may consist of calcium carbonate. According to yet other embodiments, the third filler component of the component A may be a calcium carbonate filler.

According to other embodiments, the component A may include a particular content of the third filler component. For example, the component A may include a third filler component content of at least about 1.0 wt. % for a total weight of the component A, such as, at least about 1.5 wt. % or at least about 2.0 wt. % or at least about 2.5 wt. % or at least about 3.0 wt. % or at least about 3.5 wt. % or even at least about 4.0 wt. %. According to yet other embodiments, the component A may include a third filler component content of not greater than about 20.0 wt. % for a total weight of the component A, such as, not greater than about 18.0 wt. % or not greater than about 16.0 wt. % or not greater than about 14 wt. % or even not greater than about 12.0 wt. %. It will be appreciated that the third filler component content of the component A may be within a range between any of the values noted above. It will be further appreciated that the third filler component content of the component A may be any value between any of the minimum and maximum values noted above.

According to other embodiments, the component A may include a particular content of calcium carbonate. For example, the component A may include a calcium carbonate content of at least about 1.0 wt. % for a total weight of the component A, such as, at least about 1.5 wt. % or at least about 2.0 wt. % or at least about 2.5 wt. % or at least about 3.0 wt. % or at least about 3.5 wt. % or even at least about 4.0 wt. %. According to yet other embodiments, the component A may include a calcium carbonate content of not greater than about 20.0 wt. % for a total weight of the component A, such as, not greater than about 18.0 wt. % or not greater than about 16.0 wt. % or not greater than about 14 wt. % or even not greater than about 12.0 wt. %. It will be appreciated that the calcium carbonate content of the component A may be within a range between any of the values noted above. It will be further appreciated that the calcium carbonate content of the component A may be any value between any of the minimum and maximum values noted above.

According to still other embodiments, the component A may further include a pigment component.

According to other embodiments, the component A may include a particular content of the pigment component. For example, the component A may include a pigment component content of at least about 1.0 wt. % for a total weight of the component A, such as, at least about 1.5 wt. % or at least about 2.0 wt. % or even at least about 2.5 wt. %. According to yet other embodiments, the component A may include a pigment component content of not greater than about 5.0 wt. % for a total weight of the component A, such as, not greater than about 4.5 wt. % or not greater than about 4.0 wt. % or not greater than about 3.5 wt. % or even not greater than about 3.0 wt. %. It will be appreciated that the pigment component content of the component A may be within a range between any of the values noted above. It will be further appreciated that the pigment component content of the component A may be any value between any of the minimum and maximum values noted above.

According to still other embodiments, the component A may further include a vinyl-functional pre-polymer component.

According to other embodiments, the component A may include a particular content of the vinyl-functional pre-polymer component. For example, the component A may include a vinyl-functional pre-polymer component content of at least about 10.0 wt. % for a total weight of the component A, such as, at least about 11.0 wt. % or at least about 12.0 wt. % or at least about 13.0 wt. % or at least about 14.0 wt. % or at least about 15.0 wt. % or at least about 16.0 wt. % or at least about 17.0 wt. % or at least about 18.0 wt. % or at least about 19.0 wt. % or even at least about 20.0 wt. %. According to yet other embodiments, the component A may include a vinyl-functional pre-polymer component content of not greater than about 30.0 wt. % for a total weight of the component A, such as, not greater than about 29.0 wt. % or not greater than about 28.0 wt. % or not greater than about 27.0 wt. % or even not greater than about 26.0 wt. %. It will be appreciated that the vinyl-functional pre-polymer component content of the component A may be within a range between any of the values noted above. It will be further appreciated that the vinyl-functional pre-polymer component content of the component A may be any value between any of the minimum and maximum values noted above.

According to still other embodiments, the component A may further include an alcohol-blowing agent.

According to other embodiments, the component A may include a particular content of the alcohol-blowing agent. For example, the component A may include an alcohol blowing agent content of at least about 1.0 wt. % for a total weight of the component A, such as, at least about 1.5 wt. % or at least about 2.0 wt. % or at least about 2.5 wt. % or at least about 3.0 wt. % or at least about 3.5 wt. % or at least about 4.0 wt. % or at least about 4.5 wt. % or even at least about 4.5 wt. %. According to yet other embodiments, the component A may include an alcohol blowing agent content of not greater than about 10.0 wt. % for a total weight of the component A, such as, not greater than about 9.5 wt. % or not greater than about 9.0 wt. % or not greater than about 8.5 wt. % or even not greater than about 8.0 wt. %. It will be appreciated that the alcohol blowing agent content of the component A may be within a range between any of the values noted above. It will be further appreciated that the alcohol blowing agent content of the component A may be any value between any of the minimum and maximum values noted above.

According to still other embodiments, the component A may further include a resin solution.

According to other embodiments, the component A may include a particular content of the resin solution. For example, the component A may include a resin solution content of at least about 5.0 wt. % for a total weight of the component A, such as, at least about 6.0 wt. % or at least about 7.0 wt. % or at least about 8.0 wt. % or at least about 9.0 wt. % or at least about 10.0 wt. % or at least about 11.0 wt. % or at least about 12.0 wt. % or even at least about 13.0 wt. %. According to yet other embodiments, the component A may include a resin solution content of not greater than about 25.0 wt. % for a total weight of the component A, such as, not greater than about 24.0 wt. % or not greater than about 23.0 wt. % or not greater than about 22.0 wt. % or even not greater than about 21.0 wt. %. It will be appreciated that the resin solution content of the component A may be within a range between any of the values noted above. It will be further appreciated that the resin solution content of the component A may be any value between any of the minimum and maximum values noted above.

According to still other embodiments, the component A may further include a PT catalyst component.

According to other embodiments, the component A may include a particular content of the PT catalyst component. For example, the component A may include a PT catalyst component content of at least about 0.02 wt. % for a total weight of the component A, such as, at least about 0.04 wt. % or at least about 0.06 wt. % or at least about 0.08 wt. % or even at least about 0.1 wt. %. According to yet other embodiments, the component A may include a PT catalyst component content of not greater than about 0.15 wt. % for a total weight of the component A, such as, not greater than about 0.14 wt. % or not greater than about 0.13 wt. % or not greater than about 0.12 wt. % or even not greater than about 0.11 wt. %. It will be appreciated that the PT catalyst component content of the component A may be within a range between any of the values noted above. It will be further appreciated that the PT catalyst component content of the component A may be any value between any of the minimum and maximum values noted above.

Referring to second step 220, the component B may include a silicone-based matrix component, a first filler component, a second filler component, a third filler component, and a fourth filler component.

According to particular embodiments, the silicone-based matrix component of the component B may include platinum catalyzed addition cured silicone foam. According to still other embodiments, the silicone-based matrix component of the component B may additional components. For example, the silicone-based matrix component may include platinum (Pt). According to still other embodiments, the silicone-based be a platinum catalyzed silicone-based matrix component. According to still other embodiments, the silicone-based matrix component of the component B may include peroxide. According to still other embodiments, the silicone-based may be a peroxide catalyzed silicone-based matrix component. According to still other embodiments, the silicone-based matrix component of the component B may include tin. According to yet other embodiments, the silicone-based matrix component of the component B may include tin catalyzed silicone-based matrix component. According to still other embodiments, the silicone-based matrix component of the component B may include tris(pentafluorophenyl) borane. According to still other embodiments, the silicone-based matrix component of the component B may include a transient basic catalyst. According to still other embodiments, the silicone-based matrix component of the component B may include phosphoronitrile chloride. According to still other embodiments, the silicone-based matrix component of the component B may include ruthenium.

According to certain embodiments, the component B may include a particular content of the silicone-based matrix component. For example, the component B may include a silicone-based matrix component content of at least about 20 wt. % for a total weight of the component B, such as, at least about 22 wt. % or at least about 25 wt. % or at least about 27 wt. % or at least about 30 wt. % or at least about 32 wt. % or even at least about 35 wt. %. According to yet other embodiments, the component B may include a silicone-based matrix component content of not greater than about 50 wt. % for a total weight of the component B, such as, not greater than about 48 wt. % or not greater than about 45 wt. % or not greater than about 43 wt. % or even not greater than about 40 wt. %. It will be appreciated that the silicone-based matrix component content of the component B may be within a range between any of the values noted above. It will be further appreciated that the silicone-based matrix component content of the component B may be any value between any of the minimum and maximum values noted above.

According to certain embodiments, the first filler component of the component B may include alumina trihydrate. According to still other embodiments, the first filler component of the component B may consist of alumina trihydrate. According to yet other embodiments, the first filler component of the component B may be an alumina trihydrate filler.

According to other embodiments, the component B may include a particular content of the first filler component. For example, the component B may include a first filler component content of at least about 5.0 wt. % for a total weight of the component B, such as, at least about 5.5 wt. % or at least about 6.0 wt. % or at least about 6.5 wt. % or at least about 7.0 wt. % or at least about 7.5 wt. % or even at least about 8.0 wt. %. According to yet other embodiments, the component B may include a first filler component content of not greater than about 30.0 wt. % for a total weight of the component B, such as, not greater than about 25.0 wt. % or not greater than about 20.0 wt. % or not greater than about 15.0 wt. % or even not greater than about 10.0 wt. %. It will be appreciated that the first filler component content of the component B may be within a range between any of the values noted above. It will be further appreciated that the first filler component content of the component B may be any value between any of the minimum and maximum values noted above.

According to other embodiments, the component B may include a particular content of alumina trihydrate. For example, the component B may include an alumina trihydrate content of at least about 5.0 wt. % for a total weight of the component B, such as, at least about 5.5 wt. % or at least about 6.0 wt. % or at least about 6.5 wt. % or at least about 7.0 wt. % or at least about 7.5 wt. % or even at least about 8.0 wt. %. According to yet other embodiments, the component B may include an alumina trihydrate content of not greater than about 30.0 wt. % for a total weight of the component B, such as, not greater than about 25.0 wt. % or not greater than about 20.0 wt. % or not greater than about 15.0 wt. % or even not greater than about 10.0 wt. %. It will be appreciated that the alumina trihydrate content of the component B may be within a range between any of the values noted above. It will be further appreciated that the alumina trihydrate content of the component B may be any value between any of the minimum and maximum values noted above.

According to still other embodiments, the second filler component of the component B may include perlite. According to still other embodiments, the second filler component of the component B may consist of perlite. According to yet other embodiments, the second filler component of the component B may be a perlite filler.

According to other embodiments, the component B may include a particular content of the second filler component. For example, the component B may include a second filler component content of at least about 1.0 wt. % for a total weight of the component B, such as, at least about 1.5 wt. % or at least about 2.0 wt. % or at least about 2.5 wt. % or at least about 3.0 wt. % or at least about 3.5 wt. % or even at least about 4.0 wt. %. According to yet other embodiments, the component B may include a second filler component content of not greater than about 15.0 wt. % for a total weight of the component B, such as, not greater than about 14.0 wt. % or not greater than about 13.0 wt. % or not greater than about 12.0 wt. % or even not greater than about 11.0 wt. %. It will be appreciated that the second filler component content of the component B may be within a range between any of the values noted above. It will be further appreciated that the second filler component content of the component B may be any value between any of the minimum and maximum values noted above.

According to other embodiments, the component B may include a particular content of perlite. For example, the component B may include a perlite content of at least about 1.0 wt. % for a total weight of the component B, such as, at least about 1.5 wt. % or at least about 2.0 wt. % or at least about 2.5 wt. % or at least about 3.0 wt. % or at least about 3.5 wt. % or even at least about 4.0 wt. %. According to yet other embodiments, the component B may include a perlite content of not greater than about 15.0 wt. % for a total weight of the component B, such as, not greater than about 14.0 wt. % or not greater than about 13.0 wt. % or not greater than about 12.0 wt. % or even not greater than about 11.0 wt. %. It will be appreciated that the perlite content of the component B may be within a range between any of the values noted above. It will be further appreciated that the perlite content of the component B may be any value between any of the minimum and maximum values noted above.

According to still other embodiments, the third filler component of the component B may include calcium carbonate. According to still other embodiments, the third filler component of the component B may consist of calcium carbonate. According to yet other embodiments, the third filler component of the component B may be a calcium carbonate filler.

According to other embodiments, the component B may include a particular content of the third filler component. For example, the component B may include a third filler component content of at least about 1.0 wt. % for a total weight of the component B, such as, at least about 1.5 wt. % or at least about 2.0 wt. % or at least about 2.5 wt. % or at least about 3.0 wt. % or at least about 3.5 wt. % or even at least about 4.0 wt. %. According to yet other embodiments, the component B may include a third filler component content of not greater than about 20.0 wt. % for a total weight of the component B, such as, not greater than about 18.0 wt. % or not greater than about 16.0 wt. % or not greater than about 14 wt. % or even not greater than about 12.0 wt. %. It will be appreciated that the third filler component content of the component B may be within a range between any of the values noted above. It will be further appreciated that the third filler component content of the component B may be any value between any of the minimum and maximum values noted above.

According to other embodiments, the component B may include a particular content of calcium carbonate. For example, the component B may include a calcium carbonate content of at least about 1.0 wt. % for a total weight of the component B, such as, at least about 1.5 wt. % or at least about 2.0 wt. % or at least about 2.5 wt. % or at least about 3.0 wt. % or at least about 3.5 wt. % or even at least about 4.0 wt. %. According to yet other embodiments, the component B may include a calcium carbonate content of not greater than about 20.0 wt. % for a total weight of the component B, such as, not greater than about 18.0 wt. % or not greater than about 16.0 wt. % or not greater than about 14 wt. % or even not greater than about 12.0 wt. %. It will be appreciated that the calcium carbonate content of the component B may be within a range between any of the values noted above. It will be further appreciated that the calcium carbonate content of the component B may be any value between any of the minimum and maximum values noted above.

According to still other embodiments, the fourth filler component of the component B may include zinc borate. According to still other embodiments, the fourth filler component of the component B may consist of zinc borate. According to yet other embodiments, the fourth filler component of the component B may be a zinc borate filler.

According to other embodiments, the component B may include a particular content of the fourth filler component. For example, the component B may include a fourth filler component content of at least about 1.0 wt. % for a total weight of the component B, such as, at least about 1.5 wt. % or at least about 2.0 wt. % or at least about 2.5 wt. % or at least about 3.0 wt. % or at least about 3.5 wt. % or even at least about 4.0 wt. %. According to yet other embodiments, the component B may include a fourth filler component content of not greater than about 20.0 wt. % for a total weight of the component B, such as, not greater than about 18.0 wt. % or not greater than about 16.0 wt. % or not greater than about 14 wt. % or even not greater than about 12.0 wt. %. It will be appreciated that the fourth filler component content of the component B may be within a range between any of the values noted above. It will be further appreciated that the fourth filler component content of the component B may be any value between any of the minimum and maximum values noted above.

According to other embodiments, the component B may include a particular content of zinc borate. For example, the component B may include a zinc borate content of at least about 1.0 wt. % for a total weight of the component B, such as, at least about 1.5 wt. % or at least about 2.0 wt. % or at least about 2.5 wt. % or at least about 3.0 wt. % or at least about 3.5 wt. % or even at least about 4.0 wt. %. According to yet other embodiments, the component B may include a zinc borate content of not greater than about 20.0 wt. % for a total weight of the component B, such as, not greater than about 18.0 wt. % or not greater than about 16.0 wt. % or not greater than about 14 wt. % or even not greater than about 12.0 wt. %. It will be appreciated that the zinc borate content of the component B may be within a range between any of the values noted above. It will be further appreciated that the zinc borate content of the component B may be any value between any of the minimum and maximum values noted above.

According to still other embodiments, the component B may further include a vinyl-functional pre-polymer component.

According to other embodiments, the component B may include a particular content of the vinyl-functional pre-polymer component. For example, the component B may include a vinyl-functional pre-polymer component content of at least about 10.0 wt. % for a total weight of the component B, such as, at least about 11.0 wt. % or at least about 12.0 wt. % or at least about 13.0 wt. % or at least about 14.0 wt. % or at least about 15.0 wt. % or at least about 16.0 wt. % or at least about 17.0 wt. % or at least about 18.0 wt. % or at least about 19.0 wt. % or even at least about 20.0 wt. %. According to yet other embodiments, the component B may include a vinyl-functional pre-polymer component content of not greater than about 25.0 wt. % for a total weight of the component B, such as, not greater than about 24.0 wt. % or not greater than about 23.0 wt. % or not greater than about 22.0 wt. % or even not greater than about 21.0 wt. %. It will be appreciated that the vinyl-functional pre-polymer component content of the component B may be within a range between any of the values noted above. It will be further appreciated that the vinyl-functional pre-polymer component content of the component B may be any value between any of the minimum and maximum values noted above.

According to still other embodiments, the component B may further include a hydride functional crosslinker.

According to other embodiments, the component B may include a particular content of the hydride functional crosslinker. For example, the component B may include an hydride functional crosslinker content of at least about 5.0 wt. % for a total weight of the component B, such as, at least about 5.5 wt. % or at least about 6.0 wt. % or at least about 6.5 wt. % or at least about 7.0 wt. % or at least about 7.5 wt. % or at least about 8.0 wt. % or at least about 8.5 wt. % or even at least about 9.0 wt. %. According to yet other embodiments, the component B may include a hydride functional crosslinker content of not greater than about 15.0 wt. % for a total weight of the component B, such as, not greater than about 14.5 wt. % or not greater than about 14.0 wt. % or not greater than about 13.5 wt. % or even not greater than about 13.0 wt. %. It will be appreciated that the hydride functional crosslinker content of the component B may be within a range between any of the values noted above. It will be further appreciated that the hydride functional crosslinker content of the component B may be any value between any of the minimum and maximum values noted above.

According to still other embodiments, the component B may further include an inhibitor component.

According to other embodiments, the component B may include a particular content of the inhibitor component. For example, the component B may include an inhibitor component content of at least about 0.02 wt. % for a total weight of the component B, such as, at least about 0.04 wt. % or at least about 0.06 wt. % or at least about 0.08 wt. % or even at least about 0.1 wt. %. According to yet other embodiments, the component B may include an inhibitor component content of not greater than about 0.5 wt. % for a total weight of the component B, such as, not greater than about 0.45 wt. % or not greater than about 0.4 wt. % or not greater than about 0.35 wt. % or not greater than about 0.3 wt. % or not greater than about 0.25 wt. % or not greater than about 0.2 wt. % or not greater than about 0.15 wt. % or not greater than about 0.14 wt. % or not greater than about 0.13 wt. % or not greater than about 0.12 wt. % or even not greater than about 0.11 wt. %. It will be appreciated that the inhibitor component content of the component B may be within a range between any of the values noted above. It will be further appreciated that the inhibitor component content of the component B may be any value between any of the minimum and maximum values noted above.

Referring now to embodiments of the silicone-based foam formed according to forming method 200, the silicone-based foam may be described as including a component A and a component B.

Referring to the component A of the silicone-based foam, the component A may include a silicone-based matrix component, a first filler component, a second filler component, and a third filler component.

According to particular embodiments, the silicone-based matrix component of the component A may include additional components. For example, the silicone-based matrix component may include platinum (Pt). According to still other embodiments, the silicone-based be a platinum catalyzed silicone-based matrix component. According to still other embodiments, the silicone-based matrix component of the component A may include peroxide. According to still other embodiments, the silicone-based may be a peroxide catalyzed silicone-based matrix component. According to still other embodiments, the silicone-based matrix component of the component A may include tin. According to yet other embodiments, the silicone-based matrix component of the component A may include tin catalyzed silicone-based matrix component. According to still other embodiments, the silicone-based matrix component of the component A may include tris(pentafluorophenyl) borane. According to still other embodiments, the silicone-based matrix component of the component A may include a transient basic catalyst. According to still other embodiments, the silicone-based matrix component of the component A may include phosphoronitrile chloride. According to still other embodiments, the silicone-based matrix component of the component A may include ruthenium.

According to certain embodiments, the component A may include a particular content of the silicone-based matrix component. For example, the component A may include a silicone-based matrix component content of at least about 30 wt. % for a total weight of the component A, such as, at least about 32 wt. % or at least about 35 wt. % or at least about 37 wt. % or at least about 40 wt. % or at least about 42 wt. % or even at least about 45 wt. %. According to yet other embodiments, the component A may include a silicone-based matrix component content of not greater than about 60 wt. % for a total weight of the component A, such as, not greater than about 58 wt. % or not greater than about 55 wt. % or not greater than about 53 wt. % or even not greater than about 50 wt. %. It will be appreciated that the silicone-based matrix component content of the component A may be within a range between any of the values noted above. It will be further appreciated that the silicone-based matrix component content of the component A may be any value between any of the minimum and maximum values noted above.

According to certain embodiments, the first filler component of the component A may include alumina trihydrate. According to still other embodiments, the first filler component of the component A may consist of alumina trihydrate. According to yet other embodiments, the first filler component of the component A may be an alumina trihydrate filler.

According to other embodiments, the component A may include a particular content of the first filler component. For example, the component A may include a first filler component content of at least about 5.0 wt. % for a total weight of the component A, such as, at least about 5.5 wt. % or at least about 6.0 wt. % or at least about 6.5 wt. % or at least about 7.0 wt. % or at least about 7.5 wt. % or even at least about 8.0 wt. %. According to yet other embodiments, the component A may include a first filler component content of not greater than about 30.0 wt. % for a total weight of the component A, such as, not greater than about 28.0 wt. % or not greater than about 26.0 wt. % or not greater than about 24.0 wt. % or even not greater than about 22.0 wt. %. It will be appreciated that the first filler component content of the component A may be within a range between any of the values noted above. It will be further appreciated that the first filler component content of the component A may be any value between any of the minimum and maximum values noted above.

According to other embodiments, the component A may include a particular content of alumina trihydrate. For example, the component A may include an alumina trihydrate content of at least about 5.0 wt. % for a total weight of the component A, such as, at least about 5.5 wt. % or at least about 6.0 wt. % or at least about 6.5 wt. % or at least about 7.0 wt. % or at least about 7.5 wt. % or even at least about 8.0 wt. %. According to yet other embodiments, the component A may include an alumina trihydrate content of not greater than about 30.0 wt. % for a total weight of the component A, such as, not greater than about 28.0 wt. % or not greater than about 26.0 wt. % or not greater than about 24.0 wt. % or even not greater than about 22.0 wt. %. It will be appreciated that the alumina trihydrate content of the component A may be within a range between any of the values noted above. It will be further appreciated that the alumina trihydrate content of the component A may be any value between any of the minimum and maximum values noted above.

According to still other embodiments, the second filler component of the component A may include perlite. According to still other embodiments, the second filler component of the component A may consist of perlite. According to yet other embodiments, the second filler component of the component A may be a perlite filler.

According to other embodiments, the component A may include a particular content of the second filler component. For example, the component A may include a second filler component content of at least about 1.0 wt. % for a total weight of the component A, such as, at least about 1.5 wt. % or at least about 2.0 wt. % or at least about 2.5 wt. % or at least about 3.0 wt. % or at least about 3.5 wt. % or even at least about 4.0 wt. %. According to yet other embodiments, the component A may include a second filler component content of not greater than about 15.0 wt. % for a total weight of the component A, such as, not greater than about 14.0 wt. % or not greater than about 13.0 wt. % or not greater than about 12.0 wt. % or even not greater than about 11.0 wt. %. It will be appreciated that the second filler component content of the component A may be within a range between any of the values noted above. It will be further appreciated that the second filler component content of the component A may be any value between any of the minimum and maximum values noted above.

According to other embodiments, the component A may include a particular content of perlite. For example, the component A may include a perlite content of at least about 1.0 wt. % for a total weight of the component A, such as, at least about 1.5 wt. % or at least about 2.0 wt. % or at least about 2.5 wt. % or at least about 3.0 wt. % or at least about 3.5 wt. % or even at least about 4.0 wt. %. According to yet other embodiments, the component A may include a perlite content of not greater than about 15.0 wt. % for a total weight of the component A, such as, not greater than about 14.0 wt. % or not greater than about 13.0 wt. % or not greater than about 12.0 wt. % or even not greater than about 11.0 wt. %. It will be appreciated that the perlite content of the component A may be within a range between any of the values noted above. It will be further appreciated that the perlite content of the component A may be any value between any of the minimum and maximum values noted above.

According to still other embodiments, the third filler component of the component A may include calcium carbonate. According to still other embodiments, the third filler component of the component A may consist of calcium carbonate. According to yet other embodiments, the third filler component of the component A may be a calcium carbonate filler.

According to other embodiments, the component A may include a particular content of the third filler component. For example, the component A may include a third filler component content of at least about 1.0 wt. % for a total weight of the component A, such as, at least about 1.5 wt. % or at least about 2.0 wt. % or at least about 2.5 wt. % or at least about 3.0 wt. % or at least about 3.5 wt. % or even at least about 4.0 wt. %. According to yet other embodiments, the component A may include a third filler component content of not greater than about 20.0 wt. % for a total weight of the component A, such as, not greater than about 18.0 wt. % or not greater than about 16.0 wt. % or not greater than about 14 wt. % or even not greater than about 12.0 wt. %. It will be appreciated that the third filler component content of the component A may be within a range between any of the values noted above. It will be further appreciated that the third filler component content of the component A may be any value between any of the minimum and maximum values noted above.

According to other embodiments, the component A may include a particular content of calcium carbonate. For example, the component A may include a calcium carbonate content of at least about 1.0 wt. % for a total weight of the component A, such as, at least about 1.5 wt. % or at least about 2.0 wt. % or at least about 2.5 wt. % or at least about 3.0 wt. % or at least about 3.5 wt. % or even at least about 4.0 wt. %. According to yet other embodiments, the component A may include a calcium carbonate content of not greater than about 20.0 wt. % for a total weight of the component A, such as, not greater than about 18.0 wt. % or not greater than about 16.0 wt. % or not greater than about 14 wt. % or even not greater than about 12.0 wt. %. It will be appreciated that the calcium carbonate content of the component A may be within a range between any of the values noted above. It will be further appreciated that the calcium carbonate content of the component A may be any value between any of the minimum and maximum values noted above.

According to still other embodiments, the component A may further include a pigment component.

According to other embodiments, the component A may include a particular content of the pigment component. For example, the component A may include a pigment component content of at least about 1.0 wt. % for a total weight of the component A, such as, at least about 1.5 wt. % or at least about 2.0 wt. % or even at least about 2.5 wt. %. According to yet other embodiments, the component A may include a pigment component content of not greater than about 5.0 wt. % for a total weight of the component A, such as, not greater than about 4.5 wt. % or not greater than about 4.0 wt. % or not greater than about 3.5 wt. % or even not greater than about 3.0 wt. %. It will be appreciated that the pigment component content of the component A may be within a range between any of the values noted above. It will be further appreciated that the pigment component content of the component A may be any value between any of the minimum and maximum values noted above.

According to still other embodiments, the component A may further include a vinyl-functional pre-polymer component.

According to other embodiments, the component A may include a particular content of the vinyl-functional pre-polymer component. For example, the component A may include a vinyl-functional pre-polymer component content of at least about 10.0 wt. % for a total weight of the component A, such as, at least about 11.0 wt. % or at least about 12.0 wt. % or at least about 13.0 wt. % or at least about 14.0 wt. % or at least about 15.0 wt. % or at least about 16.0 wt. % or at least about 17.0 wt. % or at least about 18.0 wt. % or at least about 19.0 wt. % or even at least about 20.0 wt. %. According to yet other embodiments, the component A may include a vinyl-functional pre-polymer component content of not greater than about 30.0 wt. % for a total weight of the component A, such as, not greater than about 29.0 wt. % or not greater than about 28.0 wt. % or not greater than about 27.0 wt. % or even not greater than about 26.0 wt. %. It will be appreciated that the vinyl-functional pre-polymer component content of the component A may be within a range between any of the values noted above. It will be further appreciated that the vinyl-functional pre-polymer component content of the component A may be any value between any of the minimum and maximum values noted above.

According to still other embodiments, the component A may further include an alcohol-blowing agent.

According to other embodiments, the component A may include a particular content of the alcohol-blowing agent. For example, the component A may include an alcohol blowing agent content of at least about 1.0 wt. % for a total weight of the component A, such as, at least about 1.5 wt. % or at least about 2.0 wt. % or at least about 2.5 wt. % or at least about 3.0 wt. % or at least about 3.5 wt. % or at least about 4.0 wt. % or at least about 4.5 wt. % or even at least about 4.5 wt. %. According to yet other embodiments, the component A may include an alcohol blowing agent content of not greater than about 10.0 wt. % for a total weight of the component A, such as, not greater than about 9.5 wt. % or not greater than about 9.0 wt. % or not greater than about 8.5 wt. % or even not greater than about 8.0 wt. %. It will be appreciated that the alcohol blowing agent content of the component A may be within a range between any of the values noted above. It will be further appreciated that the alcohol blowing agent content of the component A may be any value between any of the minimum and maximum values noted above.

According to still other embodiments, the component A may further include a resin solution.

According to other embodiments, the component A may include a particular content of the resin solution. For example, the component A may include a resin solution content of at least about 5.0 wt. % for a total weight of the component A, such as, at least about 6.0 wt. % or at least about 7.0 wt. % or at least about 8.0 wt. % or at least about 9.0 wt. % or at least about 10.0 wt. % or at least about 11.0 wt. % or at least about 12.0 wt. % or even at least about 13.0 wt. %. According to yet other embodiments, the component A may include a resin solution content of not greater than about 25.0 wt. % for a total weight of the component A, such as, not greater than about 24.0 wt. % or not greater than about 23.0 wt. % or not greater than about 22.0 wt. % or even not greater than about 21.0 wt. %. It will be appreciated that the resin solution content of the component A may be within a range between any of the values noted above. It will be further appreciated that the resin solution content of the component A may be any value between any of the minimum and maximum values noted above.

According to still other embodiments, the component A may further include a PT catalyst component.

According to other embodiments, the component A may include a particular content of the PT catalyst component. For example, the component A may include a PT catalyst component content of at least about 0.02 wt. % for a total weight of the component A, such as, at least about 0.04 wt. % or at least about 0.06 wt. % or at least about 0.08 wt. % or even at least about 0.1 wt. %. According to yet other embodiments, the component A may include a PT catalyst component content of not greater than about 0.15 wt. % for a total weight of the component A, such as, not greater than about 0.14 wt. % or not greater than about 0.13 wt. % or not greater than about 0.12 wt. % or even not greater than about 0.11 wt. %. It will be appreciated that the PT catalyst component content of the component A may be within a range between any of the values noted above. It will be further appreciated that the PT catalyst component content of the component A may be any value between any of the minimum and maximum values noted above.

Referring to the component B of the silicone-based foam, the component B may include a silicone-based matrix component, a first filler component, a second filler component, a third filler component, and a fourth filler component.

According to particular embodiments, the silicone-based matrix component of the component B may include additional components. For example, the silicone-based matrix component may include platinum (Pt). According to still other embodiments, the silicone-based be a platinum catalyzed silicone-based matrix component. According to still other embodiments, the silicone-based matrix component of the component B may include peroxide. According to still other embodiments, the silicone-based may be a peroxide catalyzed silicone-based matrix component. According to still other embodiments, the silicone-based matrix component of the component B may include tin. According to yet other embodiments, the silicone-based matrix component of the component B may include tin catalyzed silicone-based matrix component. According to still other embodiments, the silicone-based matrix component of the component B may include tris(pentafluorophenyl) borane. According to still other embodiments, the silicone-based matrix component of the component B may include a transient basic catalyst. According to still other embodiments, the silicone-based matrix component of the component B may include phosphoronitrile chloride. According to still other embodiments, the silicone-based matrix component of the component B may include ruthenium.

According to certain embodiments, the component B may include a particular content of the silicone-based matrix component. For example, the component B may include a silicone-based matrix component content of at least about 20 wt. % for a total weight of the component B, such as, at least about 22 wt. % or at least about 25 wt. % or at least about 27 wt. % or at least about 30 wt. % or at least about 32 wt. % or even at least about 35 wt. %. According to yet other embodiments, the component B may include a silicone-based matrix component content of not greater than about 50 wt. % for a total weight of the component B, such as, not greater than about 48 wt. % or not greater than about 45 wt. % or not greater than about 43 wt. % or even not greater than about 40 wt. %. It will be appreciated that the silicone-based matrix component content of the component B may be within a range between any of the values noted above. It will be further appreciated that the silicone-based matrix component content of the component B may be any value between any of the minimum and maximum values noted above.

According to certain embodiments, the first filler component of the component B may include alumina trihydrate. According to still other embodiments, the first filler component of the component B may consist of alumina trihydrate. According to yet other embodiments, the first filler component of the component B may be an alumina trihydrate filler.

According to other embodiments, the component B may include a particular content of the first filler component. For example, the component B may include a first filler component content of at least about 5.0 wt. % for a total weight of the component B, such as, at least about 5.5 wt. % or at least about 6.0 wt. % or at least about 6.5 wt. % or at least about 7.0 wt. % or at least about 7.5 wt. % or even at least about 8.0 wt. %. According to yet other embodiments, the component B may include a first filler component content of not greater than about 30.0 wt. % for a total weight of the component B, such as, not greater than about 25.0 wt. % or not greater than about 20.0 wt. % or not greater than about 15.0 wt. % or even not greater than about 10.0 wt. %. It will be appreciated that the first filler component content of the component B may be within a range between any of the values noted above. It will be further appreciated that the first filler component content of the component B may be any value between any of the minimum and maximum values noted above.

According to other embodiments, the component B may include a particular content of alumina trihydrate. For example, the component B may include an alumina trihydrate content of at least about 5.0 wt. % for a total weight of the component B, such as, at least about 5.5 wt. % or at least about 6.0 wt. % or at least about 6.5 wt. % or at least about 7.0 wt. % or at least about 7.5 wt. % or even at least about 8.0 wt. %. According to yet other embodiments, the component B may include an alumina trihydrate content of not greater than about 30.0 wt. % for a total weight of the component B, such as, not greater than about 25.0 wt. % or not greater than about 20.0 wt. % or not greater than about 15.0 wt. % or even not greater than about 10.0 wt. %. It will be appreciated that the alumina trihydrate content of the component B may be within a range between any of the values noted above. It will be further appreciated that the alumina trihydrate content of the component B may be any value between any of the minimum and maximum values noted above.

According to still other embodiments, the second filler component of the component B may include perlite. According to still other embodiments, the second filler component of the component B may consist of perlite. According to yet other embodiments, the second filler component of the component B may be a perlite filler.

According to other embodiments, the component B may include a particular content of the second filler component. For example, the component B may include a second filler component content of at least about 1.0 wt. % for a total weight of the component B, such as, at least about 1.5 wt. % or at least about 2.0 wt. % or at least about 2.5 wt. % or at least about 3.0 wt. % or at least about 3.5 wt. % or even at least about 4.0 wt. %. According to yet other embodiments, the component B may include a second filler component content of not greater than about 15.0 wt. % for a total weight of the component B, such as, not greater than about 14.0 wt. % or not greater than about 13.0 wt. % or not greater than about 12.0 wt. % or even not greater than about 11.0 wt. %. It will be appreciated that the second filler component content of the component B may be within a range between any of the values noted above. It will be further appreciated that the second filler component content of the component B may be any value between any of the minimum and maximum values noted above.

According to other embodiments, the component B may include a particular content of perlite. For example, the component B may include a perlite content of at least about 1.0 wt. % for a total weight of the component B, such as, at least about 1.5 wt. % or at least about 2.0 wt. % or at least about 2.5 wt. % or at least about 3.0 wt. % or at least about 3.5 wt. % or even at least about 4.0 wt. %. According to yet other embodiments, the component B may include a perlite content of not greater than about 15.0 wt. % for a total weight of the component B, such as, not greater than about 14.0 wt. % or not greater than about 13.0 wt. % or not greater than about 12.0 wt. % or even not greater than about 11.0 wt. %. It will be appreciated that the perlite content of the component B may be within a range between any of the values noted above. It will be further appreciated that the perlite content of the component B may be any value between any of the minimum and maximum values noted above.

According to still other embodiments, the third filler component of the component B may include calcium carbonate. According to still other embodiments, the third filler component of the component B may consist of calcium carbonate. According to yet other embodiments, the third filler component of the component B may be a calcium carbonate filler.

According to other embodiments, the component B may include a particular content of the third filler component. For example, the component B may include a third filler component content of at least about 1.0 wt. % for a total weight of the component B, such as, at least about 1.5 wt. % or at least about 2.0 wt. % or at least about 2.5 wt. % or at least about 3.0 wt. % or at least about 3.5 wt. % or even at least about 4.0 wt. %. According to yet other embodiments, the component B may include a third filler component content of not greater than about 20.0 wt. % for a total weight of the component B, such as, not greater than about 18.0 wt. % or not greater than about 16.0 wt. % or not greater than about 14 wt. % or even not greater than about 12.0 wt. %. It will be appreciated that the third filler component content of the component B may be within a range between any of the values noted above. It will be further appreciated that the third filler component content of the component B may be any value between any of the minimum and maximum values noted above.

According to other embodiments, the component B may include a particular content of calcium carbonate. For example, the component B may include a calcium carbonate content of at least about 1.0 wt. % for a total weight of the component B, such as, at least about 1.5 wt. % or at least about 2.0 wt. % or at least about 2.5 wt. % or at least about 3.0 wt. % or at least about 3.5 wt. % or even at least about 4.0 wt. %. According to yet other embodiments, the component B may include a calcium carbonate content of not greater than about 20.0 wt. % for a total weight of the component B, such as, not greater than about 18.0 wt. % or not greater than about 16.0 wt. % or not greater than about 14 wt. % or even not greater than about 12.0 wt. %. It will be appreciated that the calcium carbonate content of the component B may be within a range between any of the values noted above. It will be further appreciated that the calcium carbonate content of the component B may be any value between any of the minimum and maximum values noted above.

According to still other embodiments, the fourth filler component of the component B may include zinc borate. According to still other embodiments, the fourth filler component of the component B may consist of zinc borate. According to yet other embodiments, the fourth filler component of the component B may be a zinc borate filler.

According to other embodiments, the component B may include a particular content of the fourth filler component. For example, the component B may include a fourth filler component content of at least about 1.0 wt. % for a total weight of the component B, such as, at least about 1.5 wt. % or at least about 2.0 wt. % or at least about 2.5 wt. % or at least about 3.0 wt. % or at least about 3.5 wt. % or even at least about 4.0 wt. %. According to yet other embodiments, the component B may include a fourth filler component content of not greater than about 20.0 wt. % for a total weight of the component B, such as, not greater than about 18.0 wt. % or not greater than about 16.0 wt. % or not greater than about 14 wt. % or even not greater than about 12.0 wt. %. It will be appreciated that the fourth filler component content of the component B may be within a range between any of the values noted above. It will be further appreciated that the fourth filler component content of the component B may be any value between any of the minimum and maximum values noted above.

According to other embodiments, the component B may include a particular content of zinc borate. For example, the component B may include a zinc borate content of at least about 1.0 wt. % for a total weight of the component B, such as, at least about 1.5 wt. % or at least about 2.0 wt. % or at least about 2.5 wt. % or at least about 3.0 wt. % or at least about 3.5 wt. % or even at least about 4.0 wt. %. According to yet other embodiments, the component B may include a zinc borate content of not greater than about 20.0 wt. % for a total weight of the component B, such as, not greater than about 18.0 wt. % or not greater than about 16.0 wt. % or not greater than about 14 wt. % or even not greater than about 12.0 wt. %. It will be appreciated that the zinc borate content of the component B may be within a range between any of the values noted above. It will be further appreciated that the zinc borate content of the component B may be any value between any of the minimum and maximum values noted above.

According to still other embodiments, the component B may further include a vinyl-functional pre-polymer component.

According to other embodiments, the component B may include a particular content of the vinyl-functional pre-polymer component. For example, the component B may include a vinyl-functional pre-polymer component content of at least about 10.0 wt. % for a total weight of the component B, such as, at least about 11.0 wt. % or at least about 12.0 wt. % or at least about 13.0 wt. % or at least about 14.0 wt. % or at least about 15.0 wt. % or at least about 16.0 wt. % or at least about 17.0 wt. % or at least about 18.0 wt. % or at least about 19.0 wt. % or even at least about 20.0 wt. %. According to yet other embodiments, the component B may include a vinyl-functional pre-polymer component content of not greater than about 25.0 wt. % for a total weight of the component B, such as, not greater than about 24.0 wt. % or not greater than about 23.0 wt. % or not greater than about 22.0 wt. % or even not greater than about 21.0 wt. %. It will be appreciated that the vinyl-functional pre-polymer component content of the component B may be within a range between any of the values noted above. It will be further appreciated that the vinyl-functional pre-polymer component content of the component B may be any value between any of the minimum and maximum values noted above.

According to still other embodiments, the component B may further include a hydride functional crosslinker.

According to other embodiments, the component B may include a particular content of the hydride functional crosslinker. For example, the component B may include an hydride functional crosslinker content of at least about 5.0 wt. % for a total weight of the component B, such as, at least about 5.5 wt. % or at least about 6.0 wt. % or at least about 6.5 wt. % or at least about 7.0 wt. % or at least about 7.5 wt. % or at least about 8.0 wt. % or at least about 8.5 wt. % or even at least about 9.0 wt. %. According to yet other embodiments, the component B may include a hydride functional crosslinker content of not greater than about 15.0 wt. % for a total weight of the component B, such as, not greater than about 14.5 wt. % or not greater than about 14.0 wt. % or not greater than about 13.5 wt. % or even not greater than about 13.0 wt. %. It will be appreciated that the hydride functional crosslinker content of the component B may be within a range between any of the values noted above. It will be further appreciated that the hydride functional crosslinker content of the component B may be any value between any of the minimum and maximum values noted above.

According to still other embodiments, the component B may further include an Inhibitor component.

According to other embodiments, the component B may include a particular content of the inhibitor component. For example, the component B may include an inhibitor component content of at least about 0.02 wt. % for a total weight of the component B, such as, at least about 0.04 wt. % or at least about 0.06 wt. % or at least about 0.08 wt. % or even at least about 0.1 wt. %. According to yet other embodiments, the component B may include an inhibitor component content of not greater than about 0.5 wt. % for a total weight of the component B, such as, not greater than about 0.45 wt. % or not greater than about 0.4 wt. % or not greater than about 0.35 wt. % or not greater than about 0.3 wt. % or not greater than about 0.25 wt. % or not greater than about 0.2 wt. % or not greater than about 0.15 wt. % or not greater than about 0.14 wt. % or not greater than about 0.13 wt. % or not greater than about 0.12 wt. % or even not greater than about 0.11 wt. %. It will be appreciated that the inhibitor component content of the component B may be within a range between any of the values noted above. It will be further appreciated that the inhibitor component content of the component B may be any value between any of the minimum and maximum values noted above.

Referring now to other embodiments of the silicone-based foam formed according to forming method 200, the silicone-based foam may be described as including a silicone-based matrix component, a first filler component, a second filler component, a third filler component, and a fourth filler component.

According to particular embodiments, the silicone-based matrix component of the silicone-based foam may include additional components. For example, the silicone-based matrix component may include platinum (Pt). According to still other embodiments, the silicone-based be a platinum catalyzed silicone-based matrix component. According to still other embodiments, the silicone-based matrix component of the silicone-based foam may include peroxide. According to still other embodiments, the silicone-based may be a peroxide catalyzed silicone-based matrix component. According to still other embodiments, the silicone-based matrix component of the silicone-based foam may include tin. According to yet other embodiments, the silicone-based matrix component of the silicone-based foam may include tin catalyzed silicone-based matrix component. According to still other embodiments, the silicone-based matrix component of the silicone-based foam may include tris(pentafluorophenyl) borane. According to still other embodiments, the silicone-based matrix component of the silicone-based foam may include a transient basic catalyst. According to still other embodiments, the silicone-based matrix component of the silicone-based foam may include phosphoronitrile chloride. According to still other embodiments, the silicone-based matrix component of the silicone-based foam may include ruthenium.

According to certain embodiments, the silicone-based foam may include a particular content of the silicone-based matrix component. For example, the silicone-based foam may include a silicone-based matrix component content of at least about 25.0 wt. % for a total weight of the silicone-based foam, such as, at least about 27.0 wt. % or at least about 30.0 wt. % or at least about 32.0 wt. % or at least about 35.0 wt. % or at least about 37.0 wt. % or even at least about 40.0 wt. %. According to yet other embodiments, the silicone-based foam may include a silicone-based matrix component content of not greater than about 55.0 wt. % for a total weight of the silicone-based foam, such as, not greater than about 53.0 wt. % or not greater than about 50.0 wt. % or not greater than about 48.0 wt. % or even not greater than about 45.0 wt. %. It will be appreciated that the silicone-based matrix component content of the silicone-based foam may be within a range between any of the values noted above. It will be further appreciated that the silicone-based matrix component content of the silicone-based foam may be any value between any of the minimum and maximum values noted above.

According to yet other embodiments, the first filler component of the silicone-based foam may include alumina trihydrate. According to still other embodiments, the first filler component of the silicone-based foam may consist of alumina trihydrate. According to yet other embodiments, the first filler component of the silicone-based foam may be an alumina trihydrate filler.

According to other embodiments, the silicone-based foam may include a particular content of the first filler component. For example, the silicone-based foam may include a first filler component content of at least about 5.0 wt. % for a total weight of the silicone-based foam, such as, at least about 6.0 wt. % or at least about 7.0 wt. % or at least about 8.0 wt. % or at least about 9.0 wt. % or at least about 10.0 wt. % or even at least about 11.0 wt. %. According to yet other embodiments, the silicone-based foam may include a first filler component content of not greater than about 30.0 wt. % for a total weight of the silicone-based foam, such as, not greater than about 28.0 wt. % or not greater than about 26.0 wt. % or not greater than about 24.0 wt. % or even not greater than about 22.0 wt. %. It will be appreciated that the first filler component content of the silicone-based foam may be within a range between any of the values noted above. It will be further appreciated that the first filler component content of the silicone-based foam may be any value between any of the minimum and maximum values noted above.

According to other embodiments, the silicone-based foam may include a particular content of alumina trihydrate. For example, the silicone-based foam may include an alumina trihydrate content of at least about 5.0 wt. % for a total weight of the silicone-based foam, such as, at least about 6.0 wt. % or at least about 7.0 wt. % or at least about 8.0 wt. % or at least about 9.0 wt. % or at least about 10.0 wt. % or even at least about 11.0 wt. %. According to yet other embodiments, the silicone-based foam may include an alumina trihydrate content of not greater than about 30.0 wt. % for a total weight of the silicone-based foam, such as, not greater than about 28.0 wt. % or not greater than about 26.0 wt. % or not greater than about 24.0 wt. % or even not greater than about 22.0 wt. %. It will be appreciated that the alumina trihydrate content of the silicone-based foam may be within a range between any of the values noted above. It will be further appreciated that the alumina trihydrate content of the silicone-based foam may be any value between any of the minimum and maximum values noted above.

According to still other embodiments, the second filler component of the silicone-based foam may include perlite. According to still other embodiments, the second filler component of the silicone-based foam may consist of perlite. According to yet other embodiments, the second filler component of the silicone-based foam may be a perlite filler.

According to other embodiments, the silicone-based foam may include a particular content of the second filler component. For example, the silicone-based foam may include a second filler component content of at least about 1.0 wt. % for a total weight of the silicone-based foam, such as, at least about 1.5 wt. % or at least about 2.0 wt. % or at least about 2.5 wt. % or at least about 3.0 wt. % or at least about 3.5 wt. % or even at least about 4.0 wt. %. According to yet other embodiments, the silicone-based foam may include a second filler component content of not greater than about 15.0 wt. % for a total weight of the silicone-based foam, such as, not greater than about 14 wt. % or not greater than about 13.0 wt. % or not greater than about 12.0 wt. % or even not greater than about 110 wt. %. It will be appreciated that the second filler component content of the silicone-based foam may be within a range between any of the values noted above. It will be further appreciated that the second filler component content of the silicone-based foam may be any value between any of the minimum and maximum values noted above.

According to other embodiments, the silicone-based foam may include a particular content of perlite. For example, the silicone-based foam may include a perlite content of at least about 1.0 wt. % for a total weight of the silicone-based foam, such as, at least about 1.5 wt. % or at least about 2.0 wt. % or at least about 2.5 wt. % or at least about 3.0 wt. % or at least about 3.5 wt. % or even at least about 4.0 wt. %. According to yet other embodiments, the silicone-based foam may include a perlite content of not greater than about 15.0 wt. % for a total weight of the silicone-based foam, such as, not greater than about 14 wt. % or not greater than about 13.0 wt. % or not greater than about 12.0 wt. % or even not greater than about 110 wt. %. It will be appreciated that the perlite content of the silicone-based foam may be within a range between any of the values noted above. It will be further appreciated that the perlite content of the silicone-based foam may be any value between any of the minimum and maximum values noted above.

According to still other embodiments, the third filler component of the silicone-based foam may include calcium carbonate. According to still other embodiments, the third filler component of the silicone-based foam may consist of calcium carbonate. According to yet other embodiments, the third filler component of the silicone-based foam may be a calcium carbonate filler.

According to other embodiments, the silicone-based foam may include a particular content of the third filler component. For example, the silicone-based foam may include a third filler component content of at least about 1.0 wt. % for a total weight of the silicone-based foam, such as, at least about 1.5 wt. % or at least about 2.0 wt. % or at least about 2.5 wt. % or at least about 3.0 wt. % or at least about 3.5 wt. % or even at least about 4.0 wt. %. According to yet other embodiments, the silicone-based foam may include a third filler component content of not greater than about 20.0 wt. % for a total weight of the silicone-based foam, such as, not greater than about 18 wt. % or not greater than about 16.0 wt. % or not greater than about 15.0 wt. % or even not greater than about 14.0 wt. %. It will be appreciated that the third filler component content of the silicone-based foam may be within a range between any of the values noted above. It will be further appreciated that the third filler component content of the silicone-based foam may be any value between any of the minimum and maximum values noted above.

According to other embodiments, the silicone-based foam may include a particular content of calcium carbonate. For example, the silicone-based foam may include a calcium carbonate content of at least about 1.0 wt. % for a total weight of the silicone-based foam, such as, at least about 1.5 wt. % or at least about 2.0 wt. % or at least about 2.5 wt. % or at least about 3.0 wt. % or at least about 3.5 wt. % or even at least about 4.0 wt. %. According to yet other embodiments, the silicone-based foam may include a calcium carbonate content of not greater than about 20.0 wt. % for a total weight of the silicone-based foam, such as, not greater than about 18 wt. % or not greater than about 16.0 wt. % or not greater than about 15.0 wt. % or even not greater than about 14.0 wt. %. It will be appreciated that the calcium carbonate content of the silicone-based foam may be within a range between any of the values noted above. It will be further appreciated that the calcium carbonate content of the silicone-based foam may be any value between any of the minimum and maximum values noted above.

According to still other embodiments, the fourth filler component of the silicone-based foam may include zinc borate. According to still other embodiments, the fourth filler component of the silicone-based foam may consist of zinc borate. According to yet other embodiments, the fourth filler component of the silicone-based foam may be a zinc borate filler.

According to other embodiments, the silicone-based foam may include a particular content of the fourth filler component. For example, the silicone-based foam may include a fourth filler component content of at least about 1.0 wt. % for a total weight of the silicone-based foam, such as, at least about 1.5 wt. % or at least about 2.0 wt. % or even at least about 2.5 wt. %. According to yet other embodiments, the silicone-based foam may include a fourth filler component content of not greater than about 20.0 wt. % for a total weight of the component B, such as, not greater than about 18.0 wt. % or not greater than about 16.0 wt. % or not greater than about 14 wt. % or even not greater than about 12.0 wt. %. It will be appreciated that the fourth filler component content of the silicone-based foam may be within a range between any of the values noted above. It will be further appreciated that the fourth filler component content of the silicone-based foam may be any value between any of the minimum and maximum values noted above.

According to other embodiments, the silicone-based foam may include a particular content of zinc borate. For example, the silicone-based foam may include a zinc borate content of at least about 1.0 wt. % for a total weight of the silicone-based foam, such as, at least about 1.5 wt. % or at least about 2.0 wt. % or even at least about 2.5 wt. %. According to yet other embodiments, the silicone-based foam may include a zinc borate content of not greater than about 10.0 wt. % for a total weight of the silicone-based foam, such as, not greater than about 9.0 wt. % or not greater than about 8.0 wt. % or not greater than about 7.0 wt. % or even not greater than about 6.0 wt. %. It will be appreciated that the zinc borate content of the silicone-based foam may be within a range between any of the values noted above. It will be further appreciated that the zinc borate content of the silicone-based foam may be any value between any of the minimum and maximum values noted above.

According to still other embodiments, the silicone-based foam may further include a pigment component.

According to other embodiments, the silicone-based foam may include a particular content of the pigment component. For example, the silicone-based foam may include a pigment component content of at least about 0.5 wt. % for a total weight of the silicone-based foam, such as, at least about 0.7 wt. % or at least about 1.0 wt. % or even at least about 1.2 wt. %. According to yet other embodiments, the silicone-based foam may include a pigment component content of not greater than about 2.5 wt. % for a total weight of the silicone-based foam, such as, not greater than about 2.3 wt. % or not greater than about 2.0 wt. % or not greater than about 1.8 wt. % or even not greater than about 1.5 wt. %. It will be appreciated that the pigment component content of the silicone-based foam may be within a range between any of the values noted above. It will be further appreciated that the pigment component content of the silicone-based foam may be any value between any of the minimum and maximum values noted above.

According to still other embodiments, the silicone-based foam may further include a vinyl-functional pre-polymer component.

According to other embodiments, the silicone-based foam may include a particular content of the vinyl-functional pre-polymer component. For example, the silicone-based foam may include a vinyl-functional pre-polymer component content of at least about 10.0 wt. % for a total weight of the silicone-based foam, such as, at least about 11.0 wt. % or at least about 12.0 wt. % or at least about 13.0 wt. % or at least about 14.0 wt. % or at least about 15.0 wt. % or at least about 16.0 wt. % or at least about 17.0 wt. % or at least about 18.0 wt. % or at least about 19.0 wt. % or even at least about 20.0 wt. %. According to yet other embodiments, the silicone-based foam may include a vinyl-functional pre-polymer component content of not greater than about 30.0 wt. % for a total weight of the silicone-based foam, such as, not greater than about 29.0 wt. % or not greater than about 28.0 wt. % or not greater than about 27.0 wt. % or even not greater than about 26.0 wt. %. It will be appreciated that the vinyl-functional pre-polymer component content of the silicone-based foam may be within a range between any of the values noted above. It will be further appreciated that the vinyl-functional pre-polymer component content of the silicone-based foam may be any value between any of the minimum and maximum values noted above.

According to still other embodiments, the silicone-based foam may further include an alcohol-blowing agent.

According to other embodiments, the silicone-based foam may include a particular content of the alcohol-blowing agent. For example, the silicone-based foam may include an alcohol blowing agent content of at least about 0.5 wt. % for a total weight of the silicone-based foam, such as, at least about 0.7 wt. % or at least about 1.0 wt. % or at least about 1.2 wt. % or at least about 1.5 wt. % or at least about 1.7 wt. % or at least about 2.0 wt. % or at least about 2.2 wt. % or even at least about 2.5 wt. %. According to yet other embodiments, the silicone-based foam may include an alcohol blowing agent content of not greater than about 5.0 wt. % for a total weight of the silicone-based foam, such as, not greater than about 4.8 wt. % or not greater than about 4.5 wt. % or not greater than about 4.3 wt. % or even not greater than about 4.0 wt. %. It will be appreciated that the alcohol blowing agent content of the silicone-based foam may be within a range between any of the values noted above. It will be further appreciated that the alcohol blowing agent content of the silicone-based foam may be any value between any of the minimum and maximum values noted above.

According to still other embodiments, the silicone-based foam may further include a resin solution.

According to other embodiments, the silicone-based foam may include a particular content of the resin solution. For example, the silicone-based foam may include a resin solution content of at least about 2.5 wt. % for a total weight of the silicone-based foam, such as, at least about 2.7 wt. % or at least about 3.0 wt. % or at least about 3.2 wt. % or at least about 3.5 wt. % or at least about 3.7 wt. % or at least about 4.0 wt. % or at least about 4.2 wt. % or even at least about 4.5 wt. %. According to yet other embodiments, the silicone-based foam may include a resin solution content of not greater than about 13.0 wt. % for a total weight of the silicone-based foam, such as, not greater than about 12.0 wt. % or not greater than about 11.0 wt. % or not greater than about 10.0 wt. % or even not greater than about 9.0 wt. %. It will be appreciated that the resin solution content of the silicone-based foam may be within a range between any of the values noted above. It will be further appreciated that the resin solution content of the silicone-based foam may be any value between any of the minimum and maximum values noted above.

According to still other embodiments, the silicone-based foam may further include a PT catalyst component.

According to other embodiments, the silicone-based foam may include a particular content of the PT catalyst component. For example, the silicone-based foam may include a PT catalyst component content of at least about 0.02 wt. % for a total weight of the silicone-based foam, such as, at least about 0.04 wt. % or at least about 0.06 wt. % or at least about 0.08 wt. % or even at least about 0.1 wt. %. According to yet other embodiments, the silicone-based foam may include a PT catalyst component content of not greater than about 0.15 wt. % for a total weight of the silicone-based foam, such as, not greater than about 0.14 wt. % or not greater than about 0.13 wt. % or not greater than about 0.12 wt. % or even not greater than about 0.11 wt. %. It will be appreciated that the PT catalyst component content of the silicone-based foam may be within a range between any of the values noted above. It will be further appreciated that the PT catalyst component content of the silicone-based foam may be any value between any of the minimum and maximum values noted above.

According to still other embodiments, the silicone-based foam may further include a hydride functional crosslinker.

According to other embodiments, the silicone-based foam may include a particular content of the hydride functional crosslinker. For example, the silicone-based foam may include an hydride functional crosslinker content of at least about 5.0 wt. % for a total weight of the silicone-based foam, such as, at least about 5.5 wt. % or at least about 6.0 wt. % or at least about 6.5 wt. % or at least about 7.0 wt. % or at least about 7.5 wt. % or at least about 8.0 wt. % or at least about 8.5 wt. % or even at least about 9.0 wt. %. According to yet other embodiments, the silicone-based foam may include a hydride functional crosslinker content of not greater than about 15.0 wt. % for a total weight of the silicone-based foam, such as, not greater than about 14.5 wt. % or not greater than about 14.0 wt. % or not greater than about 13.5 wt. % or even not greater than about 13.0 wt. %. It will be appreciated that the hydride functional crosslinker content of the silicone-based foam may be within a range between any of the values noted above. It will be further appreciated that the hydride functional crosslinker content of the silicone-based foam may be any value between any of the minimum and maximum values noted above.

According to still other embodiments, the silicone-based foam may further include an Inhibitor component.

According to other embodiments, the silicone-based foam may include a particular content of the inhibitor component. For example, the silicone-based foam may include an inhibitor component content of at least about 0.02 wt. % for a total weight of the silicone-based foam, such as, at least about 0.04 wt. % or at least about 0.06 wt. % or at least about 0.08 wt. % or even at least about 0.1 wt. %. According to yet other embodiments, the silicone-based foam may include an inhibitor component content of not greater than about 0.5 wt. % for a total weight of the silicone-based foam, such as, not greater than about 0.4 wt. % or not greater than about 0.3 wt. % or not greater than about 0.2 wt. % or even not greater than about 0.1 wt. %. It will be appreciated that the inhibitor component content of the silicone-based foam may be within a range between any of the values noted above. It will be further appreciated that the inhibitor component content of the silicone-based foam may be any value between any of the minimum and maximum values noted above.

According to certain embodiments, the silicone-based foam may have a particular flammability rating as measured according to ASTM D4986. In particular, the foam layer may have a HBF flammability rating as measured according to ASTM D4986.

According to certain embodiments, the silicone-based foam may have a particular flammability rating as measured according to ASTM D3801. In particular, the foam layer may have a V-0 flammability rating as measured according to ASTM D3801.

According to yet other embodiments, the silicone-based foam may have a particular self-ignition time when exposed to a hot plate test at a temperature of 650° C. For purposes of embodiments described herein, the hot plate test is carried out by preparing a 1-inch by 1-inch specimen of the material, which is put on top of a hot plate. Then a thermal couple is fixed in a steel weight (1 inch in diameter, 2 inches in height) is put on top of the specimen to measure the cold side surface temperature. The temperature curve is recorded and the point, if any, of self-ignition is recorded. According to particular embodiments, the silicone-based foam may have a self ignition time of at least about 1 minute, such as, at least about 1.5 minutes or at least about 2 minutes or at least about 2.5 minutes or at least about 3 minutes or at least about 3.5 minutes or at least about 4.0 minutes or at least about 4.5 minutes or even at least about 5.0 minutes. It will be appreciated that the self ignition time of the silicone-based foam may be within a range between any of the values noted above. It will be further appreciated that the self-ignition time of the silicone-based foam may be any value between any of the values noted above.

According to still other embodiments, the silicone-based foam may have a particular cold-side temperature as measured at 5 minutes when a 3 mm thickness of the foam is exposed to a hot plate test at 650° C. For purposes of embodiments described herein, the hot plate test is carried out by preparing a 1 inch by 1 inch specimen of the material, which is put on top of a hot plate. Then a thermal couple is fixed in a steel weight (1 inch in diameter, 2 inches in height) is put on top of the specimen to measure the cold side surface temperature. According to certain embodiments, the silicone-based foam may have a cold side temperature of not greater than about 300° C., such as, not greater than about 275° C. or not greater than about 250° C. or not greater than about 225° C. or not greater than about 200° C. or not greater than about 175° C. or even not greater than about 150° C. According to still other embodiments, the silicone-based foam may have a cold side temperature of at least about 25° ° C. It will be appreciated that the cold side temperature of the silicone-based foam may be within a range between any of the values noted above. It will be further appreciated that the cold side temperature of the silicone-based foam may be any value between any of the values noted above.

According to yet other embodiments, the silicone-based foam may have a particular thickness. For example, the silicone-based foam may have a thickness of at least about 0.5 mm, such as, at least about 1.0 mm or at least about 1.5 mm or at least about 2.0 mm or at least about 2.5 mm or at least about 3.0 mm or at least about 3.5 mm or at least about 4.0 mm or at least about 4.5 mm or even at least about 5.0 mm. According to still other embodiments, the silicone-based foam may have a thickness of not greater than about 10 mm, such as, not greater than about 9.5 mm or not greater than about 9.0 mm or not greater than about 8.5 mm or not greater than about 8.0 mm or not greater than about 7.5 mm or not greater than about 7.0 mm or not greater than about 6.5 mm or even not greater than about 6.0 mm. It will be appreciated that the thickness of the silicone-based foam may be within a range between any of the minimum and maximum values noted above. It will be further appreciated that the thickness of the silicone-based foam may be any value between any of the minimum and maximum values noted above.

Turning now to additional embodiment described herein, according to certain embodiments, a multilayer composite may include a core foam layer, and a first ceramifiable barrier component contacting the core foam layer. According to particular embodiments, the first ceramifiable barrier component may include a ceramifiable layer and a structural layer.

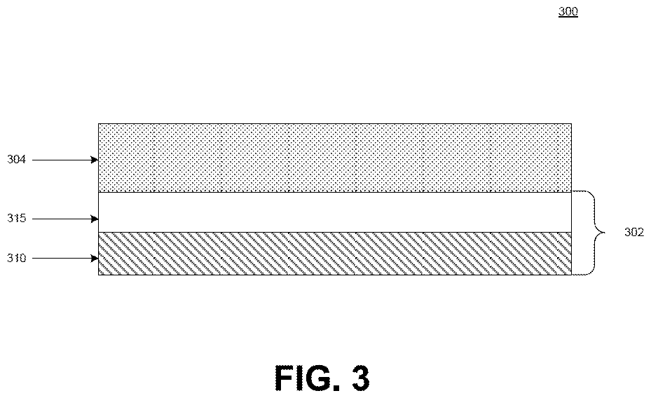

For purposes of illustration, FIG. 3 shows a multilayer composite 300 according to embodiments described herein. As shown in FIG. 3, a multilayer composite 300 may include a first ceramifiable barrier component 302 and a core foam layer 304. As further shown in FIG. 3, the first ceramifiable barrier component 302 may include a ceramifiable layer 310 and a structural layer 315.

It will be appreciated that the multilayer composite 300 and all components described in reference to the multilayer composite 300 as shown in FIG. 3 may have any of the characteristics described herein with reference to corresponding components in FIG. 1. In particular, the characteristics of the multilayer composite 300, the first ceramifiable barrier component 302, the core foam layer 304, and the ceramifiable layer 310 shown in FIG. 3 may have any of the corresponding characteristics described herein in reference to multilayer composite 100, the first ceramifiable barrier component 102, the core foam layer 104, and the ceramifiable layer shown in FIG. 1 or otherwise described herein.

According to certain embodiments, the structural layer 315 may be located between the ceramifiable layer 310 and the core foam layer 304.

According to yet other embodiments, the structural layer 315 may include a particular material. For example, the structural layer 315 may include a fiber-glass material. According to still other embodiments, the structural layer 315 may consist of a fiber-glass material. According to yet other embodiments, the structural layer 315 may be a fiber-glass layer.

According to yet other embodiments, the structural layer 315 may have a particular thickness. For example, the structural layer 315 may have a thickness of at least about 0.01 mm, such as, at least about 0.02 mm or at least about 0.03 mm or at least about 0.04 mm or at least about 0.05 mm or at least about 0.06 mm or at least about 0.07 mm or at least about 0.08 mm or at least about 0.09 mm or at least about 0.1 mm or at least about 0.2 mm or at least about 0.3 mm or at least about 0.4 mm or at least about 0.5 mm or at least about 0.6 mm or at least about 0.7 mm or at least about 0.8 mm or at least about 0.9 mm or at least about 1.0 mm or at least about 1.1 mm or at least about 1.2 mm or at least about 1.3 mm or even at least about 1.4 mm. According to still other embodiments, the structural layer 315 may have a thickness of not greater than about 7 mm, such as, not greater than about 6.5 mm or not greater than about 6.0 mm or not greater than about 5.5 mm or not greater than about 5.0 mm or not greater than about 4.5 mm or not greater than about 4.0 mm or not greater than about 3.5 mm or not greater than about 3.0 mm or not greater than about 2.9 mm or not greater than about 2.8 mm or not greater than about 2.7 mm or not greater than about 2.6 mm or not greater than about 2.5 mm or not greater than about 2.4 mm or not greater than about 2.3 mm or even not greater than about 2.2 mm. It will be appreciated that the thickness of the structural layer 315 may be within a range between any of the minimum and maximum values noted above. It will be further appreciated that the thickness of the structural layer 315 may be any value between any of the minimum and maximum values noted above.

Turning now to additional embodiment described herein, according to certain embodiments, a multilayer composite may include a core foam layer, and a first ceramifiable barrier component contacting the core foam layer and a second ceramifiable barrier component contact the fore foam layer such that the core foam layer is between the first ceramifiable barrier component and the second ceramifiable barrier component. According to particular embodiments, the first ceramifiable barrier component may include a ceramifiable layer and the second ceramifiable barrier component may include a ceramifiable layer.

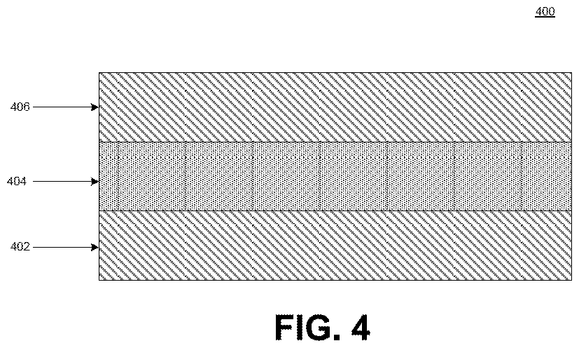

For purposes of illustration, FIG. 4 shows a multilayer composite 400 according to embodiments described herein. As shown in FIG. 4, a multilayer composite 400 may include a first ceramifiable barrier component 402, a core foam layer 404, and a second ceramifiable barrier component 406. As further shown in FIG. 4, the core foam layer 404 is between the first ceramifiable barrier component 402 and the second ceramifiable barrier component 406.

It will be appreciated that the multilayer composite 400 and all components described in reference to the multilayer composite 400 as shown in FIG. 4 may have any of the characteristics described herein with reference to corresponding components in FIGS. 1 and/or 2. Further, it will be appreciated that the second ceramifiable barrier component 404 may have any of the properties or characteristics of any first ceramifiable barrier component described herein.

Turning now to still other embodiments described herein, according to certain embodiments, a multilayer composite may include a core foam layer, and a first ceramifiable barrier component contacting the core foam layer and a second ceramifiable barrier component contact the fore foam layer such that the core foam layer is between the first ceramifiable barrier component and the second ceramifiable barrier component. According to particular embodiments, the first ceramifiable barrier component may include a ceramifiable layer and the second ceramifiable barrier component may include a ceramifiable layer. According to particular embodiments, the first ceramifiable barrier component may include a ceramifiable layer and a structural layer, and the second ceramifiable barrier component may include a ceramifiable layer and a structural layer.

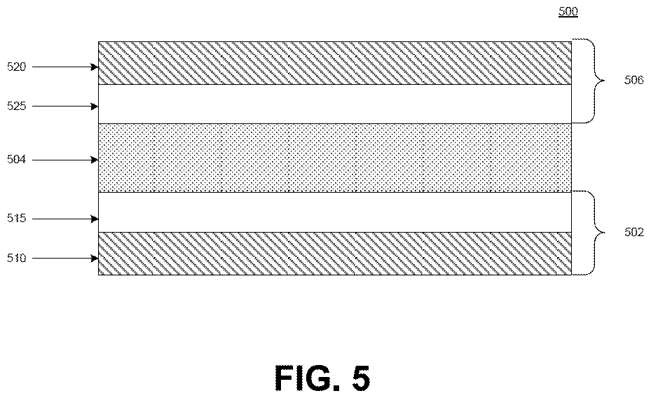

For purposes of illustration, FIG. 5 shows a multilayer composite 500 according to embodiments described herein. As shown in FIG. 5, a multilayer composite 500 may include a first ceramifiable barrier component 502, a core foam layer 504, and a second ceramifiable barrier component 506. As further shown in FIG. 5, the core foam layer 504 is between the first ceramifiable barrier component 502 and the second ceramifiable barrier component 504. As further shown in FIG. 5, the first ceramifiable barrier component 502 may include a ceramifiable layer 510 and a structural layer 515, and the second ceramifiable barrier component 506 may include a ceramifiable layer 520 and a structural layer 525.

It will be appreciated that the multilayer composite 500 and all components described in reference to the multilayer composite 500 as shown in FIG. 5 may have any of the characteristics described herein with reference to corresponding components in FIGS. 1 and/or 2. Further, it will be appreciated that the second ceramifiable barrier component 504, including the ceramifiable layer and the structural layer, may have any of the properties or characteristics of any first ceramifiable barrier component described herein.

Turning now to additional embodiment described herein, according to certain embodiments, a multilayer composite may include a first core foam layer, a first ceramifiable barrier component, and a second core foam layer such that the first ceramifiable barrier component is between the first core foam layer and the second core foam layer.

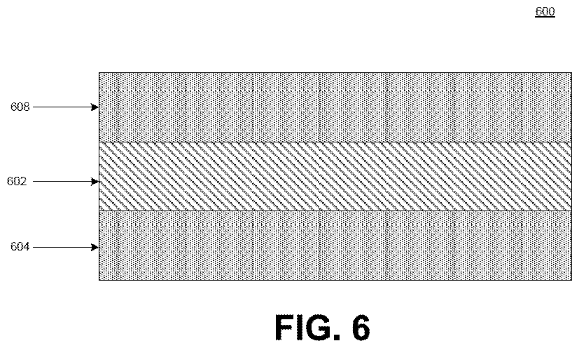

For purposes of illustration, FIG. 6 shows a multilayer composite 600 according to embodiments described herein. As shown in FIG. 6, a multilayer composite 600 may include a first ceramifiable barrier component 602, a first core foam layer 604, and a second core foam layer 608. As further shown in FIG. 6, the first ceramifiable barrier component 602 is between the first core foam layer 604 and the second core foam layer 608.

It will be appreciated that the multilayer composite 600 and all components described in reference to the multilayer composite 600 as shown in FIG. 6 may have any of the characteristics described herein with reference to corresponding components described herein.

Turning again to still other embodiments described herein, according to certain embodiments, a multilayer composite may include a first core foam layer, a first ceramifiable barrier component, and a second core foam layer such that the first ceramifiable barrier component is between the first core foam layer and the second core foam layer. According to particular embodiments, the first ceramifiable barrier component may include a ceramifiable layer and a structural layer.

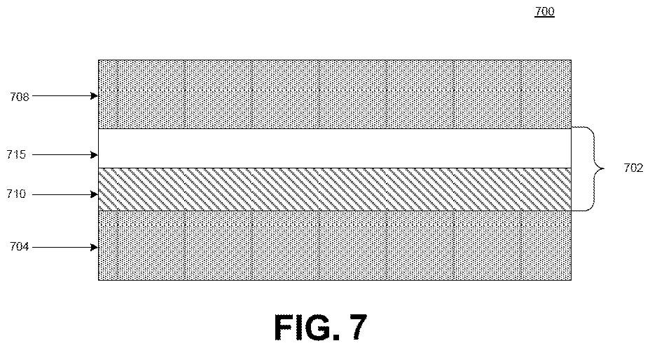

For purposes of illustration, FIG. 7 shows a multilayer composite 700 according to embodiments described herein. As shown in FIG. 7, a multilayer composite 700 may include a first ceramifiable barrier component 702, a first core foam layer 704, and a second core foam layer 708. As further shown in FIG. 7, the first ceramifiable barrier component 702 is between the first core foam layer 704 and the second core foam layer 708. As further shown in FIG. 7, the first ceramifiable barrier component 702 may include a ceramifiable layer 710 and a structural layer 715.

It will be appreciated that the multilayer composite 700 and all components described in reference to the multilayer composite 700 as shown in FIG. 7 may have any of the characteristics described herein with reference to corresponding components described herein.

Turning now to additional embodiments described herein, according to certain embodiments, the structural layer and the cermifiable layer of any ceramifiable barrier component may be arranged such that the structural layer is between the ceramifiable layer and the core foam layer as shown in FIGS. 3 and 5. According to alternative embodiments, the structural layer and the cermifiable layer of any ceramifiable barrier component may be arranged such that the ceramifiable layer is between the structural layer and the core foam layer.

According to yet other embodiments, it will be appreciated that the structural layer may include additional surface treatments that may improve performance or adhesion of the structural layer to other layers, such as, to the core foam layer, the ceramifiable layer, or any other layer in the multilayer composite. For example, the structural layer may further include a silicone coating overlying one or both of its surfaces. According to still other embodiments, the structural layer may include a surface treatment on one or both of its surfaces.

Tuning now to additional embodiments described herein, such embodiments are generally directed to multilayer laminate. It will be appreciated that any multilayer composite as described herein may be formed as a multilayer laminate such that the multilayer laminate described herein includes any of the components described herein with regards to any of the multilayer composites. It will be further appreciated that any multilayer composite as described herein may be formed as a multilayer laminate such that the components of the multilayer laminate described herein includes any of the characteristics and/or properties of the components described herein with regards to any of the multilayer composites. It will be appreciated that such multilayer laminate is formed by laminating any of the components described herein to form the multilayer laminate.

Tuning now to still other additional embodiments described herein, such embodiments are generally directed to a thermal barrier composite that may include any multilayer composite as described herein.

According to certain embodiments, the thermal barrier composite described herein may be formed according to any acceptable forming process for a thermal barrier composite. According to a particular embodiment, the thermal barrier composite may be formed using a lamination process where the porous foam and barrier layer are laminated using a transfer adhesive such as, for example, a silicon adhesive, a rubber adhesive, an acrylic adhesive, a phenolic adhesive, a polyurethane-based adhesive, or any combination thereof. According to still other embodiments, the thermal barrier composite may be formed using a lamination process with a porous foam and a coated barrier layer, where the coating on the barrier layer is an adhesive, such as, a silicon adhesive, a rubber adhesive, an acrylic adhesive, a phenolic adhesive, a polyurethane-based adhesive, or any combination thereof. According to still other embodiments, the thermal barrier composite may be formed using a direct cast forming process, wherein the foam is directly cast onto the barrier films or between the barrier films.

Many different aspects and embodiments are possible. Some of those aspects and embodiments are described herein. After reading this specification, skilled artisans will appreciate that those aspects and embodiments are only illustrative and do not limit the scope of the present invention. Embodiments may be in accordance with any one or more of the embodiments as listed below.

Embodiment 1. A multilayer composite comprising: a core foam layer, and a first ceramifiable barrier component contacting the core foam layer, wherein the ceramifiable barrier component comprises a ceramifiable layer, and wherein the multilayer composite comprises a HBF flammability rating as measured according to ASTM D4986.

Embodiment 2. A multilayer laminate material comprising: a core foam layer, and a first ceramifiable tape laminated to the core foam layer, wherein the ceramifiable barrier component comprises a ceramifiable layer, and wherein the composite material or composite material layer a HBF flammability rating as measured according to ASTM D4986.

Embodiment 3. The multilayer composite or multilayer laminate of any one of embodiments 1 and 2, wherein the core foam layer comprises a silicone-based matrix component.

Embodiment 4. The multilayer composite or multilayer laminate of any one of embodiments 1 and 2, wherein the core foam layer comprises a flame retardant filler component.

Embodiment 5. The multilayer composite or multilayer laminate of any one of embodiments 1 and 2, wherein the core foam layer comprises an insulation filler component.

Embodiment 6. The multilayer composite or multilayer laminate of embodiment 3, wherein the silicone-based matrix component of the core foam layer comprises platinum catalyzed addition cured silicone foam, peroxide cured silicone foam, tin catalyzed silicone foam and any combination thereof.

Embodiment 7. The multilayer composite or multilayer laminate of embodiment 4, wherein the flame retardant filler component of the core foam layer comprises a filler selected from a group consisting of metal hydrates, borate compounds, platinum compounds, transition metal oxides, metal carbonates, calcium silicates, aluminum silicates, magnesium silicates, glass frits, alkaline salts, vermiculites, and any combination thereof.

Embodiment 8. The multilayer composite or multilayer laminate of embodiment 4, wherein the flame retardant filler component of the core foam layer comprises a filler selected from a group consisting of aluminum trihydrate, magnesium dihydroxides, Boehmite, calcium hydroxide, Huntite, gypsum, hydromagnesite and any combination thereof.

Embodiment 9. The multilayer composite or multilayer laminate of embodiment 4, wherein the flame retardant filler component of the core foam layer comprises a filler selected from a group consisting of zinc borate, calcium borate, sodium borate, potassium borate, lithium borate and any combination thereof.

Embodiment 10. The multilayer composite or multilayer laminate of embodiment 4, wherein the flame retardant filler component of the core foam layer comprises a filler selected from a group consisting of platinum-1,3-divinyl-1,1,3,3-tetramethyldisiloxane, hexachloroplatinic acid and any combination thereof.

Embodiment 11. The multilayer composite or multilayer laminate of embodiment 4, wherein the flame retardant filler component of the core foam layer comprises a filler selected from a group consisting of iron oxide, cerium oxide, titanium oxide, zinc oxide and any combination thereof.

Embodiment 12. The multilayer composite or multilayer laminate of embodiment 4, wherein the flame retardant filler of the core foam layer component comprises a filler selected from a group consisting of Huntite, calcium carbonate and any combination thereof.

Embodiment 13. The multilayer composite or multilayer laminate of embodiment 4, wherein the flame retardant filler component of the core foam layer comprises a filler selected from a group consisting of a natural mixture of hydromagnesite and Huntite, synthetic magnesium carbonate hydroxide pentahydrate and any combination thereof.

Embodiment 14. The multilayer composite or multilayer laminate of embodiment 4, wherein the flame retardant filler component of the core foam layer comprises a filler selected from a group consisting of wallastonite, mica, clay, kaolin, talc, vermiculite, and any combination thereof.

Embodiment 15. The multilayer composite or multilayer laminate of embodiment 4, wherein the flame retardant filler component of the core foam layer comprises a filler selected from a group consisting of sodium carbonate, potassium carbonate and any combination thereof.

Embodiment 16. The multilayer composite or multilayer laminate of embodiment 5, wherein the insulation filler component of the core foam layer comprises a filler selected from the group consisting of expanded perlite, unexpanded perlite, glass beads, vermiculite, expanded vermiculite, expanded glass, zeolite, aerogel, silica, porous silica, porous alumina, and any combination thereof.

Embodiment 17. The multilayer composite or multilayer laminate of embodiment 3, wherein the core foam layer comprises a silicone-based matrix component content of at least about 20 wt. % for a total weight of the core foam layer.

Embodiment 18. The multilayer composite or multilayer laminate of embodiment 3, wherein the core foam layer comprises a silicone-based matrix component content of not greater than about 85 wt. % for a total weight of the core foam layer.

Embodiment 19. The multilayer composite or multilayer laminate of embodiment 4, wherein the core foam layer comprises a flame retardant filler component content of at least about 1 wt. % for a total weight of the core foam layer.

Embodiment 20. The multilayer composite or multilayer laminate of embodiment 4, wherein the core foam layer comprises a flame retardant filler component of not greater than about 35 wt. % for a total weight of the core foam layer.

Embodiment 21. The multilayer composite or multilayer laminate of embodiment 5, wherein the core foam layer comprises an insulation filler component of not greater than about 25 wt. % for a total weight of the core foam layer.

Embodiment 22. The multilayer composite or multilayer laminate of embodiment 5, wherein the core foam layer comprises an insulation filler component content of at least about 1 wt. % for a total weight of the core foam layer.

Embodiment 23. The multilayer composite or multilayer laminate of any one or embodiments 3, 4, and 5, wherein the core foam layer comprises an HFB flammability rating as measured according to ASTM D4986.

Embodiment 24. The multilayer composite or multilayer laminate of any one or embodiments 3, 4, and 5, wherein the multilayer composite or multilayer laminate comprises a HBF flammability rating as measured according to ASTM D4986.

Embodiment 25. The multilayer composite or multilayer laminate of any one or embodiments 3, 4, and 5, wherein the core foam layer comprises a self ignition time of at least about 1 minute when exposed to a hotplate test at 650° C.

Embodiment 26. The multilayer composite or multilayer laminate of any one or

embodiments 3, 4, and 5, wherein the multilayer comprises a self ignition time of at least about 1 minute when exposed to a hotplate test at 650° C.

Embodiment 27. The multilayer composite or multilayer laminate of any one or embodiments 3, 4, and 5, wherein the multilayer composite or multilayer laminate comprises a burn through time of at least about 6 minutes when exposed to a torch test at 1000° C.

Embodiment 28. The multilayer composite or multilayer laminate of any one or embodiments 3, 4, and 5, wherein the core foam layer comprises a cold side temperature of not greater than about 300° C. as measured at 5 minutes when a 3 mm foam is exposed to a hotplate test at 650° C.

Embodiment 29. The multilayer composite or multilayer laminate of any one or embodiments 3, 4, and 5, wherein the core foam layer comprises a cold side temperature of at least about 25° C. as measured at 5 minutes when exposed to a hotplate test at 650° ° C.

Embodiment 30. The multilayer composite or multilayer laminate of any one or embodiments 3, 4, and 5, wherein the multilayer composite or multilayer laminate comprises a cold side temperature of not greater than about 300° C. as measured at 5 minutes when a 3 mm foam is exposed to a hotplate test at 650° C.

Embodiment 31. The multilayer composite or multilayer laminate of any one of embodiments 3, 4, and 5, wherein the multilayer composite or multilayer laminate comprises a cold side temperature of at least about 25° C. as measured at 5 minutes when exposed to a hotplate test at 650° C.

Embodiment 32. The multilayer composite or multilayer laminate of any one of embodiments 3, 4, and 5, wherein the core foam layer comprises a thickness of at least about 0.5 mm.

Embodiment 33. The multilayer composite or multilayer laminate of any one of embodiments 3, 4, and 5, wherein the core foam layer comprises a thickness of not greater than about 10 mm.

Embodiment 34. The multilayer composite or multilayer laminate of any one of embodiments 3, 4, and 5, wherein the multilayer composite or multilayer laminate comprises a thickness of at least about 0.5 mm.

Embodiment 35. The multilayer composite or multilayer laminate of any one of embodiments 3, 4, and 5, wherein the multilayer composite or multilayer laminate comprises a thickness of not greater than about 10 mm.

Embodiment 36. The multilayer composite or multilayer laminate of any one of embodiments 3, 4, and 5, wherein the core foam layer comprises a 25% strain compression rating of at least about 5 kPa.

Embodiment 37. The multilayer composite or multilayer laminate of any one of embodiments 3, 4, and 5, wherein the core foam layer comprises a 25% strain compression rating of not greater than about 500 kPa.

Embodiment 38. The multilayer composite or multilayer laminate of any one of embodiments 3, 4, and 5, wherein the multilayer composite or multilayer laminate comprises a 25% strain compression rating of at least about 5 kPa.

Embodiment 39. The multilayer composite or multilayer laminate of any one of embodiments 3, 4, and 5, wherein the multilayer composite or multilayer laminate comprises a 25% strain compression rating of not greater than about 500 kPa

Embodiment 40. The multilayer composite or multilayer laminate of any one of embodiments 3, 4, and 5, wherein the core foam layer comprises a density of not greater than about 1200 kg/m³.

Embodiment 41. The multilayer composite or multilayer laminate of any one of embodiments 3, 4, and 5, wherein the core foam layer comprises a density of at least about 100 kg/m³.

Embodiment 42. The multilayer composite or multilayer laminate of any one of embodiments 3, 4, and 5, wherein the multilayer composite layer comprises a density of not greater than about 1500 kg/m³.

Embodiment 43. The multilayer composite or multilayer laminate of any one of embodiments 3, 4, and 5, wherein the multilayer composite or multilayer laminate comprises a density of at least about 100 kg/m³.

Embodiment 44. The multilayer composite or multilayer laminate of any one of embodiments 3, 4, and 5, wherein the core foam layer comprises a thermal conductivity of at least about 0.01 W/mK.

Embodiment 45. The multilayer composite or multilayer laminate of any one of embodiments 3, 4, and 5, wherein the core foam layer comprises a thermal conductivity of not greater than about 0.15 W/mK.

Embodiment 46. The multilayer composite or multilayer laminate of any one of embodiments 3, 4, and 5, wherein the multilayer composite or multilayer laminate comprises a thermal conductivity of at least about 0.01 W/mK.

Embodiment 47. The multilayer composite or multilayer laminate of any one of embodiments 3, 4, and 5, wherein the multilayer composite or multilayer laminate comprises a thermal conductivity of not greater than about 0.15 W/mK.

Embodiment 48. The multilayer composite or multilayer laminate of any one of embodiments 1 and 2, wherein the core foam layer comprises a silicone-based foam.

Embodiment 49. The multilayer composite or multilayer laminate of embodiment 48, wherein the silicone-based foam comprises a component A and a component B, wherein the component A comprises: a silicone-based matrix component, a first filler component comprising alumina trihydrate at a content of at least about 5 wt. % and not greater than about 30 wt. % for a total weight of the component A, a second filler component comprising perlite at a content of at least about 1 wt. % and not greater than about 15 wt. % for a total weight of the component A, and a third filler component comprising calcium carbonate at a content of at least about 1 wt. % and not greater than about 20 wt. % for a total weight of the component A, wherein the component B comprises: a silicone-based matrix component, a first filler component comprising alumina trihydrate at a content of at least about 5 wt. % and not greater than about 30 wt. % for a total weight of the component B, a second filler component comprising perlite at a content of at least about 1 wt. % and not greater than about 15 wt. % for a total weight of the component B, a third filler component comprising calcium carbonate at a content of at least about 1 wt. % and not greater than about 20 wt. % for a total weight of the component B, and a fourth filler component comprising zinc borate at a content of at least about 1 wt. % and not greater than about 20 wt. % for a total weight of the component B, and wherein the silicone-based foam comprises a V-0 flammability rating as measured according to ASTM D3801.

Embodiment 50. The multilayer composite or multilayer laminate of embodiment 48, wherein the silicone-based foam comprises: a silicone-based matrix component, a first filler component comprising alumina trihydrate at a content of at least about 5 wt. % and not greater than about 30 wt. % for a total weight of the silicone-based foam, a second filler component comprising perlite at a content of at least about 1 wt. % and not greater than about 15 wt. % for a total weight of the silicone-based foam, a third filler component comprising calcium carbonate at a content of at least about 1 wt. % and not greater than about 20 wt. % for a total weight of the silicone-based foam, and a fourth filler component comprising zinc borate at a content of at least about 1 wt. % and not greater than about 20 wt. % for a total weight of the silicone-based foam.

Embodiment 51. The multilayer composite or multilayer laminate of embodiment 48, wherein the silicone-based foam is formed from a component A and a component B, wherein the component A comprises: a silicone-based matrix component, a first filler component comprising alumina trihydrate at a content of at least about 5 wt. % and not greater than about 30 wt. % for a total weight of the component A, a second filler component comprising perlite at a content of at least about 1 wt. % and not greater than about 15 wt. % for a total weight of the component A, and a third filler component comprising calcium carbonate at a content of at least about 1 wt. % and not greater than about 20 wt. % for a total weight of the component A, wherein the component B comprises: a silicone-based matrix component, a first filler component comprising alumina trihydrate at a content of at least about 5 wt. % and not greater than about 30 wt. % for a total weight of the component B, a second filler component comprising perlite at a content of at least about 1 wt. % and not greater than about 15 wt. % for a total weight of the component B, a third filler component comprising calcium carbonate at a content of at least about 1 wt. % and not greater than about 20 wt. % for a total weight of the component B, and a fourth filler component comprising zinc borate at a content of at least about 1 wt. % and not greater than about 20 wt. % for a total weight of the component B, and wherein the silicone-based foam comprises a V-0 flammability rating as measured according to ASTM D3801.

Embodiment 52. The multilayer composite or multilayer laminate of embodiment 50, wherein the silicone-based foam comprises a component A and a component B.

Embodiment 53. The multilayer composite or multilayer laminate of any one of embodiments 49, 51, and 52, wherein the component A comprises a silicone-based matrix component content of at least about 30 wt. % for a total weight of the component A.

Embodiment 54. The multilayer composite or multilayer laminate of any one of embodiments 49, 51, and 52, wherein the component A comprises a silicone-based matrix component content of not greater than about 60 wt. % for a total weight of the component A.

Embodiment 55. The multilayer composite or multilayer laminate of any one of embodiments 49, 51, and 52, wherein the component A comprises a first filler component comprising alumina trihydrate at a content of at least about 5 wt. % for a total weight of the component A.

Embodiment 56. The multilayer composite or multilayer laminate of any one of embodiments 49, 51, and 52, wherein the component A comprises a first filler component comprising alumina trihydrate at a content of not greater than about 30 wt. % for a total weight of the component A.

Embodiment 57. The multilayer composite or multilayer laminate of any one of embodiments 49, 51, and 52, wherein the component A comprises a second filler component comprising perlite at a content of at least about 1 wt. % for a total weight of the component A.

Embodiment 58. The multilayer composite or multilayer laminate of any one of embodiments 49, 51, and 52, wherein the component A comprises a second filler component comprising perlite at a content of not greater than about 15 wt. % for a total weight of the component A.

Embodiment 59. The multilayer composite or multilayer laminate of any one of embodiments 49, 51, and 52, wherein the component A comprises a third filler component comprising calcium carbonate at a content of at least about 1 wt. % for a total weight of the component A.

Embodiment 60. The multilayer composite or multilayer laminate of any one of embodiments 49, 51, and 52, wherein the component A comprises a third filler component comprising calcium carbonate at a content of not greater than about 20 wt. % for a total weight of the component A.

Embodiment 61. The multilayer composite or multilayer laminate of any one of embodiments 49, 51, and 52, wherein the component A comprises a pigment component at a content of at least about 1 wt. % for a total weight of the component A.

Embodiment 62. The multilayer composite or multilayer laminate of any one of embodiments 49, 51, and 52, wherein the component A comprises a pigment component at a content of not greater than about 5 wt. % for a total weight of the component A.

Embodiment 63. The multilayer composite or multilayer laminate of any one of embodiments 49, 51, and 52, wherein the component A comprises a vinyl-functional pre-polymer component at a content of at least about 10 wt. % for a total weight of the component A.

Embodiment 64. The multilayer composite or multilayer laminate of any one of embodiments 49, 51, and 52, wherein the component A comprises a vinyl-functional pre-polymer component at a content of not greater than about 30 wt. % for a total weight of the component A.

Embodiment 65. The multilayer composite or multilayer laminate of any one of embodiments 49, 51, and 52, wherein the component A comprises an alcohol blowing agent at a content of at least about 1 wt. % for a total weight of the component A.

Embodiment 66. The multilayer composite or multilayer laminate of any one of embodiments 49, 51, and 52, wherein the component A comprises an alcohol blowing agent at a content of not greater than about 10 wt. % for a total weight of the component A.

Embodiment 67. The multilayer composite or multilayer laminate of any one of embodiments 49, 51, and 52, wherein the component A comprises a resin solution at a content of at least about 5 wt. % for a total weight of the component A.

Embodiment 68. The multilayer composite or multilayer laminate of any one of embodiments 49, 51, and 52, wherein the component A comprises a resin solution at a content of not greater than about 25 wt. % for a total weight of the component A.

Embodiment 69. The multilayer composite or multilayer laminate of any one of embodiments 49, 51, and 52, wherein the component A comprises a Pt catalyst component at a content of at least about 0.02 wt. % for a total weight of the component A.

Embodiment 70. The multilayer composite or multilayer laminate of any one of embodiments 49, 51, and 52, wherein the component A comprises a Pt catalyst component at a content of not greater than about 0.15 wt. % for a total weight of the component A.

Embodiment 71. The multilayer composite or multilayer laminate of any one of embodiments 49, 51, and 52, wherein the component B comprises a silicone-based matrix component content of at least about 20 wt. % for a total weight of the component B.

Embodiment 72. The multilayer composite or multilayer laminate of any one of embodiments 49, 51, and 52, wherein the component B comprises a silicone-based matrix component content of not greater than about 50 wt. % for a total weight of the component B.

Embodiment 73. The multilayer composite or multilayer laminate of any one of embodiments 49, 51, and 52, wherein the component B comprises a first filler component comprising alumina trihydrate at a content of at least about 5 wt. % for a total weight of the component B.

Embodiment 74. The multilayer composite or multilayer laminate of any one of embodiments 49, 51, and 52, wherein the component B comprises a first filler component comprising alumina trihydrate at a content of not greater than about 30 wt. % for a total weight of the component B.

Embodiment 75. The multilayer composite or multilayer laminate of any one of embodiments 49, 51, and 52, wherein the component B comprises a second filler component comprising perlite at a content of at least about 1 wt. % for a total weight of the component B.

Embodiment 76. The multilayer composite or multilayer laminate of any one of embodiments 49, 51, and 52, wherein the component B comprises a second filler component comprising perlite at a content of not greater than about 15 wt. % for a total weight of the component B.

Embodiment 77. The multilayer composite or multilayer laminate of any one of embodiments 49, 51, and 52, wherein the component B comprises a third filler component comprising calcium carbonate at a content of at least about 1 wt. % for a total weight of the component B.

Embodiment 78. The multilayer composite or multilayer laminate of any one of embodiments 49, 51, and 52, wherein the component B comprises a third filler component comprising calcium carbonate at a content of not greater than about 20 wt. % for a total weight of the component B.

Embodiment 79. The multilayer composite or multilayer laminate of any one of embodiments 49, 51, and 52, wherein the component B comprises a fourth filler component comprising zinc borate at a content of at least about 1 wt. % for a total weight of the component B.

Embodiment 80. The multilayer composite or multilayer laminate of any one of embodiments 49, 51, and 52, wherein the component B comprises a fourth filler component comprising zinc borate at a content of not greater than about 20 wt. % for a total weight of the component B.

Embodiment 81. The multilayer composite or multilayer laminate of any one of embodiments 49, 51, and 52, wherein the component B comprises a vinyl-functional pre-polymer component at a content of at least about 10 wt. % for a total weight of the component B.

Embodiment 82. The multilayer composite or multilayer laminate of any one of embodiments 49, 51, and 52, wherein the component B comprises a vinyl-functional pre-polymer component at a content of not greater than about 25 wt. % for a total weight of the component B.

Embodiment 83. The multilayer composite or multilayer laminate of any one of embodiments 49, 51, and 52, wherein the component B comprises a hydride functional crosslinker component at a content of at least about 5 wt. % for a total weight of the component B.

Embodiment 84. The multilayer composite or multilayer laminate of any one of embodiments 49, 51, and 52, wherein the component B comprises a hydride functional crosslinker component at a content of not greater than about 15 wt. % for a total weight of the component B.

Embodiment 85. The multilayer composite or multilayer laminate of any one of embodiments 49, 51, and 52, wherein the component B comprises an inhibitor component at a content of at least about 0.05 wt. % for a total weight of the component B.

Embodiment 86. The multilayer composite or multilayer laminate of any one of embodiments 49, 51, and 52, wherein the component B comprises an inhibitor component at a content of not greater than about 0.5 wt. % for a total weight of the component B.

Embodiment 87. The multilayer composite or multilayer laminate of any one of embodiments 49, 51, and 52, wherein the silicone-based foam comprises a silicone-based matrix component content of at least about 25 wt. % for a total weight of the silicone-based foam.

Embodiment 88. The multilayer composite or multilayer laminate of any one of embodiments 49, 51, and 52, wherein the silicone-based foam comprises a silicone-based matrix component content of not greater than about 55 wt. % for a total weight of the silicone-based foam.

Embodiment 89. The multilayer composite or multilayer laminate of any one of embodiments 49, 51, and 52, wherein the silicone-based foam comprises a first filler component comprising alumina trihydrate at a content of at least about 5 wt. % for a total weight of the silicone-based foam.

Embodiment 90. The multilayer composite or multilayer laminate of any one of embodiments 49, 51, and 52, wherein the silicone-based foam comprises a first filler component comprising alumina trihydrate at a content of not greater than about 30 wt. % for a total weight of the silicone-based foam.

Embodiment 91. The multilayer composite or multilayer laminate of any one of embodiments 49, 51, and 52, wherein the silicone-based foam comprises a second filler component comprising perlite at a content of at least about 1 wt. % for a total weight of the silicone-based foam.

Embodiment 92. The multilayer composite or multilayer laminate of any one of embodiments 49, 51, and 52, wherein the silicone-based foam comprises a second filler component comprising perlite at a content of not greater than about 15 wt. % for a total weight of the silicone-based foam.

Embodiment 93. The multilayer composite or multilayer laminate of any one of embodiments 49, 51, and 52, wherein the silicone-based foam comprises a third filler component comprising calcium carbonate at a content of at least about 1 wt. % for a total weight of the silicone-based foam.

Embodiment 94. The multilayer composite or multilayer laminate of any one of embodiments 49, 51, and 52, wherein the silicone-based foam comprises a third filler component comprising calcium carbonate at a content of not greater than about 20 wt. % for a total weight of the silicone-based foam.

Embodiment 95. The multilayer composite or multilayer laminate of any one of embodiments 49, 51, and 52, wherein the silicone-based foam comprises a fourth filler component comprising zinc borate at a content of at least about 1 wt. % for a total weight of the silicone-based foam.

Embodiment 96. The multilayer composite or multilayer laminate of any one of embodiments 49, 51, and 52, wherein the silicone-based foam comprises a fourth filler component comprising zinc borate at a content of not greater than about 20 wt. % for a total weight of the silicone-based foam.

Embodiment 97. The multilayer composite or multilayer laminate of any one of embodiments 49, 51, and 52, wherein the silicone-based foam comprises a pigment component at a content of at least about 0.5 wt. % for a total weight of the silicone-based foam.

Embodiment 98. The multilayer composite or multilayer laminate of any one of embodiments 49, 51, and 52, wherein the silicone-based foam comprises a pigment component at a content of not greater than about 2.5 wt. % for a total weight of the silicone-based foam.

Embodiment 99. The multilayer composite or multilayer laminate of any one of embodiments 49, 51, and 52, wherein the silicone-based foam comprises a vinyl-functional pre-polymer component at a content of at least about 10 wt. % for a total weight of the silicone-based foam.

Embodiment 100. The multilayer composite or multilayer laminate of any one of embodiments 49, 51, and 52, wherein the silicone-based foam comprises a vinyl-functional pre-polymer component at a content of not greater than about 28 wt. % for a total weight of the silicone-based foam.

Embodiment 101. The multilayer composite or multilayer laminate of any one of embodiments 49, 51, and 52, wherein the silicone-based foam comprises an alcohol blowing agent at a content of at least about 0.5 wt. % for a total weight of the silicone-based foam.

Embodiment 102. The multilayer composite or multilayer laminate of any one of embodiments 49, 51, and 52, wherein the silicone-based foam comprises an alcohol blowing agent at a content of not greater than about 5 wt. % for a total weight of the silicone-based foam.

Embodiment 103. The multilayer composite or multilayer laminate of any one of embodiments 49, 51, and 52, wherein the silicone-based foam comprises a resin solution at a content of at least about 2.5 wt. % for a total weight of the silicone-based foam.

Embodiment 104. The multilayer composite or multilayer laminate of any one of embodiments 49, 51, and 52, wherein the silicone-based foam comprises a resin solution at a content of not greater than about 13 wt. % for a total weight of the silicone-based foam.

Embodiment 105. The multilayer composite or multilayer laminate of any one of embodiments 49, 51, and 52, wherein the silicone-based foam comprises a Pt catalyst component at a content of at least about 0.02 wt. % for a total weight of the silicone-based foam.

Embodiment 106. The multilayer composite or multilayer laminate of any one of embodiments 49, 51, and 52, wherein the silicone-based foam comprises a Pt catalyst component at a content of not greater than about 0.15 wt. % for a total weight of the silicone-based foam.

Embodiment 107. The multilayer composite or multilayer laminate of any one of embodiments 49, 51, and 52, wherein the silicone-based foam comprises a hydride functional crosslinker component at a content of at least about 5 wt. % for a total weight of the silicone-based foam.

Embodiment 108. The multilayer composite or multilayer laminate of any one of embodiments 49, 51, and 52, wherein the silicone-based foam comprises a hydride functional crosslinker component at a content of not greater than about 15 wt. % for a total weight of the silicone-based foam.

Embodiment 109. The multilayer composite or multilayer laminate of any one of embodiments 49, 51, and 52, wherein the silicone-based foam comprises an inhibitor component at a content of at least about 0.05 wt. % for a total weight of the silicone-based foam.

Embodiment 110. The multilayer composite or multilayer laminate of any one of embodiments 49, 51, and 52, wherein the silicone-based foam comprises an inhibitor component at a content of not greater than about 0.5 wt. % for a total weight of the silicone-based foam.

Embodiment 111. The multilayer composite or multilayer laminate of any one of embodiments 49, 51, and 52, wherein the silicone-based matrix component comprises addition cured silicone foam, peroxide cured silicone foam, tin catalyzed silicone foam.

Embodiment 112. The multilayer composite or multilayer laminate of any one of embodiments 49, 51, and 52, wherein the silicone-based foam comprises a thickness of at least about 0.5 mm.

Embodiment 113. The multilayer composite or multilayer laminate of any one of embodiments 49, 51, and 52, wherein the silicone-based foam comprises a thickness of not greater than about 10 mm.

Embodiment 114. The multilayer composite or multilayer laminate of any one of embodiments 1 and 2, wherein the core foam layer comprises a polyurethane-based matrix component.

Embodiment 115. The multilayer composite or multilayer laminate of any one of embodiments 1 and 2, wherein the core foam layer comprises a flame retardant filler component.

Embodiment 116. The multilayer composite or multilayer laminate of embodiment 114, wherein the polyurethane-based matrix component of the core foam layer comprises a flexible polyurethane reacted from isocyanate and polyol.

Embodiment 117. The multilayer composite or multilayer laminate of embodiment 115, wherein the flame retardant filler component comprises a filler selected from the group consisting of reactive charring agents, mineral compounds, endothermic decomposition compounds, and any combination thereof.

Embodiment 118. The multilayer composite or multilayer laminate of embodiment 117, wherein the reactive charring agents are selected from the group consisting of melamine, organic phosphorous compounds, inorganic phosphorous compounds, metal salts, such as phosphate, phosphonate, phosphinate, aluminum diethyl phosphinate, and any combination thereof; and/or, the mineral compounds are selected from the group consisting of expandable graphite; and/or, the endothermic decomposition compounds are selected from the group consisting of metal hydrate, metal silicates, carbonates, such as aluminum trihydrate and zinc borate, and any combination thereof.

Embodiment 119. The multilayer composite or multilayer laminate of embodiment 114, wherein the core foam layer comprises a polyurethane-based matrix component content of at least about 40 wt. % for a total weight of the core foam layer.

Embodiment 120. The multilayer composite or multilayer laminate of embodiment 114, wherein the core foam layer comprises a polyurethane-based matrix component content of not greater than about 95 wt. % for a total weight of the core foam layer.

Embodiment 121. The multilayer composite or multilayer laminate of embodiment 115, wherein the core foam layer comprises a flame retardant filler component content of at least about 5 wt. % for a total weight of the core foam layer.

Embodiment 122. The multilayer composite or multilayer laminate of embodiment 115, wherein the core foam layer comprises a flame retardant filler component of not greater than about 60 wt. % for a total weight of the core foam layer.

Embodiment 123. The multilayer composite or multilayer laminate of any one of embodiments 114 and 115, wherein the core foam layer comprises a HBF flammability rating as measured according to ASTM D4986.

Embodiment 124. The multilayer composite or multilayer laminate of any one of embodiments 114 and 115, wherein the multilayer composite or multilayer laminate comprises a HBF flammability rating as measured according to ASTM D4986.

Embodiment 125. The multilayer composite or multilayer laminate of any one of embodiments 114 and 115, wherein the multilayer composite or multilayer laminate comprises a cold side temperature of not greater than about 300° C. as measured at 5 minutes when exposed to a hotplate test at 650° C.

Embodiment 126. The multilayer composite or multilayer laminate of any one of embodiments 114 and 115, wherein the multilayer composite or multilayer laminate comprises a cold side temperature of at least about 25° C. as measured at 5 minutes when exposed to a hotplate test at 650° C.

Embodiment 127. The multilayer composite or multilayer laminate of any one of embodiments 114 and 115, wherein the core foam layer comprises a thickness of at least about 0.5 mm.

Embodiment 128. The multilayer composite or multilayer laminate of any one of embodiments 114 and 115, wherein the core foam layer comprises a thickness of not greater than about 10 mm.

Embodiment 129. The multilayer composite or multilayer laminate of any one of embodiments 114 and 115, wherein the multilayer composite or multilayer laminate comprises a thickness of at least about 0.5 mm.

Embodiment 130. The multilayer composite or multilayer laminate of any one of embodiments 114 and 115, wherein the multilayer composite or multilayer laminate comprises a thickness of not greater than about 10 mm.

Embodiment 131. The multilayer composite or multilayer laminate of any one of embodiments 114 and 115, wherein the core foam layer comprises a 25% strain compression rating of at least about 5 kPa.

Embodiment 132. The multilayer composite or multilayer laminate of any one of embodiments 114 and 115, wherein the core foam layer comprises a 25% strain compression rating of not greater than about 500 kPa.

Embodiment 133. The multilayer composite or multilayer laminate of any one of embodiments 114 and 115, wherein the multilayer composite or multilayer laminate comprises a 25% strain compression rating of at least about 5 kPa.

Embodiment 134. The multilayer composite or multilayer laminate of any one of embodiments 114 and 115, wherein the multilayer composite or multilayer laminate comprises a 25% strain compression rating of not greater than about 500 kPa.

Embodiment 135. The multilayer composite or multilayer laminate of any one of embodiments 114 and 115, wherein the core foam layer comprises a density of not greater than about 600 kg/m³.

Embodiment 136. The multilayer composite or multilayer laminate of any one of embodiments 114 and 115, wherein the core foam layer comprises a density of at least about 50 kg/m³.

Embodiment 137. The multilayer composite or multilayer laminate of any one of embodiments 114 and 115, wherein the multilayer composite layer comprises a density of not greater than about 600 kg/m³.

Embodiment 138. The multilayer composite or multilayer laminate of any one of embodiments 114 and 115, wherein the multilayer composite or multilayer laminate comprises a density of at least about 50 kg/m³.

Embodiment 139. The multilayer composite or multilayer laminate of any one of embodiments 114 and 115, wherein the core foam layer comprises a thermal conductivity of at least about 0.01 W/mK.

Embodiment 140. The multilayer composite or multilayer laminate of any one of embodiments 114 and 115, wherein the core foam layer comprises a thermal conductivity of not greater than about 0.15 W/mK.

Embodiment 141. The multilayer composite or multilayer laminate of any one of embodiments 114 and 115, wherein the multilayer composite or multilayer laminate comprises a thermal conductivity of at least about 0.01 W/mK.

Embodiment 142. The multilayer composite or multilayer laminate of any one of embodiments 114 and 115, wherein the multilayer composite or multilayer laminate comprises a thermal conductivity of not greater than about 0.15 W/mK.

Embodiment 143. The multilayer composite or multilayer laminate of any one of embodiments 1 and 2, wherein the ceramifiable layer comprises a polymer-based matrix component, and a filler composition distributed within the polymer-based component.

Embodiment 144. The multilayer composite or multilayer laminate of embodiment 143, wherein the ceramifiable layer comprises a V-0 flammability rating as measured according to ASTM D3801.

Embodiment 145. The multilayer composite or multilayer laminate of embodiment 143, wherein the polymer-based component comprises a component selected from the group consisting of silicone, polyurethane, epoxy, acrylic acid, or any combination thereof.

Embodiment 146. The multilayer composite or multilayer laminate of embodiment 143, wherein the ceramifiable layer comprises a polymer-based component content of at least about 30 wt. % for a total weight of the ceramifiable layer.

Embodiment 147. The multilayer composite or multilayer laminate of embodiment 143, wherein the ceramifiable layer comprises a polymer-based component content of not greater than about 60 wt. % for a total weight of the ceramifiable layer.

Embodiment 148. The multilayer composite or multilayer laminate of embodiment 143, wherein the ceramifiable layer comprises a filler composition content of at least about 40 wt. % for a total weight of the ceramifiable layer.

Embodiment 149. The multilayer composite or multilayer laminate of embodiment 143, wherein the ceramifiable layer comprises a filler composition content of not greater than about 70 wt. % for a total weight of the ceramifiable layer.

Embodiment 150. The multilayer composite or multilayer laminate of embodiment 143, wherein the ceramifiable layer comprises a thickness of at least about 0.2 mm.

Embodiment 151. The multilayer composite or multilayer laminate of embodiment 143, wherein the ceramifiable layer comprises a thickness of not greater than about 1.5 mm.

Embodiment 152. The multilayer composite or multilayer laminate of embodiment 143, wherein the ceramifiable layer comprises a density of not greater than about 1.7 kg/m³.

Embodiment 153. The multilayer composite or multilayer laminate of embodiment 143, wherein the ceramifiable layer comprises a density of at least about 0.001 kg/m³.

Embodiment 154. The multilayer composite or multilayer laminate of embodiment 143, wherein the ceramifiable layer comprises a weight of at least about 0.001 kg/m².

Embodiment 155. The multilayer composite or multilayer laminate of embodiment 143, wherein the ceramifiable layer comprises a weight of not greater than about 2.61 kg/m².

Embodiment 156. The multilayer composite or multilayer laminate of embodiment 143, wherein the ceramifiable layer comprises a hardness of at least about 61 Shore.A.

Embodiment 157. The multilayer composite or multilayer laminate of embodiment 143, wherein the ceramifiable layer comprises a hardness of not greater than about 71 Shore.A.

Embodiment 158. The multilayer composite or multilayer laminate of embodiment 143, wherein the ceramifiable layer comprises a tensile strength of at least about 2.3 MPa.

Embodiment 159. The multilayer composite or multilayer laminate of embodiment 143, wherein the ceramifiable layer comprises a tensile strength of not greater than about 500 MPa.

Embodiment 160. The multilayer composite or multilayer laminate of embodiment 143, wherein the filler composition comprises a ceramization filler component, a reinforcement component, a flux component, and a flame retardant component.

Embodiment 161. The multilayer composite or multilayer laminate of embodiment 160, wherein the ceramifiable layer comprises a 5 minute HPE cold side temperature of not greater than about 800° ° C. as measured after 5 minutes of a hotplate test conducted at 800° C.

Embodiment 162. The multilayer composite or multilayer laminate of embodiment 160, wherein the ceramifiable layer comprises a 15 minute HPE cold side temperature of not greater than about 800° C. as measured after 15 minutes of a hotplate test conducted at 800° C.

Embodiment 163. The multilayer composite or multilayer laminate of embodiment 160, wherein the ceramifiable layer comprises a 30 minute HPE cold side temperature of not greater than about 800° C. as measured after 30 minutes of a hotplate test conducted at 800° C.

Embodiment 164. The multilayer composite or multilayer laminate of embodiment 160, wherein the ceramifiable layer comprises a 5 minute TE cold side temperature of not greater than about 800° C. as measured at 5 minutes of a torch test conducted at 1500° C.

Embodiment 165. The multilayer composite or multilayer laminate of embodiment 160, wherein the ceramifiable layer comprises a 15 minute TE cold side temperature of not greater than about 800° C. as measured at 15 minutes of a torch test conducted at 1500° C.

Embodiment 166. The multilayer composite or multilayer laminate of embodiment 160, wherein the ceramifiable layer comprises a 30 minute TE cold side temperature of not greater than about 800° ° C. as measured at 30 minutes of a torch test conducted at 1500° C.

Embodiment 167. The multilayer composite or multilayer laminate of embodiment 160, wherein the ceramization filler component comprises a component selected from the group consisting of aluminum silicate, zirconium silicate, zirconia, alumina, or any combination thereof.

Embodiment 168. The multilayer composite or multilayer laminate of embodiment 160, wherein the filler composition comprises a ceramization filler component content of at least about 50 wt. % for a total weight of the filler composition.

Embodiment 169. The multilayer composite or multilayer laminate of embodiment 160, wherein the filler composition comprises a ceramization filler component content of not greater than about 90 wt. % for a total weight of the filler composition.

Embodiment 170. The multilayer composite or multilayer laminate of embodiment 160, wherein ceramifiable layer comprises a ceramization filler component content of at least about 25 wt. % for a total weight of the ceramifiable layer.

Embodiment 171. The multilayer composite or multilayer laminate of embodiment 160, wherein the ceramifiable layer comprises a ceramization filler component content of not greater than about 65 wt. % for a total weight of the ceramifiable layer.

Embodiment 172. The multilayer composite or multilayer laminate of embodiment 160, wherein the reinforcement component comprises a component selected from the group consisting of wollastonite, sepiolite, or any combination thereof.

Embodiment 173. The multilayer composite or multilayer laminate of embodiment 160, wherein the filler composition comprises a reinforcement component content of at least about 0.1 wt. % for a total weight of the filler composition.

Embodiment 174. The multilayer composite or multilayer laminate of embodiment 160, wherein the filler composition comprises a reinforcement component content of not greater than about 10.0 wt. % for a total weight of the filler composition.

Embodiment 175. The multilayer composite or multilayer laminate of embodiment 160, wherein the ceramifiable layer comprises a reinforcement component content of at least about 0.05 wt. % for a total weight of the ceramifiable layer.

Embodiment 176. The multilayer composite or multilayer laminate of embodiment 160, wherein the ceramifiable layer comprises a reinforcement component content of not greater than about 9.0 wt. % for a total weight of the ceramifiable layer.

Embodiment 177. The multilayer composite or multilayer laminate of embodiment 160, wherein the flux component comprises a component selected from the group consisting of low T glass frit, zinc oxide, zinc borate, antimony (III) oxide, bismuth trioxide, or any combination thereof.

Embodiment 178. The multilayer composite or multilayer laminate of embodiment 160, wherein the filler composition comprises a flux component content of at least about 3 wt. % for a total weight of the filler composition.

Embodiment 179. The multilayer composite or multilayer laminate of embodiment 160, wherein the filler composition comprises a flux component content of not greater than about 10.0 wt. % for a total weight of the filler composition.

Embodiment 180. The multilayer composite or multilayer laminate of embodiment 160, wherein the ceramifiable layer comprises a flux component content of at least about 1.5 wt. % for a total weight of the ceramifiable layer.

Embodiment 181. The multilayer composite or multilayer laminate of embodiment 160, wherein the ceramifiable layer comprises a flux component content of not greater than about 9.0 wt. % for a total weight of the ceramifiable layer.

Embodiment 182. The multilayer composite or multilayer laminate of embodiment 160, wherein the flame retardant component comprises a component selected from the group consisting of aluminum hydroxide, magnesium hydroxide, or any combination thereof.

Embodiment 183. The multilayer composite or multilayer laminate of embodiment 160, wherein the filler composition comprises a flame retardant component content of at least about 5.0 wt. % for a total weight of the filler composition.

Embodiment 184. The multilayer composite or multilayer laminate of embodiment 160, wherein the filler composition comprises a flame retardant component content of not greater than about 20.0 wt. % for a total weight of the filler composition.

Embodiment 185. The multilayer composite or multilayer laminate of embodiment 160, wherein the ceramifiable layer comprises a flame retardant component content of at least about 2.5 wt. % for a total weight of the ceramifiable layer.

Embodiment 186. The multilayer composite or multilayer laminate of embodiment 160, wherein the ceramifiable layer comprises a flame retardant component content of not greater than 18.0 wt. % for a total weight of the ceramifiable layer.

Embodiment 187. The multilayer composite or multilayer laminate of embodiment 160, wherein the filler composition further comprises a functional additive.

Embodiment 188. The multilayer composite or multilayer laminate of embodiment 187, wherein the functional additive comprises a component selected from the group consisting of iron (III) oxide, titanium oxide, or any combination thereof.

Embodiment 189. The multilayer composite or multilayer laminate of embodiment 187, wherein the filler composition comprises a functional additive content of at least about 0.1 wt. % for a total weight of the filler composition.

Embodiment 190. The multilayer composite or multilayer laminate of embodiment 187, wherein the filler composition comprises a functional additive content of not greater than about 7.0 wt. % for a total weight of the filler composition.

Embodiment 191. The multilayer composite or multilayer laminate of embodiment 187, wherein the ceramifiable layer comprises a functional additive content of at least about 0.05 wt. % for a total weight of the ceramifiable layer.

Embodiment 192. The multilayer composite or multilayer laminate of embodiment 187, wherein the ceramifiable layer comprises a functional additive content of not greater than about 6.5 wt. % for a total weight of the ceramifiable layer.

Embodiment 193. The multilayer composite or multilayer laminate of embodiment 160, wherein the filler composition comprises: a ceramization filler component, a structure promoter component, a flux component, and a flame retardant component.

Embodiment 194. The multilayer composite or multilayer laminate of embodiment 193, wherein the ceramifiable layer comprises a 5 minute HPE cold side temperature of not greater than about 800° C. as measured after 5 minutes of a hotplate test conducted at 800° C.

Embodiment 195. The multilayer composite or multilayer laminate of embodiment 193, wherein the ceramifiable layer comprises a 15 minute HPE cold side temperature of not greater than about 800° C. as measured after 15 minutes of a hotplate test conducted at 800° C.

Embodiment 196. The multilayer composite or multilayer laminate of embodiment 193, wherein the ceramifiable layer comprises a 30 minute HPE cold side temperature of not greater than about 800° C. as measured after 30 minutes of a hotplate test conducted at 800° ° C.

Embodiment 197. The multilayer composite or multilayer laminate of embodiment 193, wherein the ceramifiable layer comprises a 5 minute TE cold side temperature of not greater than about 800° C. as measured at 5 minutes of a torch test conducted at 1300° C.

Embodiment 198. The multilayer composite or multilayer laminate of embodiment 193, wherein the ceramifiable layer comprises a 15 minute TE cold side temperature of not greater than about 800° C. as measured at 15 minutes of a torch test conducted at 1300° C.

Embodiment 199. The multilayer composite or multilayer laminate of embodiment 193, wherein the ceramifiable layer comprises a 30 minute TE cold side temperature of not greater than about 800° C. as measured at 30 minutes of a torch test conducted at 1300° C.

Embodiment 200. The multilayer composite or multilayer laminate of embodiment 193, wherein the ceramization filler component comprises a component selected from the group consisting of sepiolite, wollastonite, or any combination thereof.

Embodiment 201. The multilayer composite or multilayer laminate of embodiment 193, wherein the ceramization filler component has an aspect ratio (length/diameter) of not greater than about 10.

Embodiment 202. The multilayer composite or multilayer laminate of embodiment 193, wherein the ceramization filler component has an aspect ratio (length/diameter) of at least about 2.

Embodiment 203. The multilayer composite or multilayer laminate of embodiment 193, wherein the filler composition comprises a ceramization filler component content of at least about 75 wt. % for a total weight of the filler composition.

Embodiment 204. The multilayer composite or multilayer laminate of embodiment 193, wherein the filler composition comprises a ceramization filler component content of not greater than about 95 wt. % for a total weight of the filler composition.

Embodiment 205. The multilayer composite or multilayer laminate of embodiment 193, wherein the ceramifiable layer comprises a ceramization filler component content of at least about 50 wt. % for a total weight of the ceramifiable layer.

Embodiment 206. The multilayer composite or multilayer laminate of embodiment 193, wherein the ceramifiable layer comprises a ceramization filler component content of not greater than about 70 wt. % for a total weight of the ceramifiable layer.

Embodiment 207. The multilayer composite or multilayer laminate of embodiment 193, wherein the structure promoter component comprises a component selected from the group consisting of crystalline silica, diopside, spodumene, lepidolite, lithium carbonate, lithium hydroxide, or any combination thereof.

Embodiment 208. The multilayer composite or multilayer laminate of embodiment 193, wherein the filler composition comprises a structure promoter component content of at least about 0.1 wt. % for a total weight of the filler composition.

Embodiment 209. The multilayer composite or multilayer laminate of embodiment 193, wherein the filler composition comprises a structure promoter component content of not greater than about 7.0 wt. % for a total weight of the filler composition.

Embodiment 210. The multilayer composite or multilayer laminate of embodiment 193, wherein the ceramifiable layer comprises a structure promoter component content of at least about 0.05 wt. % for a total weight of the ceramifiable layer.

Embodiment 211. The multilayer composite or multilayer laminate of embodiment 193, wherein the ceramifiable layer comprises a structure promoter component content of not greater than about 5 wt. % for a total weight of the ceramifiable layer.

Embodiment 212. The multilayer composite or multilayer laminate of embodiment 193, wherein the flux component comprises a component selected from the group consisting of low T glass frit, zinc oxide, zinc borate, antimony (III) oxide, bismuth trioxide, or any combination thereof.

Embodiment 213. The multilayer composite or multilayer laminate of embodiment 193, wherein the filler composition comprises a flux component content of at least about 0.1 wt. % for a total weight of the filler composition.

Embodiment 214. The multilayer composite or multilayer laminate of embodiment 193, wherein the filler composition comprises a flux component content of not greater than about 7.0 wt. % for a total weight of the filler composition.

Embodiment 215. The multilayer composite or multilayer laminate of embodiment 193, wherein the ceramifiable layer comprises a flux component content of at least about 0.05 wt. % for a total weight of the ceramifiable layer.

Embodiment 216. The multilayer composite or multilayer laminate of embodiment 193, wherein the ceramifiable layer comprises a flux component content of not greater than about 5 wt. % for a total weight of the ceramifiable layer.

Embodiment 217. The multilayer composite or multilayer laminate of embodiment 193, wherein the flame retardant component comprises a component selected from the group consisting of aluminum hydroxide, magnesium hydroxide, or any combination thereof.

Embodiment 218. The multilayer composite or multilayer laminate of embodiment 193, wherein the filler composition comprises a flame retardant component content of at least about 5.0 wt. % for a total weight of the filler composition.

Embodiment 219. The multilayer composite or multilayer laminate of embodiment 193, wherein the filler composition comprises a flame retardant component content of not greater than about 20.0 wt. % for a total weight of the filler composition.

Embodiment 220. The multilayer composite or multilayer laminate of embodiment 193, wherein the ceramifiable layer comprises a flame retardant component content of at least about 2.5 wt. % for a total weight of the ceramifiable layer.

Embodiment 221. The multilayer composite or multilayer laminate of embodiment 193, wherein the ceramifiable layer comprises a flame retardant component content of not greater than 10 wt. % for a total weight of the ceramifiable layer.

Embodiment 222. The multilayer composite or multilayer laminate of embodiment 193, wherein the filler composition further comprises a functional additive.

Embodiment 223. The multilayer composite or multilayer laminate of embodiment 222, wherein the functional additive comprises a component selected from the group consisting of iron (III) oxide, titanium oxide, or any combination thereof.

Embodiment 224. The multilayer composite or multilayer laminate of embodiment 222, wherein the filler composition comprises a functional additive content of at least about 0.1 wt. % for a total weight of the filler composition.

Embodiment 225. The multilayer composite or multilayer laminate of embodiment 222, wherein the filler composition comprises a functional additive content of not greater than about 7.0 wt. % for a total weight of the filler composition.

Embodiment 226. The multilayer composite or multilayer laminate of embodiment 193, wherein the ceramifiable layer comprises a functional additive content of at least about 0.05 wt. % for a total weight of the ceramifiable layer.

Embodiment 227. The multilayer composite or multilayer laminate of embodiment 193, wherein the ceramifiable layer comprises a functional additive content of not greater than about 5 wt. % for a total weight of the ceramifiable layer.

Embodiment 228. The multilayer composite or multilayer laminate of any one of embodiments 1 and 2, wherein the ceramifiable barrier component further comprises a structural layer.

Embodiment 229. The multilayer composite or multilayer laminate of embodiment 228, wherein the structural layer is between the ceramifiable layer and the core foam layer.

Embodiment 230. The multilayer composite or multilayer laminate of embodiment 228, wherein the structural layer comprises a fiber-glass material.

Embodiment 231. The multilayer composite or multilayer laminate of embodiment 228, wherein the structural layer consists of a fiber-glass material.

Embodiment 232. The multilayer composite or multilayer laminate of embodiment 228, wherein the structural layer is a fiber glass layer.

Embodiment 233. The multilayer composite or multilayer laminate of embodiment 228, wherein the structural layer has a thickness of at least about 0.01 mm.

Embodiment 234. The multilayer composite or multilayer laminate of embodiment 228, wherein the structural layer has a thickness of not greater than about 7 mm.

### EXAMPLES

The concepts described herein will be further described in the following Examples, which do not limit the scope of the invention described in the claims.

### Example 1

Two sample multilayer composite S1 and S2 were formed according to embodiments described herein. One comparative sample multilayer composite CS1 was formed for comparison to the sample multilayer composites S1 and S2. The construction and composition of each multilayer composite S1, S2, and comparative sample multilayer composite CS1 are summarized in table 1 below.

TABLE 1
Multilayer Composite Construction/Composition

| | | Silicone Foam | Ceramifiable | |
|---|---|---|---|---|
| | Sample | Layer | Barrier Layer | |
| | Thickness | Thickness | Thickness | |
| Sample | (mm) | (mm) | (mm) | Configuration |
| S1 | 2.4 | 2.2 | 0.2 | Barrier Layer |
| | | | | Toward Heat |
| | | | | Source |
| S2 | 2.4 | 2.2 | 0.2 | Foam Layer |
| | | | | Toward Heat |
| | | | | Source |
| CS1 | 2.2 | 2.2 | NONE | N/A |

The performance (i.e. the flame resistance rating, time to 200° C. normalized by thickness, and cold-side temperature) of the sample multilayer composites S1, S2, and the comparative sample multilayer composite CS1 are summarized in Table 2 below. It will be appreciated that the flame resistance rating is based on the sample's performance in a HBF test, and the cold-side temperature is measured in an 800° C. hot plate test as described herein.

TABLE 2
Multilayer Composite Performance

| | | Cold-Side | |
|---|---|---|---|
| | Flame Resistance | Temperature at | Time to 200° C. - |
| | Rating | 5 min in 800° C. | Normalized by |
| Sample | (HBF - Y/N) | Hot Plate Test | Thickness (C/mm) |
| S1 | Y | 440° C. | 22.5 |
| S2 | Y | 425° C. | 22.3 |
| CS1 | N | 471° C. | 21.3 |

### Example 2

Two sample multilayer composites S3 and S4 were formed according to embodiments described herein. One comparative sample multilayer composite CS2 was formed for comparison to the sample multilayer composites S3 and S4. The construction and composition of each multilayer composite S3, S4, and comparative sample multilayer composite CS2 are summarized in table 3 below.

TABLE 3
Multilayer Composite Construction/Composition

| | | | | Polyurethane |
|---|---|---|---|---|
| | | First | Second | Foam Layer |
| | | Ceramifiable | Ceramifiable | (located between |
| | Sample | Barrier Layer | Barrier Layer | first and second |
| | Thickness | Thickness | Thickness | barrier layers) |
| Sample | (mm) | (mm) | (mm) | Thickness (mm) |
| S3 | 3.0 | 0.3 | 0.3 | 2.4 |
| S4 | 2.8 | 0.2 | 0.2 | 2.4 |
| CS2 | 2.4 | NONE | NONE | 2.4 |

The performance (i.e. the flame resistance rating, time to 200° C. normalized by thickness, and cold-side temperature) of the sample multilayer composites S3, S4, and the comparative sample multilayer composite CS2 are summarized in Table 4 below. It will be appreciated that the flame resistance rating is based on the sample's performance in a HBF test, and the cold-side temperature is measured in an 800° C. hot plate test as described herein.

TABLE 4
Multilayer Composite Performance

| | | Cold-Side Temperature at |
|---|---|---|
| | Flame Resistance Rating | 5 min in 800° C. |
| Sample | (HBF - Y/N) | Hot Plate Test |
| S3 | Y | 80° C. |
| S4 | Y | 120° C. |
| CS2 | N | 170° C. |

### Example 3

A sample multilayer composite S5 was formed according to embodiments described herein. One comparative sample multilayer composite CS3 was formed for comparison to the sample multilayer composite S5. The construction and composition of each multilayer composite S5, and comparative sample multilayer composite CS3 are summarized in table 5 below.

TABLE 5
Multilayer Composite Construction/Composition

| | | | | Silicone Foam |
|---|---|---|---|---|
| | | First | Second | Layer (located |
| | | Ceramifiable | Ceramifiable | between first |
| | Sample | Barrier Layer | Barrier Layer | and second |
| | Thickness | Thickness | Thickness | barrier layers) |
| Sample | (mm) | (mm) | (mm) | Thickness (mm) |
| S5 | 2.6 | 0.2 | 0.2 | 2.2 |
| CS3 | 2.2 | NONE | NONE | 2.2 |

The performance (i.e. burn-through time when exposed to a torch test carried out at a temperature of 1000° C.) of the sample multilayer composites S5 and the comparative sample multilayer composite CS3 are summarized in Table 6 below.

TABLE 6
Multilayer Composite Performance

| | Burn-Through Time |
|---|---|
| Sample | (seconds) |
| S5 | >300 |
| CS3 | 20 |

Note that not all of the activities described above in the general description or the examples are required, that a portion of a specific activity may not be required, and that one or more further activities may be performed in addition to those described. Still further, the order in which activities are listed is not necessarily the order in which they are performed.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

The specification and illustrations of the embodiments described herein are intended to provide a general understanding of the structure of the various embodiments. The specification and illustrations are not intended to serve as an exhaustive and comprehensive description of all of the elements and features of apparatus and systems that use the structures or methods described herein. Separate embodiments may also be provided in combination in a single embodiment, and conversely, various features that are, for brevity, described in the context of a single embodiment, may also be provided separately or in any subcombination. Further, reference to values stated in ranges includes each and every value within that range. Many other embodiments may be apparent to skilled artisans only after reading this specification. Other embodiments may be used and derived from the disclosure, such that a structural substitution, logical substitution, or another change may be made without departing from the scope of the disclosure. Accordingly, the disclosure is to be regarded as illustrative rather than restrictive.

What is claimed is:

1. A multilayer composite comprising:
a core foam layer, and
a first ceramifiable barrier component contacting the core foam layer,
wherein the ceramifiable barrier component comprises a ceramifiable layer, and
wherein the multilayer composite comprises a HBF flammability rating as measured according to ASTM D4986.

2. The multilayer composite of claim 1, wherein the core foam layer comprises a silicone-based matrix component, a flame retardant filler component, and an insulation filler component.

3. The multilayer composite of claim 1, wherein the core foam layer comprises a silicone-based foam.

4. The multilayer composite of claim 3, wherein the silicone-based foam comprises a component A and a component B,
wherein the component A comprises:
a silicone-based matrix component,
a first filler component comprising alumina trihydrate at a content of at least about 5 wt. % and not greater than about 30 wt. % for a total weight of the component A,
a second filler component comprising perlite at a content of at least about 1 wt. % and not greater than about 15 wt. % for a total weight of the component A, and
a third filler component comprising calcium carbonate at a content of at least about 1 wt. % and not greater than about 20 wt. % for a total weight of the component A,
wherein the component B comprises:
a silicone-based matrix component,
a first filler component comprising alumina trihydrate at a content of at least about 5 wt. % and not greater than about 30 wt. % for a total weight of the component B,
a second filler component comprising perlite at a content of at least about 1 wt. % and not greater than about 15 wt. % for a total weight of the component B,
a third filler component comprising calcium carbonate at a content of at least about 1 wt. % and not greater than about 20 wt. % for a total weight of the component B, and
a fourth filler component comprising zinc borate at a content of at least about 1 wt. % and not greater than about 20 wt. % for a total weight of the component B, and
wherein the silicone-based foam comprises a V-0 flammability rating as measured according to ASTM D3801.

5. The multilayer composite of claim 1, wherein the core foam layer comprises a polyurethane-based matrix component.

6. The multilayer composite of claim 1, wherein the core foam layer comprises a flame retardant filler component.

7. The multilayer composite of claim 5, wherein the polyurethane-based matrix component of the core foam layer comprises a flexible polyurethane reacted from isocyanate and polyol.

8. The multilayer composite of claim 1, wherein the ceramifiable layer comprises a polymer-based matrix component, and a filler composition distributed within the polymer-based component.

9. The multilayer composite of claim 8, wherein the filler composition comprises a ceramization filler component, a reinforcement component, a flux component, and a flame retardant component.

10. The multilayer composite of claim 8, wherein the filler composition comprises: a ceramization filler component, a structure promoter component, a flux component, and a flame retardant component.

11. The multilayer composite of claim 10, wherein the ceramization filler component comprises a component selected from the group consisting of sepiolite, wollastonite, or any combination thereof.

12. The multilayer composite of claim 1, wherein the ceramifiable barrier component further comprises a structural layer.

13. The multilayer composite of claim 12, wherein the structural layer is between the ceramifiable layer and the core foam layer.

14. The multilayer composite of claim 12, wherein the structural layer comprises a fiber-glass material.

15. A multilayer laminate material comprising:
a core foam layer, and
a first ceramifiable tape laminated to the core foam layer,
wherein the ceramifiable barrier component comprises a ceramifiable layer, and
wherein the composite material or composite material layer a HBF flammability rating as measured according to ASTM D4986.

16. The multilayer laminate of claim 15, wherein the core foam layer comprises a silicone-based matrix component, a flame retardant filler component, and an insulation filler component.

17. The multilayer laminate of claim 15, wherein the core foam layer comprises a silicone-based foam.

18. The multilayer laminate of claim 17, wherein the silicone-based foam comprises a component A and a component B,
wherein the component A comprises:
a silicone-based matrix component,
a first filler component comprising alumina trihydrate at a content of at least about 5 wt. % and not greater than about 30 wt. % for a total weight of the component A,
a second filler component comprising perlite at a content of at least about 1 wt. % and not greater than about 15 wt. % for a total weight of the component A, and
a third filler component comprising calcium carbonate at a content of at least about 1 wt. % and not greater than about 20 wt. % for a total weight of the component A,
wherein the component B comprises:
a silicone-based matrix component,
a first filler component comprising alumina trihydrate at a content of at least about 5 wt. % and not greater than about 30 wt. % for a total weight of the component B,
a second filler component comprising perlite at a content of at least about 1 wt. % and not greater than about 15 wt. % for a total weight of the component B,
a third filler component comprising calcium carbonate at a content of at least about 1 wt. % and not greater than about 20 wt. % for a total weight of the component B, and
a fourth filler component comprising zinc borate at a content of at least about 1 wt. % and not greater than about 20 wt. % for a total weight of the component B, and
wherein the silicone-based foam comprises a V-0 flammability rating as measured according to ASTM D3801.

19. The multilayer laminate of claim 15, wherein the core foam layer comprises a polyurethane-based matrix component.

20. The multilayer laminate of claim 15, wherein the core foam layer comprises a flame retardant filler component.
